(19) United States
(12) Patent Application Publication
(10) Pub. No.: US 2024/0111491 A1
(43) Pub. Date: Apr. 4, 2024

(54) Single-Weight-Multiple-Data Multiply-Accumulate with Winograd Layers

(71) Applicant: Flex Logix Technologies, Inc., Mountain View, CA (US)

(72) Inventors: Frederick A. Ware, Los Altos Hills, CA (US); Cheng C. Wang, Los Altos, CA (US)

(21) Appl. No.: 18/371,228

(22) Filed: Sep. 21, 2023

Related U.S. Application Data
(60) Provisional application No. 63/409,194, filed on Sep. 22, 2022.

(51) Int. Cl. G06F 7/544; G06F 7/50; G06F 7/523

(52) U.S. Cl. CPC G06F 7/5443; G06F 7/50; G06F 7/523

(57) ABSTRACT

An integrated circuit device includes a broadcast data path, a weighting-value memory, Winograd conversion circuitry and multiply-accumulate units. The Winograd conversion circuitry executes a first Winograd conversion function with respect to an input data set to render a converted input data set onto the broadcast data path and executes a second Winograd conversion function with respect to a filter-weight data set to store a converted weighting data set within the weighting-value memory. The multiply-accumulate units, coupled in common to the broadcast data path to receive the converted input data set and coupled to receive respective converted weighting data values from the weighting-value memory, execute a parallel sequence of multiply-accumulate operations to generate an interim output data set that is, in turn, converted to a final output data set through execution of a third Winograd conversion function within the Winograd conversion circuitry.

### CROSS REFERENCE TO RELATED APPLICATIONS

This application hereby incorporates by reference and claims the filing-date benefit of U.S. provisional application No. 63/409,194 filed Sep. 22, 2022.

### DRAWINGS

The various embodiments disclosed herein are illustrated by way of example, and not by way of limitation, in the figures of the accompanying drawings and in which like reference numerals refer to similar elements and in which:

FIG. 1 illustrates an embodiment of an integrated-circuit inferencing engine having hierarchically arranged broadcast-data TPUs (tensor processing units) together with supporting memory, interconnect circuitry and physical signaling interfaces;

FIG. 2 contrasts a multi-data tensor processing scheme with a broadcast-data tensor processing approach implemented within the TPUs of FIG. 1;

FIG. 3 illustrates an exemplary execution of the FIG. 2 broadcast data example within an exemplary set of four multiply-accumulate (MAC) processors, showing the cycle-by-cycle transition of the input data value and respective rows of the filter weight matrix applied within the MAC processors in each MAC operation;

FIG. 4 illustrates a more detailed embodiment of a broadcast-data TPU;

FIG. 5 illustrates an exemplary pipelined vector multiplication executed within the FIG. 4 broadcast-data TPU;

FIG. 6 presents an exemplary tensor processing operation executed via parallel component-tensor processing within the data-broadcasting TPUs of FIG. 1 in accordance with the FIG. 5 MAC pipeline;

FIG. 7 illustrates an exemplary vector-matrix multiply operation parallel-processed within an array of broadcast-data TPUs;

FIG. 8 illustrates an exemplary MAC pipeline timing diagram corresponding to the FIG. 5 MAC pipeline, showing a sequence of vector multiply and pipelined operations therein;

FIG. 9 illustrates an embodiment of a broadcast-data TPU having a register-segmented broadcast data line;

FIG. 10 illustrates an embodiment of a broadcast-data TPU having a multi-channel broadcast data store, multi-channel MAC engine and multi-channel data I/O structure that enables two or more independent or correlated streams of broadcast data values to be vector multiplied with a given filter weight matrix simultaneously to yield corresponding streams of output values;

FIG. 11 presents an exemplary tensor processing operation executed via parallel component-tensor processing within a single-weight, multiple broadcast data TPU implemented generally as shown FIG. 10;

FIGS. 12A, 12B and 12C illustrate contrasting embodiments of dual-channel MAC units that may be implemented (or programmably configured/enabled) within the various single-weight multiple broadcast data TPU embodiments discussed in reference to FIGS. 10 and 11;

FIG. 13 illustrates a more generalized channel combination circuit that may be implemented within a single-weight, multiple broadcast data TPU;

FIG. 14 illustrates an embodiment of a single-weight, multiple broadcast data TPU having multiply-accumulate circuits disposed in a MAC circuit array;

FIG. 15 illustrates a finite impulse response (FIR) filtering operation that may be implemented within the various single-weight multi-broadcast data TPU embodiments presented herein;

FIG. 16 illustrates a 4-way parallel execution of the convolutional 3×3 FIR shown in FIG. 15;

FIG. 17 illustrates an exemplary application of six multi-broadcast-data-channel TPUs to implement the concurrent 4-way parallel FIR processing operations shown in FIG. 16;

FIG. 18 illustrates an exemplary application of input subtensors and filter weight values within the six 4-channel broadcast-data TPUs shown in FIG. 17 during each of three successive 64-cycle vector multiply intervals to generate four output subtensors concurrently;

FIG. 19 illustrates an exemplary execution and data-unload pipeline corresponding to the four-way parallel 3×3 FIR convolutions shown in FIGS. 16-18;

FIG. 20 illustrates an extension of the FIG. 17 approach to enable higher-depth data tensor filtering;

FIG. 21 illustrates another 3×3 FIR filtering configuration in which eight instances of a three-TPU cluster are applied to 3×3 FIR-filter an input data tensor having a depth dimension twice that shown in FIG. 20;

FIG. 22 illustrates another exemplary application of six multi-broadcast-data-channel TPUs to implement concurrent 4-way parallel FIR processing operations, in this case with non-unity stride (e.g., stride=2);

FIG. 23 illustrates exemplary logical detail for processing a convolutional neural net (CNN) layer with a 3×3 FIR filter using the broadcast-data SWMD mode;

FIG. 24 shows the logical detail for processing a CNN layer with a 3×3 FIR filter using 1D1Y SWMD mode and Winograd (WGD) optimization;

FIG. 25 illustrates an exemplary operational flow for the three component conversion operations applied to implement the Winograd (WGD) optimization method shown in FIG. 24;

FIG. 26 shows the detail for each of the three conversion functions (E, H and Y) within the Winograd optimization discussed in FIGS. 24 and 25;

FIG. 27 illustrates the logical detail for processing a CNN layer with a 3×3 FIR filter using 4D4Y SWMD mode and Winograd (WGD) optimization;

FIGS. 28 and 29 illustrate exemplary physical detail for processing a CNN layer with a 3×3 FIR filter using 4D4Y SWMD mode and using WGD optimization (i.e., as in FIGS. 25-27);

FIG. 30 illustrates additional exemplary physical detail for processing a CNN layer with a 3×3 FIR filter using 4D4Y SWMD mode and WGD optimization;

FIG. 31 illustrates exemplary first-level sequencing detail for processing the logical model layer from previous FIGS. 27-30;

FIG. 32 illustrates exemplary logical detail for processing a CNN layer with a 3×3 FIR filter using 4D4Y SWMD mode and WGD optimization;

FIG. 33 illustrates exemplary logical detail for processing a CNN layer with a 3×3 FIR filter using 4D4Y SWMD mode and WGD optimization;

FIG. 34 illustrates exemplary extension of the single-tile processing shown in foregoing examples to two or more processing tiles to parallel process larger model layers;

FIG. 35 illustrates another TPU aggregation example, again extending the single 16-TPU tile example to two or more 16-TPU tiles;

FIG. 36 illustrates another aggregation example that extends the single 16-TPU tile example to two or more 16-TPU tiles so that a larger model layer can be processed; and

FIGS. 37, 38 and 39 illustrates exemplary pseudo-code detail for the Winograd-optimized CNN layer-processing examples discussed above;

### DETAILED DESCRIPTION

In various embodiments herein multiply-accumulate (MAC) processors within a tensor processing unit (TPU) simultaneously execute, in each of a sequence of MAC cycles, respective multiply operations using a shared (common) input data operand and respective weighting operands, each of the MAC processors applying a new shared input data operand and respective weighting operand in each successive MAC cycle to accumulate, as a component of an output tensor, a respective sum-of-multiplication-products. The shared-data TPU architecture—referred to herein as a broadcast-data architecture as each new input-data value is broadcast to data inputs of all constituent MAC processors of the TPU—provides a number of potential advantages relative to legacy multi-data architectures (i.e., in which each of N parallel MAC processors multiplies a respective one of N data values with a respective weighting operand during a given MAC cycle) including, for example and without limitation:
substantially reduced processing latency as shared input data may be loaded in parallel into all N MAC processors in a single clock cycle, avoiding the N clock-cycle load time required in multi-data architectures (e.g., shifting N data values into the N MAC processors over N successive clock cycles) and thus reducing end-to-end tensor processing latency by N−1 clock cycles;
obviated cycle-to-cycle data exchange between the MAC processors—no cycle-to-cycle shifting/rotating of different input data values between MAC processors (as required in a data-rotate multi-data TPU) or accumulated output data values between MAC processors (as required in an output-rotate multi-data TPU) and thus providing/enabling:
   improved timing margin (and therefore headroom for reduced MAC cycle time) relative to output-rotate architectures at least, by avoiding output rotation overhead within the summation/accumulation pipeline stage;
   input tensor depth (number of input data values, K, per input tensor or input sub-tensor) greater or less than per-TPU MAC processor count, N, as each MAC processor may execute an unlimited number (up to the point of numeric overflow) of multiply-accumulate operations to generate an output tensor result;
non-skewed (matrix-aligned) weighting operand storage within MAC processor memory, obviating circuitry generally required in multi-data TPU architectures to effect skewed storage of dynamically generated weight matrices.

In a number of embodiments, the decoupling of input tensor depth from TPU width (number of constituent MAC processors) enables more flexible mapping of input tensors to TPUs and/or simplified result aggregation/combination within sets of TPUs assigned to generate a given output tensor. In embodiments in which data propagation time over the broadcast data path (i.e., data path coupled to data inputs of respective MAC processors within a given TPU) exceeds the timing margin required for reliable capture within all MAC processors, the broadcast data path may be segmented by one or more pipe-stage registers, with upstream MAC processors including one or more additional input register stages to levelize the data input to the multiply stages within all MAC processors. In other embodiments, two or more broadcast data channels are supplied in parallel to the MAC processors within a given TPU, with each MAC processor including two or more multiply-accumulate units within each MAC processor (i.e., the per-processor MAC unit count corresponding to the number of parallel broadcast data channels). In such embodiments, a single, shared filter weight value may be multiplied with respective broadcast data values—one broadcast data value from each different data channel—within respective MAC units in each MAC cycle, thus effecting a single-weight, multi-broadcast data TPU architecture (SWMBD TPU) in which each MAC unit effectively implements a respective MAC channel. In a number of SWMBD embodiments, two or more broadcast data channels may convey constituent n-bit components of an N-bit value, where, for example, N=2n, 4n, 8n, etc. In those cases, referred to herein as single-weight, compound broadcast data (SWCBD), the MAC units (forming respective MAC channels) within a given processor may be inter-coupled to exchange partial multiplication results, carry data and so forth as necessary to effect significance-weighted multiply and accumulated operations (e.g., carry from multiply operation and summation operation MAC channel of lesser arithmetic significance to MAC channel of greater arithmetic significance). In other compound broadcast data embodiments, the MAC channels independently generate values of different arithmetic significance (no carry and/or partial results exchanged between MAC channels) with those values being combined in a final-accumulation stage, for example, within interface circuitry that links the TPU to other circuit blocks (including other TPUs) within the host integrated circuit device. In both compound and non-compound SWMBD embodiments, the decoupling of input tensor depth from per-TPU MAC processor count enables summation of MAC results from one or more serially-connected sets of multi-broadcast-data-channel TPUs, each vector-multiplying a complex filter weight input with a respective input subtensor, into a finite impulse response (FIR) filter output, implementing, for example, a convolutional neural network (CNN) capable of generating a matrix of FIR output subtensors over an N*log N multiply-accumulate cycles (N being the critical input/output matrix dimension) and thus dramatically faster than the N² (or longer) MAC cycles generally required by conventional CNN implementations. These and other features and embodiments are discussed in further detail below.

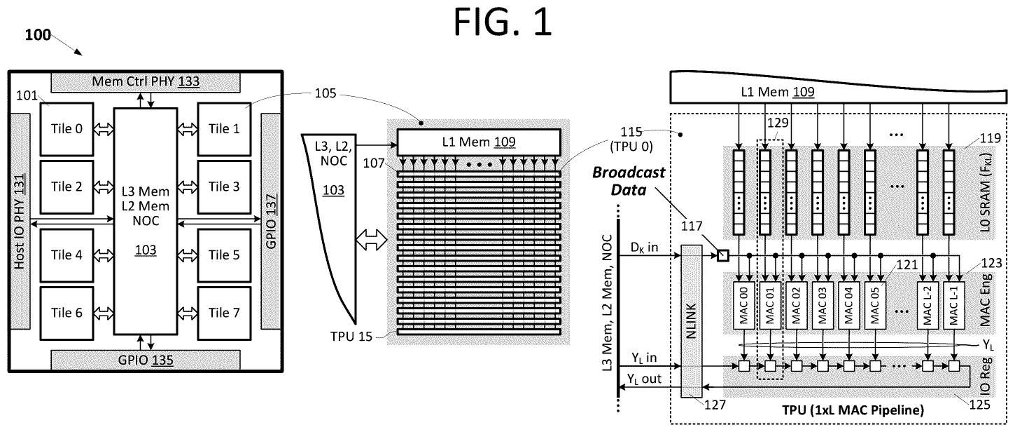

FIG. 1 illustrates an embodiment of an integrated-circuit inferencing engine 100 (“inferencing IC”) having broadcast-data TPUs grouped/clustered within processing tiles 101 and interconnected to one another, on-die memory and various physical signaling interfaces via a network-on-chip interconnect 103. In the depicted implementation, each of the processing tiles 101—shown for example in detail view 105—includes sixteen TPUs 107 (a ×16 TPU cluster) coupled to receive filter weight values from a shared local (tile-resident) memory 109 referred to herein as level-one (L1) memory. Referring to the exemplary detail at 115, each TPU 107 includes a broadcast data register 117 and high-speed/low-latency filter-weight storage 119 (referred to herein as a level-zero (L0) memory), together with a bank of ‘L’ multiply-accumulate units 121 (collectively implementing a MAC engine 123), input/output (I/O) shift register 125, and linking logic 127 (“NLINK”), the latter for interfacing to the broadcast data register and I/O shift register to NOC 107 and thus to the progressively larger level-two and level-three memories (L2 and L3) and signaling PHYs. The collective circuit block shown at 129, including an individual MAC unit 121 and the L0 memory stripe (column) and I/O register element coupled to that MAC unit, is referred to herein as a MAC processor, with the TPU including a total of L such MAC processors implementing a collective parallel MAC pipeline. In some contexts, the MAC units themselves may be referred to (or viewed as) constituting the MAC processors, with the L0 memory and/or shift-out register comprising processor-support circuitry. In any case, broadcast data register 117 outputs a sequence of shared input data values, one per MAC cycle, to all MAC processors such that all MAC processors within the TPU operate on the same broadcast data value during a given multiply-and-accumulate (MAC) cycle.

Still referring to FIG. 1, the various PHYs within inferencing IC 100 include a host I/O PHY 131 (e.g., compliant with a Peripheral Component Interconnect express (PCIe) standard or any other practicable standard or proprietary physical signaling hardware set/control protocol) to enable bidirectional information and/or instruction exchange with respect to a host processor or other control component; a memory-control PHY 133 to support read/write access to a system-level memory installation (e.g., dynamic random access memory (DRAM), flash memory, etc., disposed on a socketed memory module or implemented in any other practicable form factor), and one or more general-purpose I/O PHYs 135, 137 used, for example and without limitation, to coordinate operation between (gang) two or more inferencing ICs in a multi-chip inferencing system (with such multiple inferencing ICs 101 disposed in shared package to form a system-in-package, multi-package IC, three-dimensional IC, etc., or implemented as discrete components and interconnected via printed-circuit-board traces or other wired or wireless signaling media), establish network interconnect (e.g., according to any practicable Internet or intranet (WAN, LAN) physical layer interconnect and/or protocol suite), access nonvolatile storage media, etc. Various additional or alternative PHYs may be implemented within inferencing IC 101 in alternative embodiments, and any practicable higher-layer protocols may be implemented in connection with a given PHY (e.g., Compute Express Link or other memory-semantic protocol implemented over PCIe physical layer installation of host I/O PHY 131; memory control protocols according to various JEDEC standards implemented via memory control PHY 133; etc.). Also, the L3 and L2 memories disposed within (or accessed via) interconnect circuitry 103 may be implemented by various memory technologies in any combination (e.g., DRAM, static random access memory (SRAM), non-volatile memory, etc.) and, like processing-tile-resident L1 memory and TPU-resident L0 memory, are operationally distinguished by storage capacity and access speed/latency, with L0 memory nominally being the smallest, fasted on-chip memory and L3 being the largest (highest capacity), slowest on-chip memory. Additional or fewer memory levels may be implemented within the on-chip memory hierarchy in other embodiments, and the dispositions of individual memory levels may vary in all cases.

Referring again to the exemplary TPU detail view 115 (one of the sixteen TPUs disposed within processing tile 1 and coupled in common to the data output lines of the tile-resident L1 memory 109), each of the L multiply-accumulate units 121 execute parallel tensor processing operations—in effect matrix multiplication operations in which a two dimensional matrix of filter weight values (F_{KL}, where ‘K’ and ‘L’ are the matrix row and column indices) is vector-multiplied with a one dimensional input-data tensor, D_{K} to yield an output tensor Y_{L}. As discussed below, the input data tensor D_{K} generally constitutes a fragment or sub-tensor of a substantially larger input tensor (i.e., with segments of that tensor progressively loaded into processing tiles 101 via hierarchical memory levels (and thus ultimately into broadcast-data storage elements of individual TPUs 107) after retrieval from external memory and/or receipt from the host or data network via the memory PHY/host PHY/GPIO PHY) and output tensor Y_{L} likewise constitutes a fragment or sub-tensor of a substantially larger output tensor. The vector multiplication operation yields, as each component value within the output tensor, a convolution of the filter matrix and input tensor—multiplication of each weighting element within a given column of the filter matrix with a respective input data element within the input tensor to produce K multiplication products which are summed to produce a respective data element within the output tensor. That is: Y_{L}=ΣF_{KL}*D_{K}, for K=0 to maxK, so that Y₀=ΣF_{K0}*D_{K}, Y₁=ΣF_{K1}*D_{K}, . . . , Y_{maxL}=ΣF_{KmaxL}*D_{K}. Accordingly, in a vector multiplication of a filter weight matrix having K*L component values (filter elements or weighting values) with an input data tensor having K data elements, each of L components of the Y_{L} output tensor is produced by performing K multiplication operations and K accumulations of the multiplication products into the tensor output value and thus K multiply-and-accumulate operations pipelined in a sequence of MAC cycles (i.e., generating multiplication product during a given MAC cycle and, during that same MAC cycle, adding product generated during previous MAC cycle into accumulated sum). While an intuitive approach to convolving multiple input data elements and filter elements is to apply all the different data elements simultaneously as operands in parallel multiplication operations (i.e., K simultaneous multiplications with the K different data values in each MAC cycle), such “multi-data” approach requires (i) shifting/rotating of the input data elements (D[K]) relative to partially accumulated output values (Y[L]) following each MAC cycle (i.e., as each of the K input data values is applied in a respective one of the K multiplication operations feeding into a given output value, Y), and (ii) that all K data elements of the input tensor be loaded into respective MAC processors prior to commencement of the initial MAC cycle—a “load phase” that requires K serial shift operations (K MAC cycles where the data load circuitry and MAC processors are timed by the same clock) or a widened input data port (e.g., K*b wide, where ‘b’ is the bit-depth of an individual input data value).

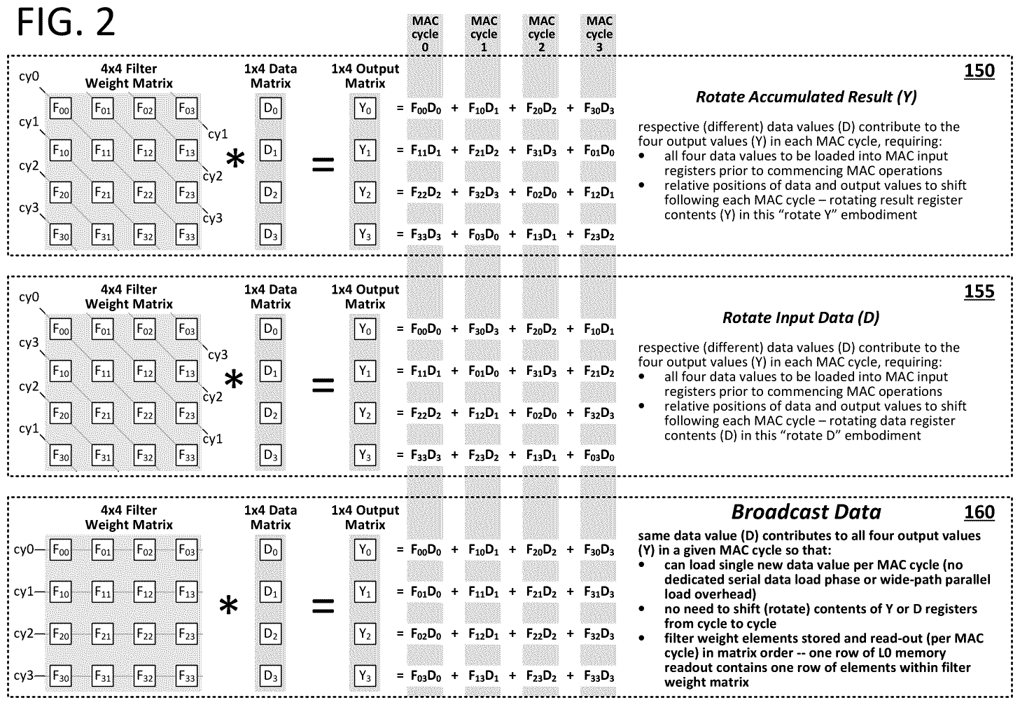

FIG. 2 contrasts the multi-data tensor processing scheme with a broadcast-data tensor processing approach implemented within the TPUs of FIG. 1, showing alternative “rotate result” and “rotate input” instances of the multi-data scheme at 150 and 155, respectively, and the broadcast-data approach at 160—all in the context of an exemplary 4×4 filter weight matrix, 1×4 input-data matrix and 1×4 result matrix (i.e., K=4, L=4). In the rotate-result (or “rotate Y”) and rotate-data examples at 150 and 155, all four of the input data values (D₀, D₁, D₂, D₃) are applied in each of four MAC cycles to yield four result values (Y₀, Y₁, Y₂, Y₃)—each of the four input data values being multiplied with a respective filter weight in each MAC cycle in accordance with the respective filter-weight selections shown by “cy0”, “cy1”, “cy2”, “cy3”. Because all input data values are loaded prior to commencement of multiply-accumulate operations and because all four input data values are applied to yield a given result value, either the input data values or accumulated results are exchanged between the MAC processors following each MAC cycle (i.e., each MAC processor receives either the input data value or the partially accumulated result value from another of the MAC processors) to enable contribution of a new one of the input data values to a given product accumulation—a data exchange implemented, for example, by circular shifting (rotating) of the data values or the partially accumulated result values among the MAC processors. In the result rotation approach at 150, the input data values are maintained within respective MAC processors throughout the vector multiply operation (no input data rotation), with partial accumulation results rotated following each MAC cycle to effect cycle-to-cycle data/result realignment. In addition to the added latency of loading all data values into the MAC processor bank before commencing multiply-accumulate operations (i.e., the multi-data load latency), result rotation tends to shrink operational timing margin as the inter-processor result exchange consumes part of the MAC cycle allocated to add the partially accumulated result and locally generated multiplication product. Moreover, the set of weighting operands applied in any given MAC cycle are drawn from a diagonal slice of the filter weight matrix (i.e., each weighting value applied in a given MAC cycle has both a unique row index and a unique column index relative to all other weighting values applied in that same MAC cycle) complicating filter matrix storage within memory—requiring either (i) matrix elements to be stored in skewed alignment within L2, L1, L0 memories so that the diagonal matrix slices (sets of filter weights aligned along diagonals within the filter weight matrix) may be read out cycle by cycle, or (ii) specialized readout architecture within the L0 memory that effects the diagonal slice (e.g., skewing the address decode to select entries from different L0 memory rows for respective MAC processors).

Still referring to FIG. 2, cycle-to-cycle input data rotation as shown at 155 avoids the timing budget strain of the result rotation scheme (i.e., no same-MAC-cycle application of neighbor-sourced value in an arithmetic operation), but suffers the same multi-data load latency and skewed filter matrix application as the result rotation approach (as the input data values are rotated while the accumulation values remain static in respective MAC processors and the cycle-to-cycle progression through the weighting matrix includes the same diagonally-aligned values in reverse order). The broadcast-data approach by contrast, avoids the multi-data load latency as the same input data value is applied within all MAC processors during a given MAC cycle so that (i) only one shared input data value (broadcast data value) must be loaded into the constituent MAC processors of a given TPU before commencing MAC operations and (ii) each of the K shared input data values may be supplied to the MAC processors in succession over the sequence of K MAC cycles required for the vector matrix multiply—just-in-time data delivery that avoids the extensive pre-load latency of the data exchange architectures (150, 155). The broadcast-data approach also avoids skewed weighting value storage/read-out as the MAC units apply respective weighting values from the same row of the filter weight matrix during each MAC cycle (progressing cycle-by-cycle through all rows of the filter weight matrix). Moreover, because there is no cycle-to-cycle data exchange between the MAC processors (all MAC processors load the same newly broadcast data value (D_{K}) in each MAC cycle), the total number of MAC cycles applied in a given vector multiplication and thus the dimension K of the filter weight matrix (F_{KL}) and input data tensor (D_{K}) is unshackled from (rendered independent of) the number of MAC processors applied in the vector multiplication (the processor count otherwise being constrained/configured to ‘K’ ensure rotation of K input-data values or K partially accumulated results among K MAC processors). Nor are MAC cycle timing budgets encumbered by data exchange latency (e.g., in contrast to the result-rotation approach in which result exchange and summation operations are executed sequentially in the same MAC cycle).

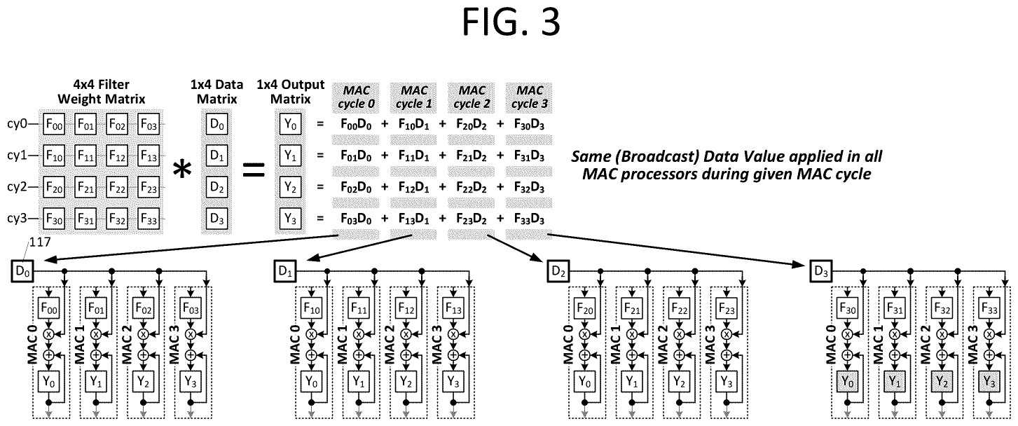

FIG. 3 illustrates an exemplary execution of the FIG. 2 broadcast data example within an exemplary set of four MAC processors (MAC0-MAC3), showing the cycle-by-cycle transition of the input data value and respective rows of the filter weight matrix applied within the MAC processors in each MAC operation. As the same input data value is supplied to (and thus shared by) all four MAC processors during each cycle, vector multiplication commences after loading the first input data value (DO) into processor-shared data register 117 (i.e., broadcast data register)—no need to load all four data values (which in practical application is generally a much higher number—64, 128, 256, 512, etc.—incurring a correspondingly higher latency). Moreover, the filter weights applied in each MAC cycle correspond to a respective row of the 4×4 filter matrix, meaning that the filter weight elements may be stored within MAC processor memory (“L0” memory and higher order memory) in matrix order and thus without the pre-skew required by the data/result-rotation schemes. Further, as there is no input data or result exchange, component values of the output tensor are generated one-for-one within respective MAC processors and without regard to the row dimension (K) of the filter weight matrix and input data matrix, and therefore independently of the number of MAC cycles (and MAC operations) executed to achieve the final output result. For example, the 4-column by 4-row (4×4) filter weight matrix and 1×4 input data matrix may be generalized to a 4×K filter weight matrix and 1×K input data matrix (K being any practicable value, for example, within the data overflow limitation of the hardware set) with each MAC processor executing K MAC cycles to generate the finalized output result (instead of the four MAC cycles shown). By contrast, in a data/result rotation scheme, component 4×4 results must generally be pre-loaded into the MAC processor accumulators (i.e., register elements Y₀-Y₃) following each 4×4 operation, iteratively executing the component 4×4 vector-multiply operation (and partial result pre-load) with respective sets of pre-loaded input values until all K input data values and K rows filter weight values have been convolved.

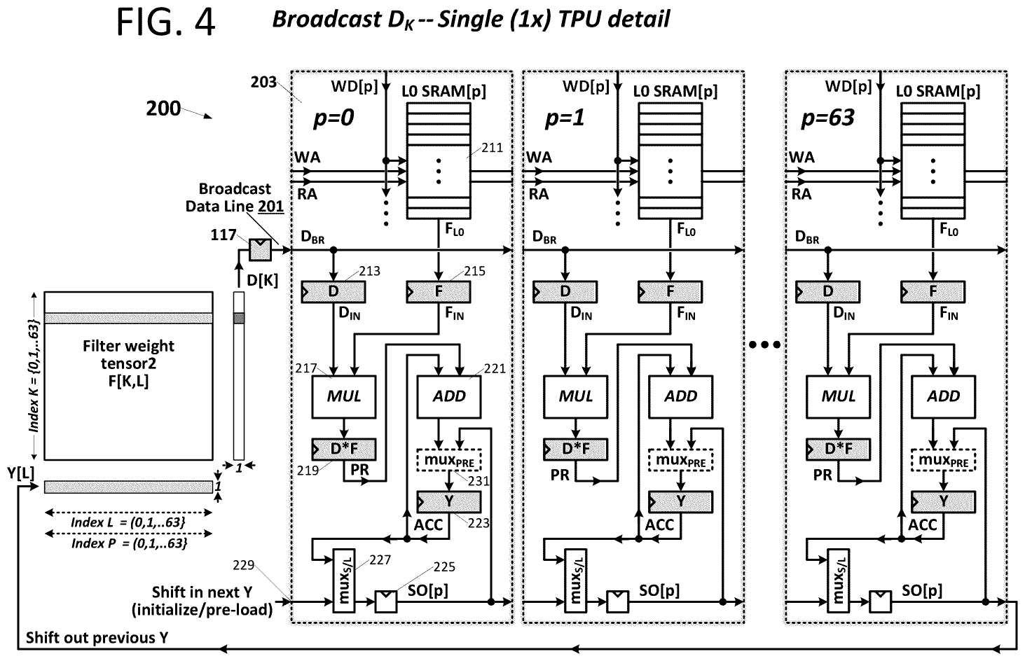

FIG. 4 illustrates a more detailed embodiment of a broadcast-data TPU 200 having a broadcast data register 117 that drives, via broadcast data line 201, a shared input data value (D[K]) to each of 64 MAC processors 203 (i.e., processor index ‘p’ ranges from 0 to 63 and, in this example, matches the number of components ‘L’ of output tensor Y_{L}). In the depicted implementation, each of the MAC processors includes an L0 SRAM stripe 211 (e.g., to store K filter weight operands to be multiplied, within a given MAC processor, with the K sequentially broadcast data values in K respective MAC cycles), a data operand register 213, weight operand register 215, multiplier circuit 217, product register 219, adder circuit 221 and accumulated-result register 223 (referred to herein as the “result” register for brevity). As shown, the L0 memory stripes (i.e., L0 SRAM[p]) within the 64 MAC processors—collectively forming the TPU L0 memory—receive a shared set of read and write address signals, RA and WA, the former (RA) to select filter weight operands (F_{L0}) output from the per-processor L0 memory stripes 211 to the weight operand registers 215 of respective MAC processors 203, and the latter (WA) to enable unloaded filter weight operands (i.e., operands already output to weight operand registers 215) to be overwritten with inbound operand values (i.e., arriving via per-processor write data lines WD[p]) to be applied in subsequent vector multiplication operations. In a number of embodiments, the collective L0 memory formed by per-processor stripes 211 (which may be implemented by register files, SRAM arrays, or any other practicable small-footprint memory) is dual ported to enable simultaneous read and write operations, with read/write control logic (e.g., implemented within TPU 200 though not specifically shown) to sequence the read and write addresses through respective modulo counts (i.e., from zero to K, and then back to zero—with the write address lagging one or more entries behind the read address) and also to output control signals as necessary to time read and write address decoding operations, etc. In other embodiments, the L0 memory may include two banks of single-ported storage elements, with one bank serving as the operand readout source during a given vector multiply interval while the other bank is loaded (during that same vector multiply interval) with filter weight operands to be applied in a subsequent vector multiply interval, the two banks switching roles at commencement of that subsequent vector multiply interval.

In the FIG. 4 embodiment, broadcast data register 117, per-processor operand registers (213, 215), per-processor product registers 219 and per-processor result registers 223 are clocked/synchronized by a shared clock signal (or respective clock-tree-generated instances of two or more same-phase clock signals) to implement pipelined data broadcast, operand load, product load, and product accumulation operations—operations executed in respective stages of a MAC pipeline with each stage of execution (“pipestage”) with regard to a given input data value transpiring in a respective clock cycle, referred to herein as a “MAC” cycle. More specifically, an input data value is clocked into the processor-shared broadcast data register 117 in a broadcast data load pipestage, and then into the data operand register 213 during an ensuing operand load pipestage (in which a corresponding weighing operand is loaded from L0 memory into weighting operand register 215). The operand load pipestage is followed by a product load pipestage in which a multiplication product generated by multiplier 217 (i.e., combinatorial logic to multiplying the operands output from registers 213 and 215) is loaded into product register 219. The product load pipestage is followed in turn by a result load pipestage—loading the output of adder 221 (i.e., combinatorial logic to add the multiplication product from product register 219 and the product accumulation (if any) previously loaded into result register 223) into result register 223, thus accumulating a sum of cyclically generated multiplication products within result register 223.

At the conclusion of a vector multiply operation, the output tensor (accumulated within collective result registers 223 of the MAC processors) is transferred from the result registers to a bank of shift-out registers 225 via shift/load multiplexer 227—one such shift-out register 225 per MAC processor 203 in the depicted embodiment—freeing the result registers 223 for a subsequent vector multiply operation. As shown, the shift-out registers 225 are coupled to one another (via ports within shift/load multiplexers 227) to form a shift register or queue such that, during respective MAC cycles of the subsequent vector multiply operation, the contents of shift-out registers 225 (i.e., output tensor) may be shifted out, tensor component by tensor component, to downstream circuitry (e.g., to shift-in input 229 of another TPU via NLINK/NOC interconnect circuitry) and/or for storage within on-chip (L2, L3) or external memory. An optional pre-load multiplexer 231 is imposed between adder 221 and result register 223 of each MAC processor to enable content shifted into the shift-out register bank to be parallel-loaded (i.e., transferred in parallel) into result registers 223, thus effecting a data pre-load (e.g., partially accumulated output tensor where a given vector multiply is split into component operations executed over respective sets of MAC sequences/cycles). Though not specifically shown, a finite state machine, sequencer or other control circuitry may be implemented within each TPU (or shared among multiple TPUs) to issue various control/configuration signals to the multiplier 217, adder 221, shift/load multiplexer 227, and pre-load multiplexer 227 within each of the MAC processors and/or other TPU components (e.g., inter-TPU adder circuitry, TPU interconnect circuitry, etc.), for example, to control multiplexer operation, enable multiplication/summation operations with various data formats (floating point, fixed point, etc. all with various precision/bit-depth, etc.), override (e.g., forcing to zero) the result-register input to adder 221 to reset the accumulated result during the first product accumulation within a vector multiply operation, and so forth.

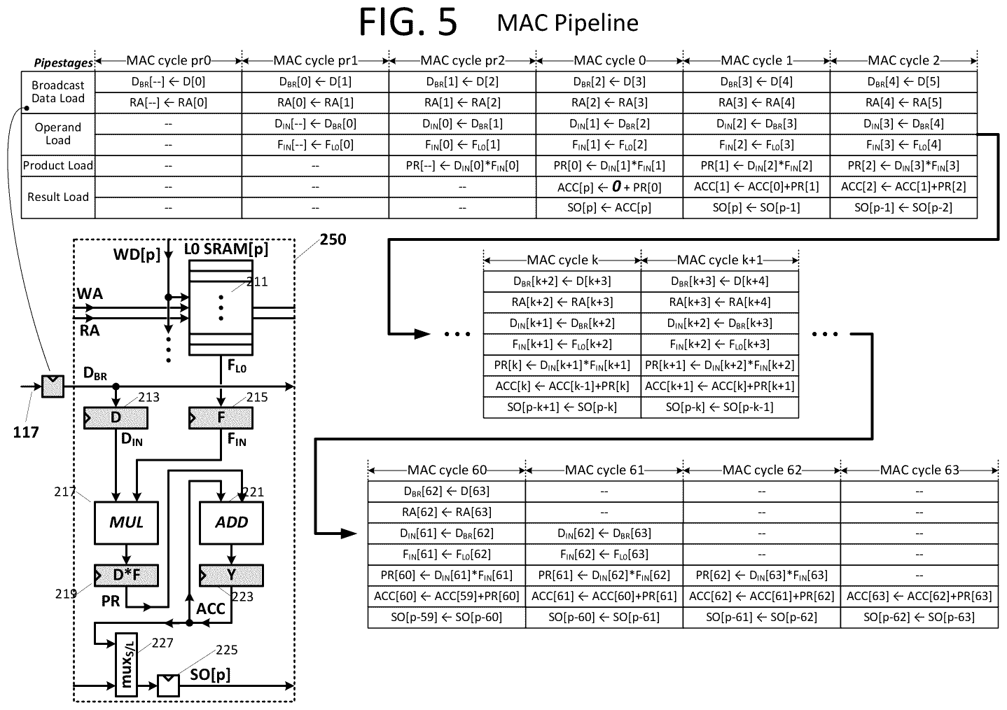

FIG. 5 illustrates an exemplary pipelined vector multiplication executed within the FIG. 4 broadcast-data TPU in the aforementioned pipestages (broadcast data load, operand load, product load, result load) over three MAC-pipeline-priming timing cycles (MAC cycles pr0, pr1 pr2) and then 64 MAC operation cycles (MAC cycles 0-63). The pipestages are executed concurrently within all MAC processors of the TPU, with a single representative MAC processor 250 shown in FIG. 5 for ease of reference (identical to the FIG. 4 MAC processors, except for omission of pre-load multiplexer 231). As shown, an initial broadcast data load is executed within the broadcast data load pipestage during priming cycle pr0 (loading the first broadcast data value, D[0], into broadcast data register 117 to become D_{BR}[0] as shown by the notation “D_{BR}[-]←D[0]”) and, during that same pipestage, the L0 read address (e.g., a pointer register) is updated to the address of the initial filter operand for the subject MAC processor (i.e., “RA[--]←RA[0]”), thus producing initial filter weight F_{L0}[0] at the L0 memory output (F_{L0}). In the ensuing priming cycle (pr1), the broadcast data value (D_{BR}[0]) and L0 filter weight output (F_{L0}[0]) are loaded into data operand register 213 and weighting operand register 215, respectively, in an execution of the operand load pipestage (i.e., D_{IN}[--]←D_{BR}[0] and F_{IN}[--]←F_{L0}[0]),) while the broadcast data load pipestage is re-executed to (i) load a new input data value into broadcast data register 117 (D_{BR}[0]←D_{BR}[1]) and (ii) advance the read address (RA[0]←RA[1]) to produce a new filter weight value F_{L0}[1] at the output of L0 memory 211. In priming cycle pr2, the product load pipestage is executed to store the multiplication product of the operands from registers 213 and 215 (i.e., output of multiplier circuit 217 and thus D_{IN}[0]*F_{IN}[0], where ‘*’ denotes multiplication) into product register 219, while the broadcast data load and operand load pipestages are repeated (in the same pr2 priming cycle) to load D[2] into broadcast register 117, advance the read address to render F_{L0}[2] at the L0 memory output, and load D_{BR}[1] into data operand register 213 and F_{L0}[1] into weighting operand register 215. As the data depth of the vector multiply operation (K) is 64 in the FIG. 5 example, the first of 64 MAC cycles commences after priming cycle pr2, including execution of the result load pipestage to (i) transfer the accumulated result from any prior vector multiply operation from result registers 223 (i.e., within the collective set of MAC processors 250) to shift-out registers 225 via multiplexer 227 (“SO[p]←ACC[p],” where ‘p’ is the MAC processor index), and (ii) load the accumulator-zeroed output of adder circuit 221—that is, a sum of product register output PR[0] and a forced-to-zero accumulated-result operand (e.g., a reset of the previously accumulated sum effected by assertion of an accumulator reset signal to adder 221)—into result register 223 as indicated by the notation “ACC[p]←0+PR[0].” During that same initial MAC cycle (MAC cycle 0), broadcast data load, operand load and product load pipestages are executed to advance new operands into the broadcast data register, operand registers and product register as discussed above. Accordingly, at the conclusion of MAC cycle 0, the shift-out registers within MAC processors 250 collectively contain the output tensor generated during a prior vector multiply operation, the result registers within all MAC processors contain the initial multiplication product (i.e., PR[0] and thus the product of D_{BR}[0] and F_{L0}[0]), and the product registers, operand registers and data broadcast registers (and L0 read address) are primed to yield a sequence new multiplication products (of sequentially supplied input data and filter weight values) to be accumulated into the result registers in the 63 ensuing MAC cycles 1-63. Moreover, as the head-of-queue shift-out register 225 (e.g., register 225 within MAC processor 63 in the FIG. 4 embodiment, though MAC processor 0 may instead constitute the head of queue, with shift-out occurring in the direction reverse of that shown) outputs the head-of-queue component of output tensor generated during the prior vector multiplication operation following MAC cycle 0, shift out operations executed within the ensuing 63 MAC cycles produces the remaining 63 output tensor components of the prior vector multiplication at the head of the shift-out queue (i.e., to be transferred in succession to downstream circuitry)—an operation indicated by “SO[p−k+1]←SO[p−k]” for generalized MAC cycle k.

In the exemplary four-stage pipeline depth shown in the FIGS. 4 and 5 embodiments, the final broadcast data load pipestage for a given vector multiply operation is executed in MAC cycle K−4 (MAC cycle 60 in this K=64 example), the final operand load pipestage is executed in MAC cycle K−3 (MAC cycle 61) and the final product load pipestage is executed in MAC cycle K−2 (MAC cycle 62) as indicated by the placeholder or null-operation designation “- -” in those pipestages for MAC cycles 61-63. In a fully loaded operational sequence in which vector multiply operations are executed back-to-back (i.e., no idle pipestages), the final three pipestages of a given vector multiply operation constitute the priming MAC cycles (pr0-pr2) for a subsequent vector multiply operation and, conversely, the initial three priming cycles of a given vector multiply operation may be committed to the final operand load, product load and result load pipestages of a prior vector multiply operation. In alternative embodiments, one or more cycles of delay may be imposed between vector multiply operations as necessary to account for memory access latency, additional tensor output processing or any other operational overhead.

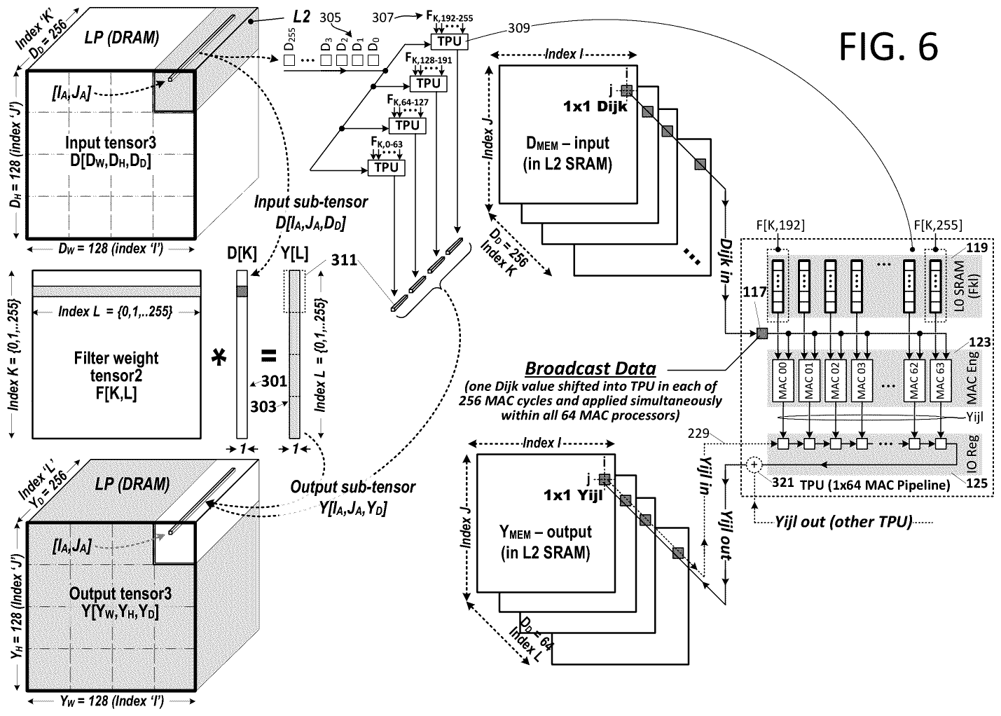

FIG. 6 presents an exemplary tensor processing operation executed via parallel component-tensor processing within the data-broadcasting TPUs of FIG. 1 in accordance with the FIG. 5 MAC pipeline (and FIG. 4/FIG. 5 MAC processor embodiments). In the depicted example, an input data tensor3 (the ‘3’ suffix indicating a three-dimensional tensor) having a 128×128 array of input sub-tensors 301, each 256 data elements deep (K=256 such that the total number of input tensor3 data elements is 2⁷*2⁷*2⁸=2²² n-bit data elements) is convolved with a two-dimensional 256×256 filter weight matrix tensor (i.e., filter weight tensor2) to produce an output data tensor3 having a 128×128 array of 256-element output sub-tensors 303. As each broadcast-data TPU includes 64 parallel MAC processors in this instance, and each of the 256 input data values of a given input sub-tensor is to be multiplied by a respective set of 256 filter weights (i.e., a respective one of K rows of filter weight tensor2), the sub-tensor processing operation is executed in the FIG. 6 example by sequentially shifting each of the 256 input data values (constituents of input sub-tensor 301) in parallel into respective broadcast data registers of four broadcast-data TPUs as shown at 305. The L0 memories within the TPU quartet are loaded with respective column-stripes of the tensor2 filter weights such that, for example, the first of the four TPUs is loaded with the filter weights from columns 0-63 of filter weight tensor2, the second of the four TPUs is loaded with filter weights from tensor2 columns 64-127, the third TPU of the quartet is loaded filter weights from tensor2 columns 128-191, and the last of the four TPUs is loaded with filter weights from tensor2 columns 192-255 (i.e., as shown generally at 307 and in the exemplary TPU detail at 309). Accordingly, as the data input index ‘k’ advances from 0 to 255 (more generally, from 0 to K−1), the read address applied within the L0 memories of the TPU quartet (four broadcast data TPUs) allocated to process input sub-tensor 301 is likewise advanced from 0 to 255 so that each TPU of the quartet generates a respective one-fourth fragment 311 of output sub-tensor 303, with the four fragments being shifted out of the quartet TPUs in parallel for storage (as sub-tensor 303) within memory allocated for output data tensor3.

Still referring to FIG. 6, exemplary input and output data flow within each TPU of the sub-tensor processing quartet is shown in detail view 309. As shown, each of 256 input data values is loaded, MAC cycle by MAC cycle, into the broadcast data register 117 of the TPU and thus applied simultaneously within all 64 multiply-accumulate units within MAC engine 123 (each MAC unit receiving a respective sequence of 64 filter weights from L0 memory 119), yielding a quarter-fragment of the output sub-tensor after 256 MAC cycles (i.e., fragment containing 64 of 256 component values of the output sub-tensor), shifting that sub-tensor fragment out of the TPU via shift-out register (I/O register) 125 during execution of an ensuing input sub-tensor processing interval (ensuing 64-MAC-cycle interval). Note that summation circuitry 321 may be provided (e.g., within the NLINK component of a given TPU—shown for example at 127 in FIG. 1) to sum the sub-tensor output with that of another TPU, thus providing flexibility for alternative TPU groupings (and thus alternative parallel processing arrangements) within the FIG. 1 inferencing IC. The output of a given TPU (or other TPU) may also or alternatively be pre-loaded into a given TPU (e.g., via pre-load multiplexers as shown at 223 in FIG. 4) to enable a partial accumulation result to be re-applied in a subsequent MAC processing sequence. With regard to pre-loading, for example, where input data dimension K for a given sub-tensor processing exceeds practical limitations (e.g., product or accumulated-result register bit depths, L0 memory row count, etc.), sub-tensor processing may be segmented into n successive operational sub-intervals, accumulating partial results with respect to K/n input data values and K/n rows of filter weight values in each operational sub-interval. The partial results generated by a given TPU during an operational sub-interval may be stored within memory (e.g., L2 and/or L3 memory) and then later pre-loaded into the same or a different TPU via the shift-in path (e.g., as shown at 229 in FIGS. 4 and 6) to enable continued result accumulation with respect to another of the K/n input data values (and another of the K/n rows of filter weight values).

Continuing with FIG. 6 and assuming the exemplary number of broadcast-data TPUs shown in FIG. 1 inferencing IC 100 (i.e., eight tiles each including 16 broadcast-data TPUs and thus 128 broadcast-data TPUs), each of 32 TPU quartets may process a respective one of 32 input sub-tensors (generating a corresponding one of 32 output sub-tensors) per vector multiplication interval (i.e., complete MAC pipeline execution spanning 256 MAC cycles in the K=256 example of FIG. 6), thus processing each of the 16,384 input sub-tensors that constitute input data tensor3 (i.e., 128×128 sub-tensors) over 512 successive vector multiplication intervals to yield the corresponding 16,384 output sub-tensors that constitute output data tensor3. In one embodiment, each of the 256 MAC cycles within a given vector multiplication interval corresponds to the cycle time of a 16 GHz clock signal (i.e., MAC cycle time=clock cycle time, t_{CLK}), so the total time required for inferencing IC 100 to convolve the four million+(i.e., 2²²) input tensor data values with the 65 thousand+(2¹⁶) filter weight matrix is 29*2⁸ MAC cycles/2⁴*10⁹ MAC cycles/second=(2¹³/10⁹) seconds and thus approximately 8 microseconds. Said another way, inferencing IC 100 can perform 160,000 such tensor processing operations per second (yielding a respective output data tensor3 in each operation) and thus at a rate that enables real-time inferencing with respect to massive amounts of input data (e.g., high resolution and/or high frame rate video and possibly multiple video streams) in a single integrated circuit component—enabling IC 100 to be deployed within edge-of-network/Internet devices alone or together with other such inferencing ICs (coordinating with one another via the host PHY or via general purpose IO PHYs shown in FIG. 1) to implement real-time, in-situ inferencing.

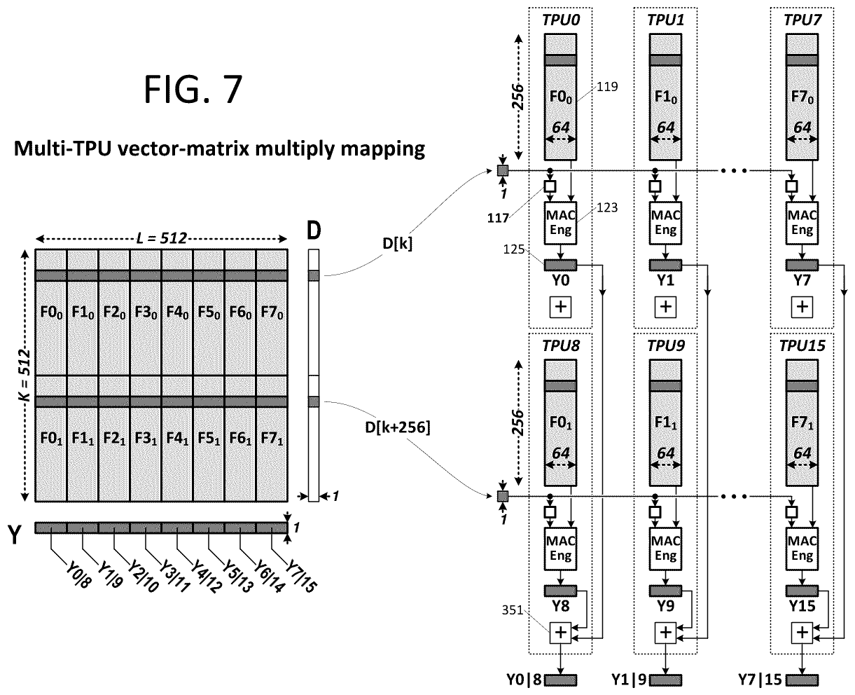

FIG. 7 illustrates an exemplary vector-matrix multiply operation parallel-processed within an array of broadcast-data TPUs. In this case, the filter weight matrix includes 512 rows and 512 columns of filter weights (2¹⁸ filter weight values) to be convolved with an input tensor having a 512-element sub-tensor data depth (i.e., K=512, L=512). In the depicted example, each of the TPUs (TPU0-TPU15) is implemented generally as shown at 115 in FIG. 1 and thus includes a data broadcast register 117 coupled in common to the data inputs of 64 MAC units (collectively forming MAC engine 123) and a 256-row L0 memory 119 in which each of 64 memory columns feeds respective weighting operand registers (e.g., as shown by column-stripes 211 and operand registers 215 in FIG. 4) within the MAC processors. As the height of the filter weight matrix (number of rows and thus dimension K) is twice the L0 memory depth (row count) and the matrix width (number of filter weight columns and thus dimension L) is 8 times the number of MAC processors per TPU (64), an array of 16 TPUs (e.g., within a single tile 101 of FIG. 1 inferencing IC 100) is allocated to parallel-process each convolution of the 512×512 filter weight matrix with a 1×256 input-data sub-tensor (D[0:255]). In the configuration shown (e.g., established by interconnect programming within the network-on-chip and/or intra-TPU NLINK circuitry 127), the array of TPUs is logically interconnected such that each of eight pairs of TPUs (TPU0/TPU8, TPU1/TPU 9, . . . , TPU7/TPU15) concurrently execute vector multiplication operations for respective halves of the input-data rows and filter-weight matrix rows and respective eighths of the filter-weight matrix columns. That is, TPUs 0 and 8 (forming TPU pair 0|8) execute vector multiply operations for the upper and lower halves (upper and lower sets of 256 rows) of the filter weight matrix (F0₀ and F0₁, respectively) and input data sub-tensor (D[0-255] and D[256-511], respectively) and the first 64 columns of the filter weight matrix, while TPUs 1 and 9 (forming TPU pair 119) execute vector multiply operations for F1₀ and F1₁, respectively (i.e., the second set of 64 filter-matrix columns), with respect to the same input data, and so forth. Thus, a first shared input data value, D[k] (where k is sequenced from 0 to 255), is broadcast to all TPUs processing the upper half of the filter weight matrix and input data sub-tensor (i.e., TPUs 0-7), and a second shared input data value, D[k+256], is concurrently/simultaneously broadcast to all TPUs processing the lower half of the filter weight matrix and input data sub-tensor (i.e., TPUs 8-15). As the vector multiply result within each TPU of a given pair represents a partial accumulation of half the constituent MAC operations with respect to a given component of the output sub-tensor, those results are summed (e.g., within adder 351 disposed, for example, in the NLINK circuit (element 127 in FIG. 1) of a given one of the TPUs of each the TPU pair to produce a complete output sub-tensor value and thus, for each TPU pair, a ×64 fragment of the complete (Y[0:511]) output sub-tensor. Thus, TPU pair TPU0/TPU8 generates output sub-tensor fragment Y0|8=Y[0:63], TPU pair TPU1/TPU9 generates output sub-tensor fragment Y1|9=Y[64:127], and so forth to TPU pair TPU7/TPU15 which generates output sub-tensor fragment Y7|15=Y[448:511]. In alternative embodiments, particularly where the L0 memory within each TPU permits low-overhead loading of successive sets of filter weight rows (e.g., dual-ported L0 memory that may be loaded with new filter weights as previously-loaded filter weights are read out and applied; or dual L0 memory banks that alternate between pre-load and read-out roles) and MAC processor register size permits, a single set of eight MAC processors may execute the vector multiplication shown in FIG. 7 (i.e., each processing a respective one of the eight columns of filter weight values, F0-F7) over 512 MAC cycles. Conversely, an additional set of 16 TPUs may be engaged in parallel with the 16 TPUs shown in FIG. 7 to halve the total vector multiplication time—for example, each of four TPUs (forming one of eight quartets) may be allocated (e.g., through run-time and/or production time configuration/interconnection) to vector-multiply a respective set of 64 rows of the filter weight matrix and input data sub-tensor to generate four partial accumulation results that are summed to yield a respective ×64 fragment of the output sub-tensor (a parallelism that may be extended through allocation of yet additional sets of TPUs to further reduce vector multiplication time).

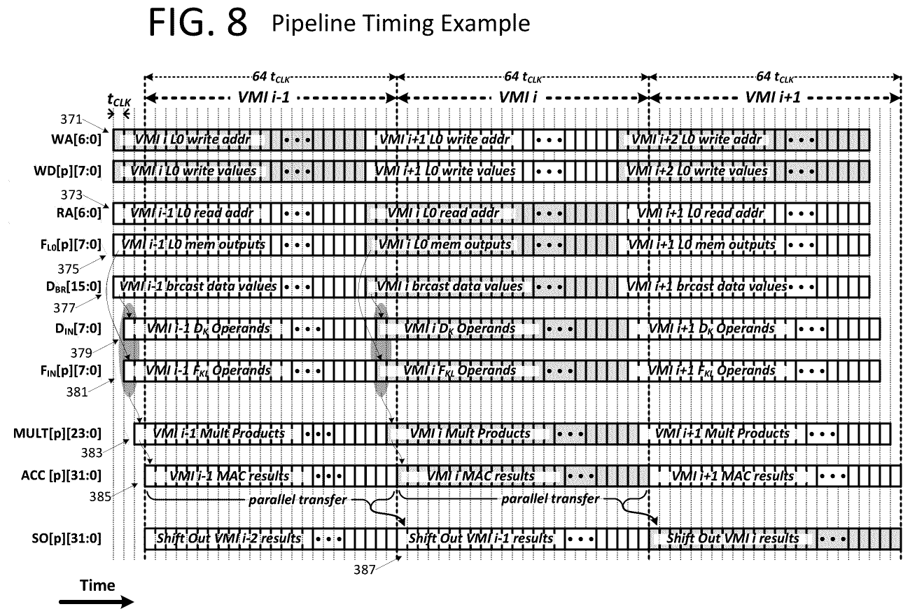

FIG. 8 illustrates an exemplary MAC pipeline timing diagram corresponding to the FIG. 5 MAC pipeline, showing a sequence of vector multiply intervals (VMI i−1, VMI i, VMI, i+1) and pipelined operations therein. As in the FIG. 5 MAC pipeline example, the three MAC cycles (each corresponding to a cycle of a pipestage clock, t_{CLK}) prior to a given vector multiply interval constitute priming cycles for an upcoming MAC operation and, when the pipeline is fully loaded, the latter three MAC cycles of a prior vector multiply interval (i.e., in which the final multiply-and-accumulate operations for a prior vector multiplication are completed). In the FIG. 8 embodiment, the L0 memory for a given TPU is loaded with filter weight values for an ensuing vector multiply interval as the L0 memory contents (filter weight values) for the current vector multiply interval are read out—for example, sequencing the write address (WA) for writing the per-MAC-processor VMI i filter weight data (WD[p][7:0]) just behind the read address sequencing (RA) for the VMI i−1 data read-out as shown at 371 and 373 (the write and read operations may be staggered in time to avoid contention if necessary, and/or the weighting data write may be executed with respect to one of two role-alternated L0 memory banks, while the weighting data read is executed with respect to the other of the two L0 memory banks as discussed above). In either case, the read address sequencing yields a sequence of per-processor L0 memory outputs F_{L0}[p][7:0] simultaneously with sequential input data load into the TPU broadcast register as shown at 375 and 377. Each of the filter weight and broadcast data values are loaded into per-processor operand registers in the ensuing MAC cycle (as operands D_{IN} and F_{IN}[p] as shown at 379 and 381), yielding multiplication products one MAC cycle later (383) and then accumulation of those products yet another MAC cycle later—in the initial cycle of a 64-cycle vector multiply operation as shown at 385. Pipelined operations directed to the i^{th} vector multiply interval (“VMI i”) are shaded in the FIG. 8 example to delineate the transitions between constituent operations of predecessor and successor vector multiply operations (VMI i−1 and VMI i+1, respectively) in the temporally staggered stages of the MAC pipeline. As in the embodiments discussed above, upon conclusion of a given vector multiply interval, the collective result register content within the TPU (i.e., within respective result registers of the constituent MAC processors of the TPU) is transferred in parallel to the shift-out register bank, and then shifted out of the TPU during the subsequent vector multiply interval—an operation shown at 387.

FIG. 8 shows, in the signal legends at left, exemplary bit-depths of the L0 read and write addresses (7-bit values corresponding to 128-row L0 memory), filter weight values, input data values, multiplication products and accumulated results. Any or all of those bit depths may be larger or smaller in other embodiments and the filter weight values, input data values, multiplication products and accumulated results may be represented in any of a variety of data formats (e.g., positive integer, signed integer, fixed point, floating point, logarithmic) with any practicable bit-depth allocation to the multiple components of a floating point, logarithmic or other compound numeric format. Also, where desirable or necessary, additional pipestages may be provided to enable data format conversion (e.g., fixed point to floating point or vice-versa) and/or matrix transformation (e.g., transforming linear matrix to Winograd or other representational format) or any other tensor processing operations.

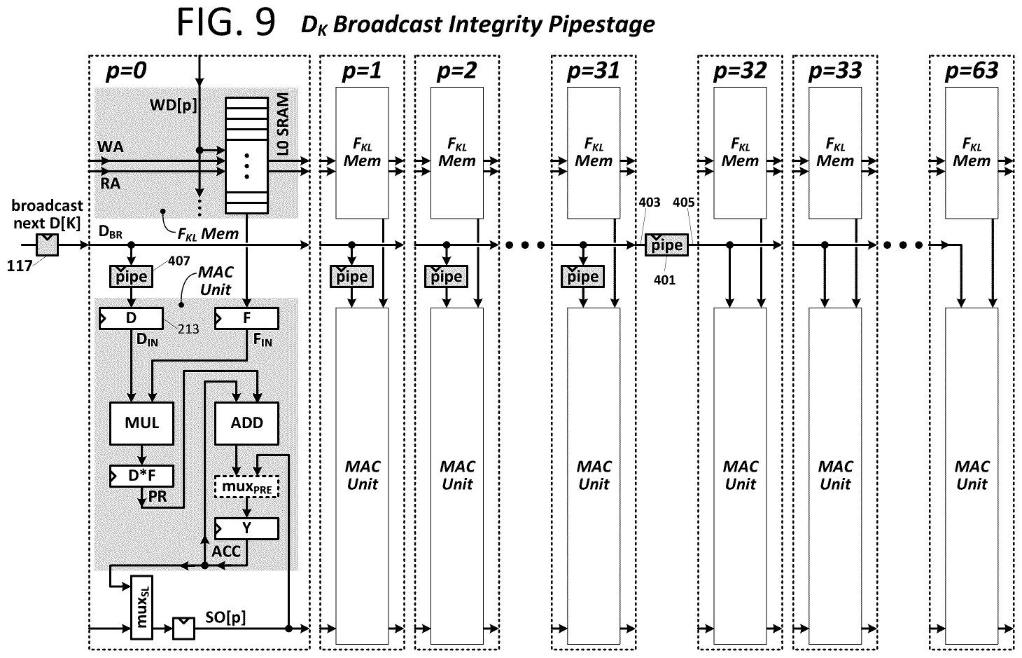

In embodiments discussed above, the broadcast data value (e.g., output from broadcast data register 117 as shown in FIGS. 1 and 4) is latched within input data registers (e.g., operand register 213 as shown in FIG. 4) of all MAC processors in response to the same clock edge (e.g., rising or falling edge of MAC clock). Accordingly, where the broadcast data register is disposed at one edge of the collective MAC processor implementation (the MAC processor “block”), each newly loaded broadcast data value must propagate from one end of the MAC processor block to the other (and thus via a relatively long and high capacitance signaling link) within a timing budget set by the MAC cycle time (t_{CLK}) less the worst-case setup time (worst process, voltage and temperature corner) of the per-processor data operand registers—a timing budget that potentially constrains the MAC clock frequency. In a number of embodiments, this timing constraint is relaxed by physical disposition of the broadcast data register midway (or otherwise part way) through the MAC processor block, for example, between MAC processors 31 and 32 (in a TPU having 64 MAC processors numbered 0 to 63), to halve the broadcast data propagation distance and flight time. In those same embodiments, separate/distinct broadcast data lines (each conveying identical instances of the broadcast data value) may be output from the broadcast data register to two 32-MAC-processor subsets of the MAC processor block thus nominally halving the capacitance on the broadcast data line instance coupled to a given half of the MAC processors. In those and other embodiments, the broadcast data line (or any portion thereof) may also be segmented by one or more pipestage registers to increase timing margin and/or enable higher speed clocking. FIG. 9 illustrates an embodiment of a broadcast-data TPU having such register-segmented broadcast data line—in this example, a single additional pipestage register 401 disposed midway between the 64 MAC processors of the TPU (i.e., between MAC processors 31 and 32) to split the broadcast data line into upstream and downstream segments (403, 405, respectively). Because all MAC processors downstream from the broadcast-segmenting pipestage register 401 (i.e., MAC processors 32-63, coupled to downstream segment 405 of the broadcast data line) receive the broadcast data value one MAC cycle later than the upstream MAC processors (0-31), additional per-processor pipestage registers 407 are imposed between upstream broadcast data line segment 403 and data operand registers 213 of all upstream MAC processors (i.e., MAC processors 0-31) to levelize data operand registration within all MAC processors of the TPU (i.e., load the broadcast data value into data operand registers 213 of all 64 MAC processors in the same MAC cycle). In other embodiments (particularly in implementations having larger numbers of MAC processors per TPU), two or more pipestage registers may be deployed to segment the broadcast data line (into three or more segments), with additional pipestage registers implemented within upstream MAC processors (according to number of downstream pipestage registers 401) to levelized data operand loading, and corresponding number of pipestages added into the MAC processing pipelines shown in FIGS. 5 and 8 to account for the increased data load latency. In all cases, broadcast data register 117 may be disposed strategically within the MAC processor block to minimize data propagation time—for example, physically centering the broadcast data register between two branches of MAC processors, with the broadcast data line to each branch segmented by one or more pipestage registers; or physically centering the broadcast data register within four quadrant-arranged subsets of MAC processors (e.g., at the center of a two-by-two matrix of MAC processors, each quadrant of the matrix including a group of MAC processors coupled to an optionally segmented broadcast data line).

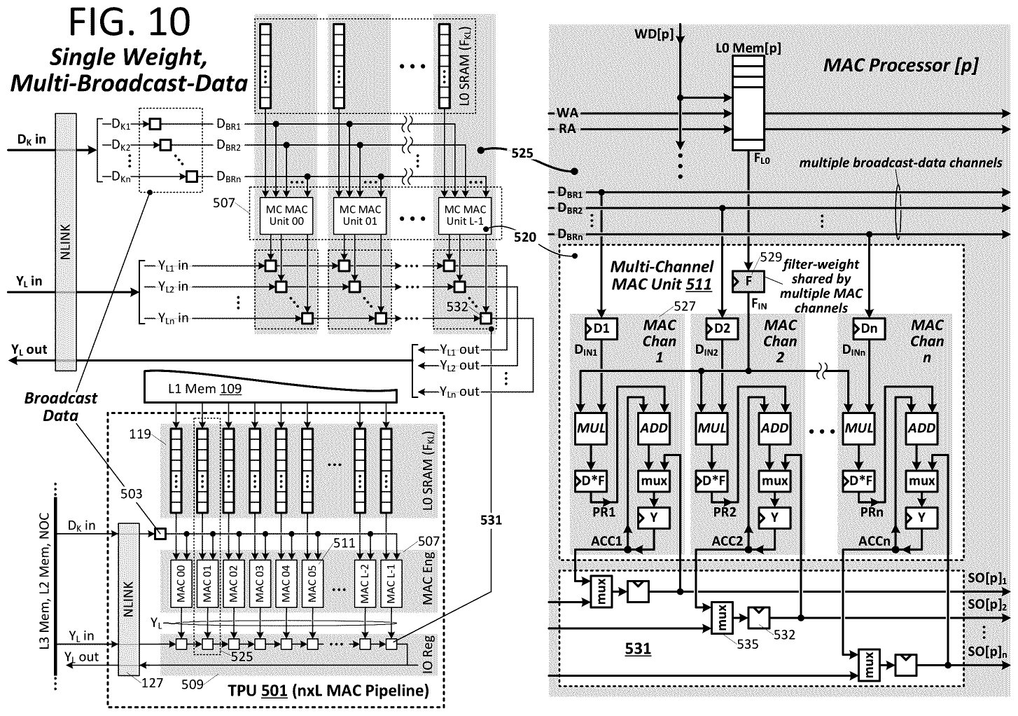

FIG. 10 illustrates an alternative embodiment of a broadcast-data TPU 501, in this case having a multi-channel broadcast data store 503, multi-channel MAC engine 507 and multi-channel data I/O structure 509 that enables two or more independent or correlated streams of broadcast data values (D_{K1}, D_{K2}, . . . , D_{Kn}) to be vector multiplied with a given filter weight matrix simultaneously (i.e., during the same vector multiply interval and thus the same set of K MAC cycles) to yield corresponding streams of output values (Y_{L1}, Y_{L2}, . . . , Y_{Ln}). Referring to exemplary detail view 520, a MAC unit 511 within each of L MAC processors 525 includes ‘n’ parallel sets of multiply-accumulate circuits 527 that implement respective multiply-accumulate channels (i.e., MAC channels 1 through n), with each of the MAC channels within a given MAC unit receiving, as operands during a given MAC cycle, a common/singular filter weight value (i.e., all MAC channels within a given MAC unit 511 receiving the same shared weight value) and a respective broadcast data value from one of the ‘n’ broadcast data streams (or broadcast data channels). By this arrangement, the MAC channels within each MAC unit 511 collectively perform multiply-and-accumulate operations with respect to a shared sequence of weighting values (a single weighting value per MAC cycle) and respective sequences of multiple broadcast data operands and thus implement a single-weight, multiple broadcast-data (SWMBD) architecture. The multi-channel I/O structure 531 within each MAC processor generates (via multiple shift-out registers 532 each sourced by a respective MAC channel within the corresponding MAC unit) a multi-channel MAC output constituted by two or more independent or correlated streams of output data values (SO[p]₁, SO[p]₂, . . . , SO[p]ₙ, where ‘p’ is the processor index and, in this example, ranges from 0 to L−1) following a given vector-multiply interval, with the MAC output streams constituting vector multiplications of the same filter weight matrix with respective input data subtensors. While shown and described herein as constituting a data I/O structure distinct from constituent MAC units 511 of MAC engine 507, the shift-out registers 532 (and path multiplexers 535) within individual MAC processors may alternatively be viewed as a component of multichannel MAC unit 511, and the entirety of the I/O register structure 509 (which also enables shift-in for pre-load as discussed above) may likewise be deemed a component of MAC engine 507. Also, the number of MAC processors 525 per broadcast data channel need not be uniform and/or individual broadcast data channels may be processed in overlapping subsets of MAC processors. For example, broadcast data channel D_{K1} (registered as D_{BR1}) may be supplied to MAC processors 0 to L−1, while broadcast data channel D_{K2} (registered as D_{BR2}) is simultaneously supplied to MAC processors 0 to M−1 (where M is an integer greater than, less than, or equal to integer L). In the overlap case, one of the broadcast data channels may be coupled to MAC processors 0 to L−1, while another is coupled to MAC processors J to K+L−1, where J is an integer between 0 and L−2, inclusively, and K is an integer greater than zero.

Still referring to FIG. 10, the individual MAC channels (or MAC circuits 527) within a given multi-channel MAC unit 511 each include multiply-and-accumulate circuitry that operates generally as discussed above (e.g., each MAC channel implemented by the registers, multiply circuitry, adder circuitry and optional multiplexers generally as discussed in reference to FIG. 4), except that filter weight register 529 (counterpart to register 215 in FIG. 4) delivers a shared/common filter weight operand to the multiplier circuits within each MAC channel (additional data and/or filter-weight registers may be provided to meet loading requirements as discussed, for example, in reference to FIG. 9) to effect single-weight, multiple broadcast data operation. Also, as discussed below, where data values on individual broadcast data channels share a logical or numeric association (e.g., respective k-bit components of a K-bit value, where K=2*k, 4*k, 8*k, etc.), the MAC channels may include and be coupled to one another via linking or inter-coupling circuitry (e.g., to share carry data, convey data fragments for operation with counterpart channel, etc.).

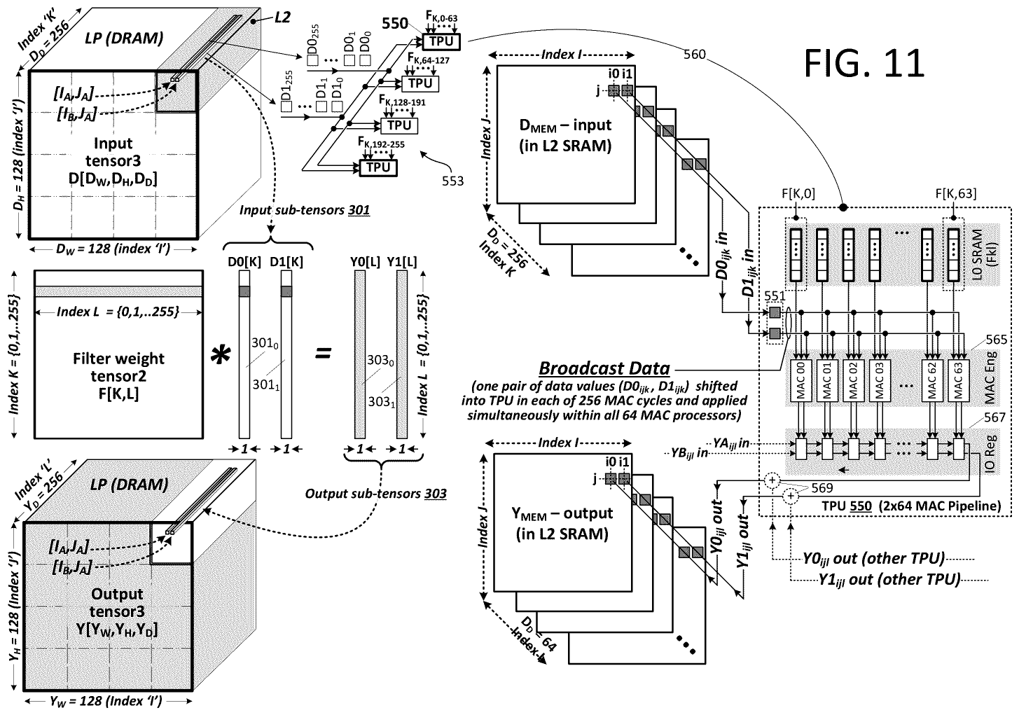

FIG. 11 presents an exemplary tensor processing operation executed via parallel component-tensor processing within a single-weight, multiple broadcast data TPU 550 implemented generally as shown FIG. 10 but in this instance more specifically having two broadcast data channels. As in the FIG. 6 example, an input data tensor3 having a 128×128 array of sub-tensors 301, each 256 data elements deep (K=256 such that the total number of input tensor3 data elements is 2⁷*2⁷*2⁸=2²² n-bit data elements) is convolved with a two-dimensional 256×256 filter weight matrix tensor (i.e., filter weight tensor2) to produce an output data tensor3 having a 128×128 array of 256-element output sub-tensors 303. As each broadcast-data TPU includes 64 parallel multi-channel MAC processors—two broadcast data channels per MAC processor in this instance—and each of the 256 input data values of a given input sub-tensor is to be multiplied by a respective set of 256 filter weights (i.e., a respective one of K rows of filter weight tensor2), two simultaneous sub-tensor processing operations are executed in the FIG. 11 example by sequentially shifting two streams of 256 input data values (i.e., D0₀-D0₂₅₅ constituting input sub-tensor 301₀ and D1₀-D1₂₅₅ constituting input sub-tensor 301₁) in parallel into a given TPU 550, and more specifically, shifting four copies of the D0 and D1 data streams in parallel into respective broadcast data register pairs (e.g., as shown at 551 in TPU detail view 560) within each of four dual-channel broadcast-data TPUs 550 (“TPU quartet”) as shown at 553. The L0 memories within the TPU quartet are loaded with respective column-stripes of the tensor2 filter weights such that, for example, the first of the four TPUs 550 is loaded with the filter weights from columns 0-63 of filter weight tensor2, the second of the four TPUs is loaded with filter weights from tensor2 columns 64-127, the third TPU of the quartet is loaded filter weights from tensor2 columns 128-191, and the last of the four TPUs is loaded with filter weights from tensor2 columns 192-255. Accordingly, as the data input index ‘k’ advances from 0 to 255 (more generally, from 0 to K−1), the read address applied within the L0 memories of the TPU quartet (i.e., four dual-broadcast-data-channel TPUs) allocated to process input sub-tensors 301₀ and 301₁ is likewise advanced from 0 to 255 so that each TPU of the quartet generates a respective one-fourth fragment of output sub-tensor 303₀ and a respective one-fourth fragment of output sub-tensor 303₁ (i.e., as generally shown above in FIG. 6 with respect to a single input data channel implementation), with the four fragments of each of the two output sub-tensors 303₀ and 303₁ (eight fragments in all) being shifted out of the quartet TPUs in parallel for storage within memory allocated for output data tensor3.

Still referring to FIG. 11, exemplary input and output data flow within each TPU 550 of the sub-tensor processing quartet is illustrated in detail view 560. As shown, two streams of 256 input data values (D0 and D1) are loaded, MAC cycle by MAC cycle, into respective broadcast data registers (shown collectively at 551) of the TPU and thus applied simultaneously within all 64 dual-channel multiply-accumulate units of MAC engine 565 (each MAC unit receiving a respective sequence of 256 filter weights from L0 memory 119 together with the dual D0/D1 broadcast data sequences), yielding a quarter-fragment of output sub-tensor 303₀ and a quarter-fragment of output sub-tensor 303₁ after 256 MAC cycles (i.e., each fragment containing 64 of 256 component values of a respective one of output sub-tensors 303₀ and 303₁), shifting those two sub-tensor fragments out of the TPU via dual-channel shift-out register (I/O register) 567 during execution of an ensuing dual-sub-tensor processing interval (ensuing 256-MAC-cycle interval). As shown, summation circuitry 569 may be provided (e.g., within the NLINK component of a given TPU—shown for example at 127 in FIG. 1) to sum the dual sub-tensor outputs with corresponding dual-channel outputs of another TPU, thus providing flexibility for alternative TPU groupings (and thus alternative parallel processing arrangements) within the host inferencing IC. The dual-channel output of a given TPU (or other TPU) may also or alternatively be pre-loaded into a given TPU (e.g., via pre-load multiplexers as shown at 535 in FIG. 10) to enable a partial dual-channel accumulation result to be re-applied in a subsequent MAC processing sequence. With regard to pre-loading, for example, where input data dimension K for a given sub-tensor pair processing exceeds practical limitations (e.g., product or accumulated-result register bit depths, L0 memory row count, etc.), sub-tensor processing may be segmented into n successive operational sub-intervals, accumulating partial results with respect dual K/n input data channels and K/n rows of filter weight values in each operational sub-interval. The partial results generated by a given TPU during an operational sub-interval may be stored within memory (e.g., L2 and/or L3 memory) and then later pre-loaded into the same or a different TPU via the dual-channel shift-in path (e.g., as shown by the YAᵢⱼₗin, YBᵢⱼₗin paths in FIG. 11) to enable continued result accumulation with respect to another pair of the K/n input data channels (and another of the K/n rows of filter weight values). While FIG. 11 specifically illustrates two (dual) broadcast data channel processing, any practicable number of parallel broadcast data channels may be simultaneously processed (i.e., multiplied by the shared two-dimensional filter weight matrix) by an n-channel MAC unit implementation (e.g., as shown generally in FIG. 10).

Continuing with FIG. 11 and assuming an exemplary number of dual-channel broadcast-data TPUs in accordance with the architecture shown in FIG. 1 inferencing IC 100 (i.e., eight tiles each including 16 dual-broadcast-data-channel TPUs and thus 128 dual-broadcast-data-channel TPUs), each of 32 TPU quartets may process a respective one of 32 input sub-tensor pairs (generating a corresponding one of 32 output sub-tensor pairs) per vector multiplication interval (i.e., complete MAC pipeline execution spanning 256 MAC cycles in the K=256 example of FIG. 11). Thus, the 32 TPU quartets may processing each of the 8,192 input sub-tensor pairs that constitute input data tensor3 (i.e., 128×128 sub-tensors) over 128 successive vector multiplication intervals to yield the corresponding 8,192 output sub-tensor pairs that constitute output data tensor3. In one embodiment, each of the 256 MAC cycles within a given vector multiplication interval corresponds to the cycle time of a 16 GHz clock signal (i.e., MAC cycle time=clock cycle time, t_{CLK}), so the total time required for a dual-channel SWMBD implementation of inferencing IC 100 to convolve the four million+(i.e., 2²²) input tensor data values with the 65 thousand+(2¹⁶) filter weight matrix values is 2⁹*2⁷ MAC cycles/(2⁴*10⁹ MAC cycles/second)=(2¹²/10⁹) seconds and thus approximately 4 microseconds. An inferencing IC that implements 128 quad-broadcast-data channel TPUs (i.e., same number of TPUs as in FIG. 1, but four broadcast data channels per TPU) halves that processing time to approximately 2 μS and an eight-broadcast-data-channel architecture (8 broadcast data channels per TPU) halves that processing time again to −1 μS and so forth.

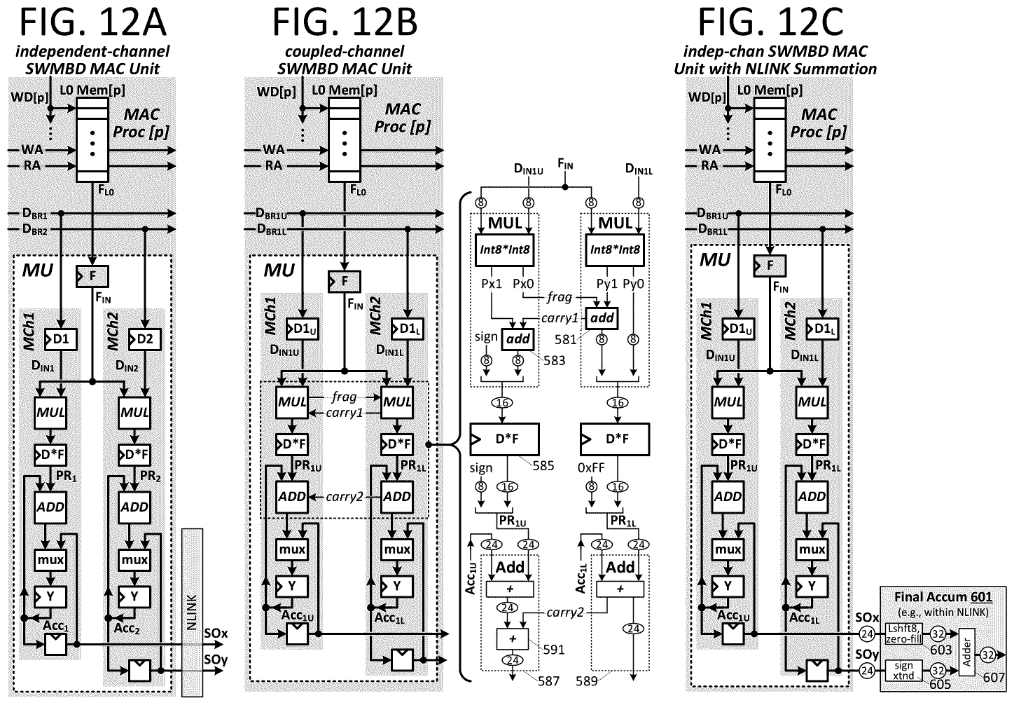

FIGS. 12A, 12B and 12C illustrate contrasting embodiments of dual-channel MAC units that may be implemented (or programmably configured/enabled) within the various SWMBD TPU embodiments discussed above. In the FIG. 12A embodiment, dual MAC channels (MCh1, MCh2)—each including the registers, multipliers, and multiplexers discussed above in reference to FIG. 10 (and not all of which are shown)—generate and shift-out independent multiply-accumulate results generally as discussed above, with those independent results being output from the TPU (SOx, SOy) via NLINK circuitry as shown. In FIG. 12B, by contrast, the dual MAC channels are functionally inter-coupled to exchange information in accordance with a correlation between the two incoming broadcast data values. In the depicted example, the two broadcast data values supplied to the dual MAC channels in a given MAC cycle constitute respective components of higher and lower significance within a collective numeric value and, more specifically in this instance, respective 8-bit components—upper byte and lower byte—of a 16-bit signed integer value. Thus, MAC channel 1 executes a signed-integer multiply of the upper broadcast data byte and a byte sized filter weight value, while MAC channel 2 simultaneously integer-multiplies the lower broadcast data byte with that same filter weight. Each multiply operation yields a 16 bit product with respective 8-bit fragments (Px1 and Px0 for MCh1; Py1 and Py0 for MCh2), with the less-significant eight-bit fragment (or subfield) of the MCh1 product (Px0) and more-significant eight-bit fragment of the MCh2 product (Py1) having equal significance in the overall product and thus being added (i.e., lower MCh1 fragment Px0 “frag” crossing between the MAC channels to adder component 581 of the MCh2 multiplier) together to generate (i) a finalized most significant fragment of the MCh2 multiplication product, and (ii) a possible carry into the significance of the more significant fragment of the MCh1 product. Accordingly, the carry generated by adder component—“carry1”—crosses back from MCh2 to MCh1 to be added to the Px1 component of the MCh1 multiply (i.e., within adder 583) and with a sign extended pre-set value being output as the upper fragment of the final 16-bit product stored within register 585 (e.g., PR_{1U} in signed 16-bit integer format, INT16). The two INT16 multiplication products are further sign-extended at the inputs to adder circuits 587 and 589 (e.g., into respective 24-bit two's complement integer values—INT24) and then accumulated within two INT24 implementations of respective output (‘Y’) registers (i.e., iteratively summed with Acc_{1U} and Acc_{1L}, respectively, over a sequence of MAC cycles). As shown, any “carry2” resulting from the summation within adder 589 (accumulating the less significant of the two INT24 components of the final accumulation result) is conveyed from MCh2 to MCh1 to be combined with the result of adder circuit 587 (e.g., within carry-adder 591).

FIG. 12C illustrates an alternative dual-channel MAC unit embodiment in which correlated broadcast data values are processed independently within two MAC channels (i.e., MCh1, MCh2 implemented as shown in FIG. 12A) followed by post-MAC combination of the correlated results (e.g., pair of INT24 values in this example) within a final-accumulator circuit 601 (e.g., implemented within above-described NLINK circuitry or elsewhere within or outside the host TPU). In the depicted example, the most significant accumulated result (SOx) is left shifted by eight bits (603) to produce a 32-bit operand (with zero-filled least significant byte) having a one-byte higher significance than that of the less significant accumulated result (SOy). The less-significant accumulated result is sign-extended to a 32-bit operand (605) that is added to the left-shifted more significant 32-bit operand within adder 607 to yield a combined (singular) 32-bit accumulation result.

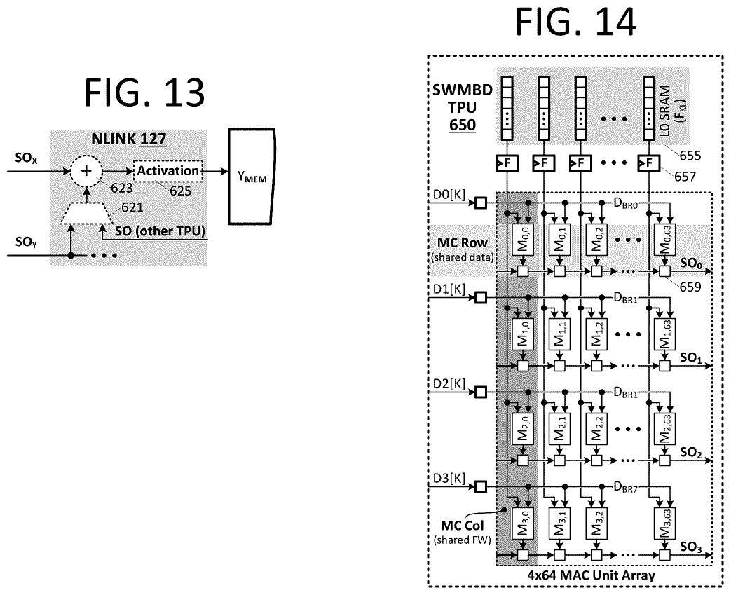

Still referring to FIGS. 12A-12C, specific data formats, precisions, bit depths, numbers of broadcast data channels, etc. are presented for purposes of understanding and example only. In all cases, different data formats (signed or unsigned integer, fixed-point, floating point, logarithmic, etc.) with any practicable precision/bit-depth may be processed within the multi-channel MAC units shown, including multiple different data formats and/or precisions with circuitry implemented within and/or at ingress/egress points of the MAC units/MAC channels as necessary to perform such conversions. Broadcast data and filter weight operands in logarithmic data formats (i.e., values represent logarithmic values and thus exponents) may be summed and then converted to a non-logarithmic format (e.g., fixed point, floating point) to effect multiplication of corresponding non-logarithmic operands. Also, as discussed in reference to FIGS. 12B and 12C and below in reference to FIG. 13, various additional circuitry may be provided to effect multiply-accumulate operations with respect to correlated broadcast data channels either within SWMBD MAC units themselves (e.g., exchanging fragment/carry data between two or more MAC channels as shown in FIG. 12B) and/or within post-processor arithmetic circuitry (e.g., final accumulation value generated/activated within NLINKS circuitry as shown in FIGS. 12B, 12C, 13).

FIG. 13 illustrates a more generalized channel combination circuit that may be implemented within NLINK circuitry 127 (or elsewhere) of a given TPU. As shown, an optional multiplexer 621 enables the accumulated output of one of the dual channels to be summed (623) with either the accumulated output of the counterpart channel or the shift-output of another TPU. Though not specifically shown, a second adder circuit may be provided to sum the dual-channel summation (i.e., SOx+SOy, with one operand shifted in significance relative to the other as discussed in reference to FIG. 13) with a counterpart dual-channel summation from another TPU (i.e., the shift-output from the other TPU is summed with the SOx and SOy summation). In any case, the final summation result may be applied to an activation circuit 625 to yield an activated output data stream (e.g., zeroing out content below an activation threshold or otherwise effecting an activation range or function with regard to a given result) to be stored within L2 or L3 memory. In the case of independent output data channels (i.e., from a SWMBD TPU as discussed above), each shifted output may be supplied (after optional summation with outputs of another TPU) to respective instances of activation circuit 625 to deliver a parallel set of activated output streams to the output tensor memory. While dual output channels (SOx, SOy) are shown in FIG. 13 (and in FIGS. 12A, 12B and 12C), any practicable number of output channels (generated by a corresponding number of MAC channels per MAC unit) may be combined with one another and/or outputs of other TPUs in alternative embodiments.

FIG. 14 illustrates an embodiment of a SWMBD TPU 650 having 256 multiply-accumulate circuits organized in a 4-row by 64-column array, with each MAC circuit (“M_{R,C}” where ‘R’ and ‘C’ are respective row and column positions of the MAC circuit within the array) implemented generally as shown at 527 in FIG. 10. As shown, each column of the MAC circuits (“MC Col”) is coupled to receive, as operands during a given MAC cycle, a single shared filter weight (the shared filter weight having been loaded from a respective one of 64 columns of L0 memory 655 into column operand register 657 in the preceding MAC cycle) and a respective one of four broadcast data values (D0[K]-D3[K]) and thus constitutes one of 64 four-channel MAC units. Conversely, each row of the MAC circuits is coupled to receive, as operands during the MAC cycle, a respective one of 64 filter weights (from respective columns of L0 memory) and a single shared broadcast data value. Individual shift-out registers 659 within a 4×64 register array are coupled respectively to the outputs of individual MAC circuits within the array (such shift-out registers may be deemed an element within the corresponding MAC circuit) and daisy-chained to one-another within a given MAC circuit row to form four shift-register circuits into which MAC results may be loaded following a given vector multiply interval and then shifted out to downstream circuitry during the ensuing vector multiply interval (e.g., SO₀-SO₃ shifted out via the TPU NLINK circuitry for storage within L2 or L3 memory; delivered to summation circuitry and/or shifted into shift-register circuits within the same or another TPU, etc.). Two or more MAC circuits within a given column for which respective broadcast data streams bear correlation (e.g., as discussed in reference to FIG. 12B) may exchange operational data (e.g., fragment, carry data as shown in FIG. 12B) and/or deliver respective shift-out data streams to final accumulation circuitry and/or other operational circuitry within per-TPU NLINK circuit block or elsewhere within the host TPU. As in the embodiments discussed above, data may be delivered, operated upon within the MAC circuit array and output in any practicable data formats (floating point, fixed point, logarithmic, etc.) and data precisions.

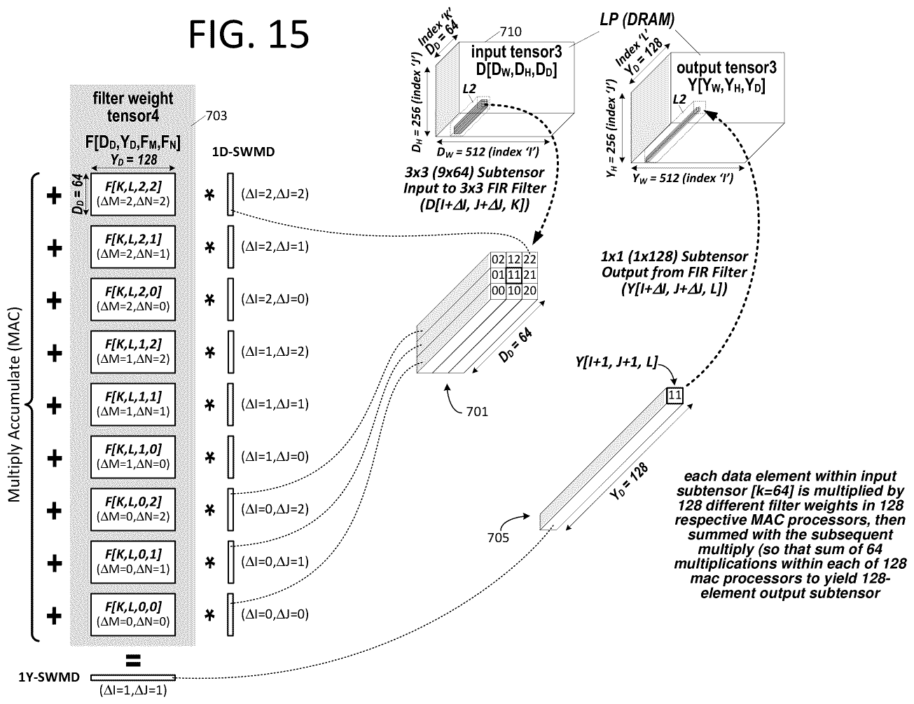

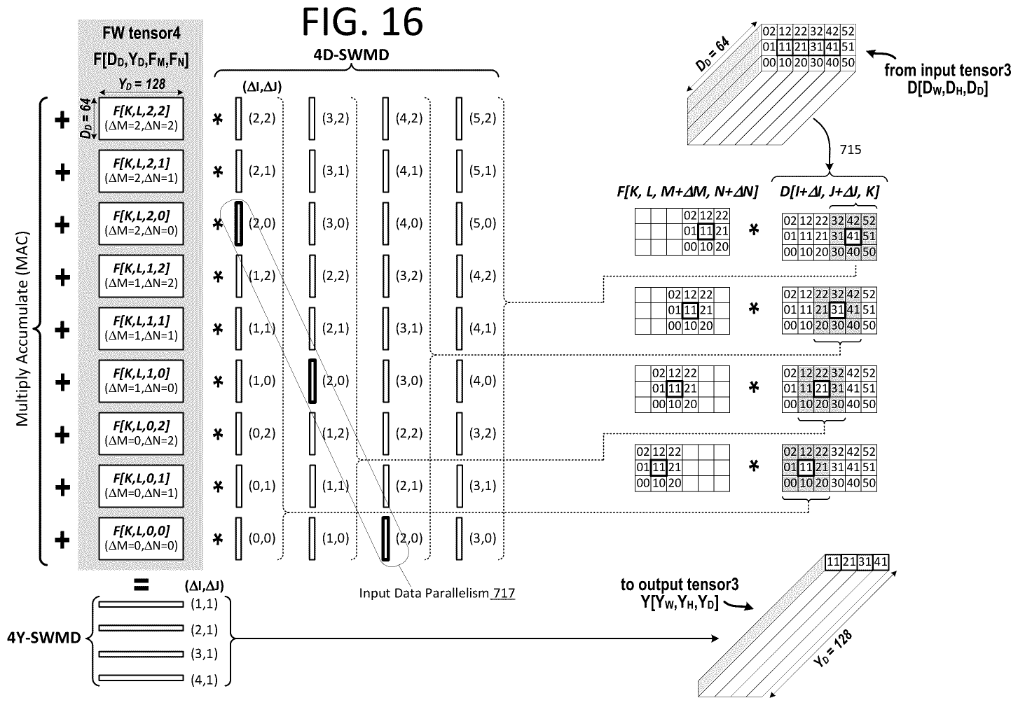

FIG. 15 illustrates exemplary convolutional neural-net (CNN) layer finite impulse response (FIR) filtering operation that may be implemented within the various single-weight multi-broadcast data TPU embodiments discussed above, in this case combining the convolutions of nine (9) input subtensors 701 and filter weight vectors (drawn from filter weight memory 703) to yield a single output subtensor 705. In the depicted example, each of the nine input subtensors (constituting a 3×3 matrix of subtensors within 3-dimensional input tensor 710) has a depth dimension (D_{D}) half that of the output subtensor depth dimension (Y_{D}) so that number of filter weights (L=Y_{D}) to be multiplied with each broadcast data input (i.e., per MAC cycle) is twice the total number of broadcast data values (K=D_{D}) per input subtensor (other Y_{D}/D_{D} ratios may apply in alternative embodiments). Similarly, the number of input subtensors applied per FIR filtering operation may be larger or smaller than the 3×3 set shown (i.e., within individual input subtensors indexed by ΔI and ΔJ offsets relative to corner input subtensor D[I=, J=0, K] and corresponding output subtensors—constituents of output tensor 712—likewise indexed by ΔI, ΔJ offsets), with various strides between respective sets of 3×3 input subtensor matrices (and output subtensors) along the I and J dimensions (i.e., strides may be one or more and need not be the same in the I and J dimensions). In general, each data element within a given input subtensor contributor (D_{K}) is multiplied by Y_{L} different filter weight values in Y_{L} different MAC processing operations (e.g., within Y_{L} MAC processors in a fully parallel subtensor/filter-weight convolution) to yield a partial result that is summed with partial results from the other subtensor/filter-weight convolutions (i.e., in this 3×3 FIR example, 9 partial results are summed) to produce the final output subtensor 705.

FIG. 16 illustrates a 4-way parallel execution of the convolutional 3×3 FIR shown in FIG. 15, in this case with unity stride (in the column ‘I’ dimension at least) such that each 3×3 set of input subtensors shares six input subtensors with the neighboring set (i.e., as shown at 715). In a number of embodiments, this data parallelism (e.g., as emphasized at 717) is exploited to reduce data readout overhead, for example, by delivering same stream of input data values (D_{K}) for a given input subtensor in parallel to multiple TPUs (or sets of TPUs) and thus avoiding repeated readout (e.g., from L2 memory) of the same input data values. Moreover, the parallel FIR convolutions may be executed in parallel broadcast data channels within a set of multi-channel TPUs—for example, allocating each of ‘n’ broadcast data channels within a given multi-channel TPU (or set of multi-channel TPUs) to a respective one of ‘n’ FIR convolutions and thereby enabling generation of ‘n’ output subtensors in parallel. In the 4-way parallel example of FIG. 16, for instance, four output subtensors (having respective I, J indices 11, 21, 31, 41) may be generated in parallel within a set of ×4 broadcast-data-channel TPUs, reducing the net input tensor3 processing time (already reduced to N*log N by the MAC processing parallelism, where ‘N’ is the dimension of the input subtensor set) by a factor of 4.

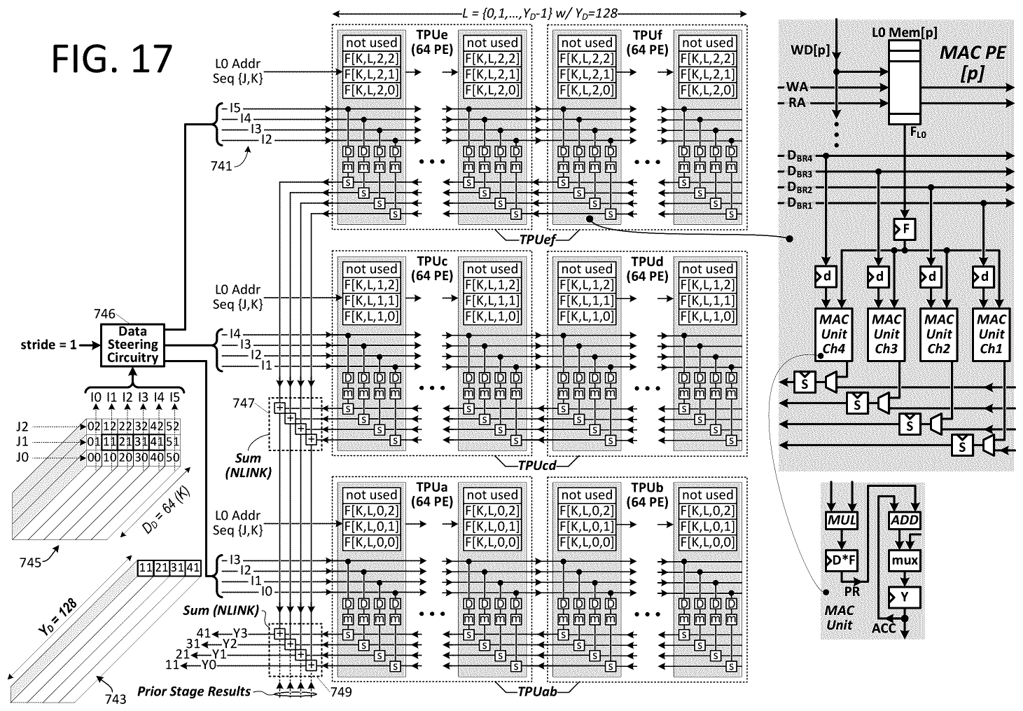

FIG. 17 illustrates an exemplary application of six multi-broadcast-data-channel TPUs to implement the concurrent 4-way parallel FIR processing operations shown in FIG. 16. In the depicted example, each pair of 64-processor TPUs (TPUa and TPUb forming a TPUab pair; TPUc and TPUd forming a TPUcd pair; TPUe and TPUf forming a TPUef pair) is coupled to the same ×4 set of broadcast data buses (e.g., buses as shown at 741) so that each of four broadcast data values is applied to a respective MAC channel within each of 128 MAC processors (64 MAC processors per TPU), thus enabling each input subtensor within a given 3×3 (FIR) set of input subtensors to be convolved with a corresponding ×128 row of the filter matrix during a given 64-cycle vector multiply interval. Moreover, the four independent broadcast data channels enable, with respect to each TPU pair, generation of four partial results (convolutions) corresponding, respectively, to the four output subtensors shown at 745 (i.e., each partial result forming a contribution to a respective one of the four output subtensors). Further, as three TPU pairs (six multi-channel TPUs in all) are applied to the 3×3 FIR processing, each TPU pair (ab, cd, ef) may generate the four partial results corresponding to a respective input subtensor column offset (ΔI) relative to the base column (I=0 in this example). Thus, TPU pair ab convolves input subtensor D[I=0, J=0, K] with filter matrix values F[K, L, I=0, J=0] (where K ranges from 0 to 63 over 64 MAC cycles, and L ranges from 0 to 127 across the 128 MAC processors of the subject TPU pair) over the same 64-cycle vector multiply interval in which TPU pair cd convolves input subtensor D[I=1, J=0, K] with filter matrix values F[K, L, I=1, J=0] and TPU pair ef convolves input subtensor D[I=2, J=0, K] with filter matrix values F[K, L, I=1, J=0]. Data steering circuitry 746 responds to a stride=1 control input (e.g., from a programmable configuration register) by routing respective subsets of the input data columns to the three TPU pairs as shown. The ‘J’ index of the input subtensor set and filter weight matrix is sequenced (e.g., incremented by one in this example) following each 64-cycle vector multiply interval to execute convolutions with respect to the remaining two rows of the input subtensor (and filter weight matrix) so that a total of three vector multiply intervals (or phases or stages) are applied to complete the 3×3 FIR operation, generating, in parallel, each of the four output subtensors 743 corresponding to four respective 3×3 sets of input subtensors (shown collectively at 745, individually at 715 in FIG. 16).

Still referring to FIG. 17, the partial-result data accumulated within individual MAC processors following each of the initial two vector multiply intervals is left in place (no accumulator clearing) to be summed with multiply-accumulate results generated within the subsequent vector multiply interval. Also, summation circuits 747, 749 (e.g., implemented within per-TPU NLINK blocks as discussed above) are applied to sum partial results generated concurrently by the three TPU pairs (e.g., summing the three partial convolutions corresponding to respective columns of a given 3×3 subtensor set) as data is shifted out of the TPU pairs following the final vector multiply interval. In alternative embodiments, partial results generated following each of the initial two 64-cycle vector multiply intervals (i.e., two of the three intervals) may be buffered (e.g., within the L2 memory space set aside for output subtensor storage or elsewhere within the host inferencing IC) and then fed back to the NLINK summation circuitry of TPU pair ab to be summed with the partial convolution results of the subsequent vector multiply interval.

In a number of embodiments, the FIR filtering architecture shown in FIG. 17 is programmably extendable to support higher numbers of FIR filter layers. For example, 5×5 FIR filtering may be achieved by allocating five TPU pairs together with control inputs (e.g., programmable settings) to steering circuitry 746 to steer staggered subsets of subtensor columns I0-I7 to those five TPU pairs. For example, in the column-stride=1, 5×5 FIR case, steering circuitry is configured to steer subtensor data to the five TPU pairs as follows:

| TPU Pair | Subtensor Column Input |
|---|---|
| TPUab | I0, I1, I2, I3 |
| TPUcd | I1, I2, I3, I4 |
| TPUef | I2, I3, I4, I5 |
| TPUgh | I3, I4, I5, I6 |
| TPUxy | I4, I5, I6, I7 |

Where input and output subtensor dimensions (and filter-weight vector dimensions) match those shown in FIGS. 15-17 (i.e., K=64, L=128), five 64-cycle vector multiply intervals (i.e., FIR cycle=5*64=320 MAC cycles) are applied to sequence the row index from J=0 to J=4, with partially accumulated sums held in place following each of the first four vector-multiply interval, with readout-summation as discussed in reference to FIG. 17 (e.g., summing the readout results within NLINK summation circuitry) to combine the partial totals shifted out of the five TPU pairs and thus generate four YD=128 output subtensors (with I, J indices 12, 22, 32, 42) during the ensuing FIR cycle. As in the 3×3 FIR example, extra-dimensional input subtensor data may be padded to yield output subtensors at the edges/corners of the output tensor3 array.

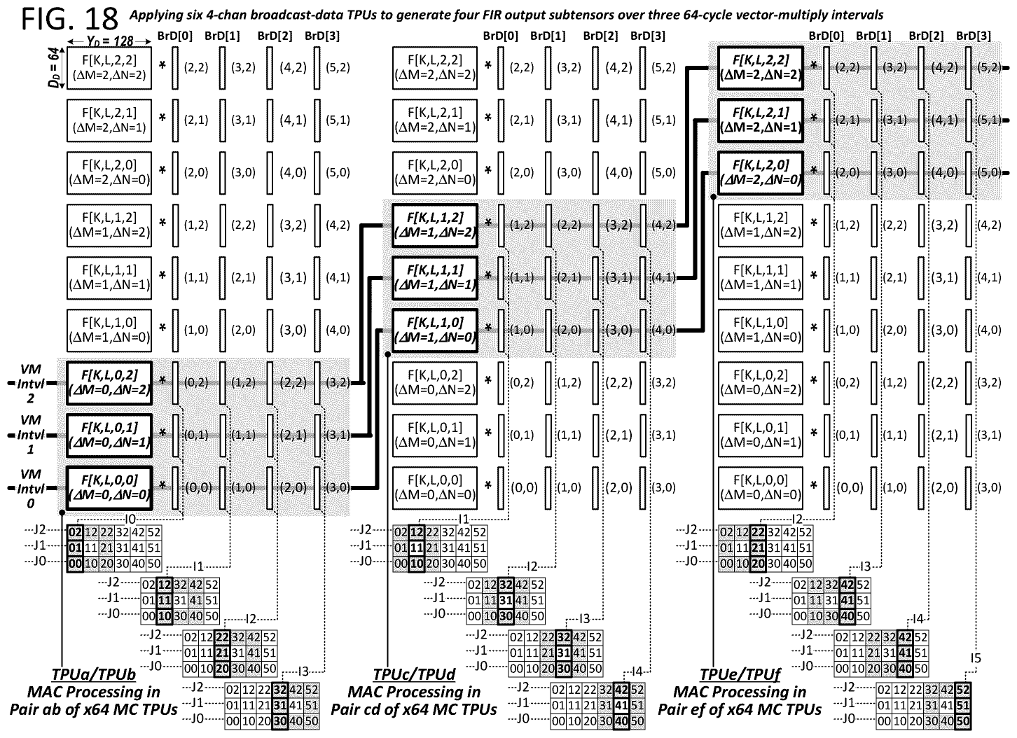

FIG. 18 illustrates an exemplary application of input subtensors and filter weight values within the six 4-channel broadcast-data TPUs shown in FIG. 17 (i.e., implementing the 3×3 FIR operation) during each of three successive 64-cycle vector multiply intervals (i.e., 192 MAC cycles) to generate four output subtensors concurrently. With respect to the nine input subtensors filtered to yield output subtensor ‘11’, for example, the three input subtensors within column I=0 are convolved with filter weight values from vectors F[K,L,0,0], F[K,L,0,1] and F[K,L,0,2], respectively—convolutions carried out concurrently with respect to convolution of corresponding initial rows of three adjacent (and overlapping in this stride=1 example) 3×3 sets of subtensors, with the data values for each of four input subtensors (one per respective 3×3 FIR) being supplied simultaneously to each of three TPU pairs (ab, cd, ef) via respective broadcast data channels (BrD[0], BrD[1], BrD[2], BrD[3]) in each of three successive vector multiply intervals.

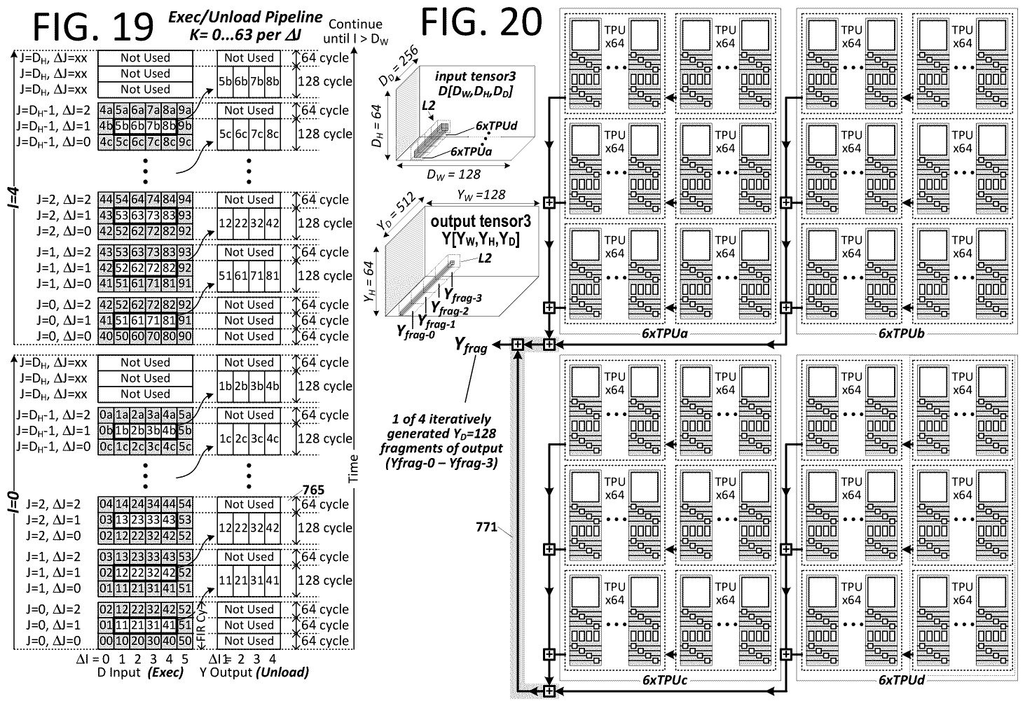

FIG. 19 illustrates an exemplary execution and data-unload pipeline corresponding to the four-way parallel 3×3 FIR convolutions shown in FIGS. 16-18. As shown (and discussed above), three 64-cycle vector multiply intervals—totaling to 192 constituent MAC cycles of an “FIR cycle”—are applied to concurrently generate a respective set of four FIR-filtered output sub-tensors (elemental subtensors within output tensor3) so that the final-result generated during a given FIR cycle is shifted out (and stored, for example, within L3 memory) during the ensuing FIR cycle (e.g., shifting out and storing output subtensors 11, 21, 31, 41 during the FIR cycle in which output subtensors 12, 22, 32 and 42 are generated). Moreover, as each output subtensor contains 128 data elements, only two of the three 64-cycle vector-multiply intervals (i.e., that transpire per FIR cycle) are required for data shift-out, leaving the shift-out circuitry unused during one of those three 64-cycle intervals as shown at 765.

FIG. 20 illustrates an extension of the FIG. 17 approach to enable higher-depth data tensor filtering. In the depicted example, four instances of the six-TPU cluster of FIG. 17 (i.e., 6×TPUa, 6×TPUb, 6×TPUc, 6×TPUd, each constituted by three TPU pairs and thus six TPUs) are applied to 3×3 FIR-filter an input data tensor having depth dimension D_{D}=256 (i.e., 4× the D_{D}=64 shown in FIG. 17), and thus produce an output data tensor having depth dimension 512 (i.e., 4× the Y_{D}=128 dimension depicted in FIG. 17). As shown, each of four distinct fragments of the input data subtensors—separated along the K (D_{D}) axis such that K ranges from 0 to 63 for the first fragment, from 64 to 127 for the second fragment, from 128 to 191 for the third fragment and from 192 to 255 for the fourth fragment—are supplied respectively to the four 6×TPU clusters (a, b, c, d). Operating with the exemplary timing shown in FIG. 19, the four 6×TPU clusters simultaneously/concurrently generate respective 128-element partial convolution results, with NLINK summation of those four partial results (i.e., within NLINK adder circuits 771) to produce, over each of four 192-MAC-cycle intervals, a respective quarter-fragment (i.e., Y_{frag-0}, Y_{frag-1}, Y_{frag-2}, Y_{frag-3}—each having a 128-element depth along the Y_{D} axis) of the output subtensor set. In one embodiment, each of the four output subtensor fragments is shifted out of the 6×TPU clusters during accumulation of the subsequent output subtensor fragment (i.e., pipelining the convolution and data shift-out operations), so that data shift-out (and output subtensor storage within L2 memory) is hidden under the 4*192=768-MAC-cycle interval required to complete the FIR filtering with respect to a given set of input subtensors.

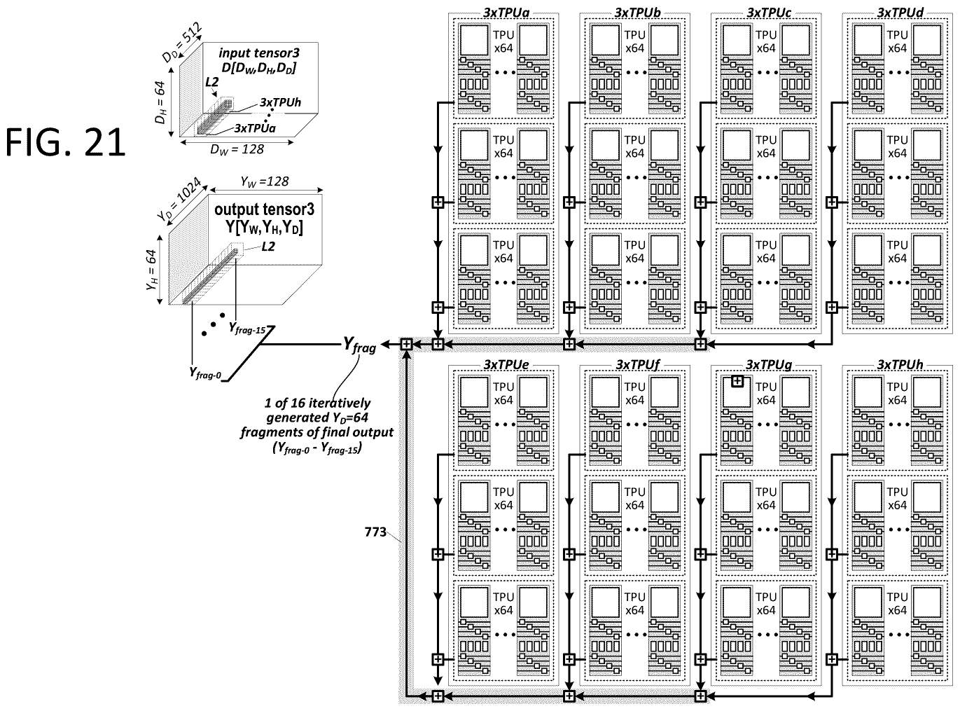

FIG. 21 illustrates another 3×3 FIR filtering configuration in which eight instances of a three-TPU cluster (i.e., 3×TPUa-3×TPUh) are applied to 3×3 FIR-filter an input data tensor having depth dimension D_{D}=512 (i.e., twice the D_{D}=256 dimension shown in FIG. 20, and 8× the D_{D}=64 shown in FIG. 17), producing an output data tensor having depth dimension Y_{D}=1024 (i.e., twice the Y_{D}=512 dimension shown in FIG. 20, and 8× the Y_{D}=128 shown in FIG. 17). As shown, each of eight distinct fragments of the input data subtensors—separated along the K (D_{D}) axis such that K ranges from 0-63 for the first fragment, from 64-127 for the second fragment, and so forth to 448-511 for the eighth fragment—are supplied respectively to the eight 3×TPU clusters (a, b, c, d, e, f, g, h). The eight 3×TPU clusters simultaneously/concurrently generate (over the index-j-sequenced 192-MAC-cycle interval discussed above) respective 64-element partial convolution results, with NLINK summation of those eight partial results (i.e., within adder circuits 773) to produce, over each of sixteen 192-MAC-cycle intervals, a respective one-sixteenth fragment (i.e., Y_{frag-0}, Y_{frag-1}, Y_{frag-2}, . . . , Y_{frag-15}—each having a 64-element depth along the Y_{D} axis) of the output subtensor set. In one embodiment, each of the sixteen output subtensor fragments is shifted out of the 3×TPU clusters during accumulation of the subsequent output subtensor fragment (i.e., pipelining the convolution and data shift-out operations), so that data shift-out (and output subtensor storage within L2 memory) is hidden under the 16*192=3072-MAC-cycle interval required to complete the FIR filtering with respect to a given set of input subtensors.

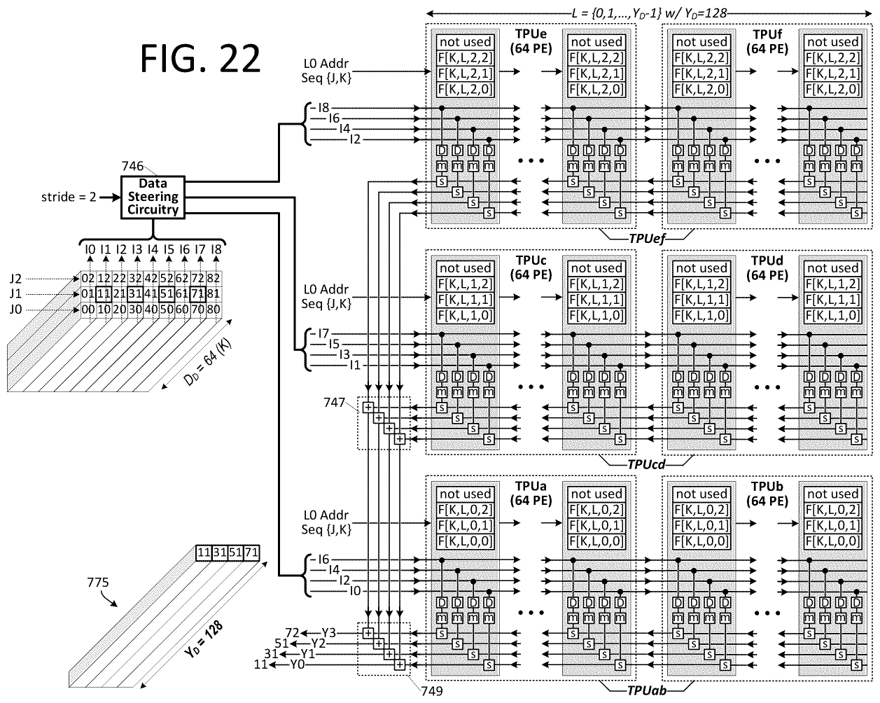

FIG. 22 illustrates another exemplary application of six multi-broadcast-data-channel TPUs to implement concurrent 4-way parallel FIR processing operations, in this case with non-unity stride input to data-steering circuitry 746—more specifically, stride=2 to yield a 2× ΔI offset between data values supplied on respective broadcast data channels. As in the FIG. 17 example, each pair of ×64 TPUs (i.e., within pairs TPUab, TPUcd and TPUef) is coupled to the same ×4 set of broadcast data buses so that each of four broadcast data values is applied to a respective MAC channel within each of 128 MAC processors, thus enabling each input subtensor within a given 3×3 (FIR) set of input subtensors to be convolved with a corresponding ×128 row of the filter matrix during a given 64-cycle vector multiply interval. As in the FIG. 17 example, the four independent broadcast data channels enable, with respect to each TPU pair, generation of four partial results (convolutions) corresponding, respectively, to the four output subtensors 775 (i.e., each partial result forming a contribution to a respective one of the output subtensors, the latter having indices corresponding to the stride=2 configuration). Further, as three TPU pairs (six multi-channel TPUs in all) are dedicated to the 3×3 FIR processing, each TPU pair may generate the four partial results corresponding to a respective input subtensor column offset (ΔI) relative to the base column (I=0 in this example). Thus, TPU pair ab convolves input subtensor D[I=0, J=0, K] with filter matrix values F[K, L, I=0, J=0] (where K ranges from 0 to 63 over 64 MAC cycles, and L ranges from 0 to 127 across the 128 MAC processors of the subject TPU pair), over the same 64-cycle vector multiply interval in which TPU pair cd convolves input subtensor D[I=1, J=0, K] with filter matrix values F[K, L, I=1, J=0] and TPU pair ef convolves input subtensor D[I=2, J=0, K] with filter matrix values F[K, L, I=2, J=0]. The ‘J’ index of the input subtensor set and filter weight matrix is sequenced following each 64-cycle vector multiply interval to execute convolutions with respect to the remaining two rows of the input subtensor (and filter weight matrix) so that a total of three vector multiply intervals (or phases or stages) are applied to complete the 3×3 FIR operation, yielding in parallel each of the four output subtensors corresponding to four respective sets (with column-stride=2) of 3×3 input subtensor sets.

As in the FIG. 17 example, the partial-result data accumulated within individual MAC processors following each of the initial two vector multiply intervals is left in place (no accumulator clearing) to be summed with multiply-accumulate results generated within the subsequent vector multiply interval. As discussed, summation circuits 747 and 749 (e.g., within per-TPU NLINK blocks) may be applied to sum partial results generated concurrently by the three TPU pairs (e.g., summing the three partial convolutions corresponding to respective columns of a given 3×3 subtensor set) as data is shifted out of the TPU pairs following the final vector multiply interval. Also, as discussed in reference to FIG. 20, parallelism within the convolution engine may be increased by applying additional sets of TPUs (e.g., each TPU set operating on a respective data subset separated along the K axis or any other practicable data separation axis).

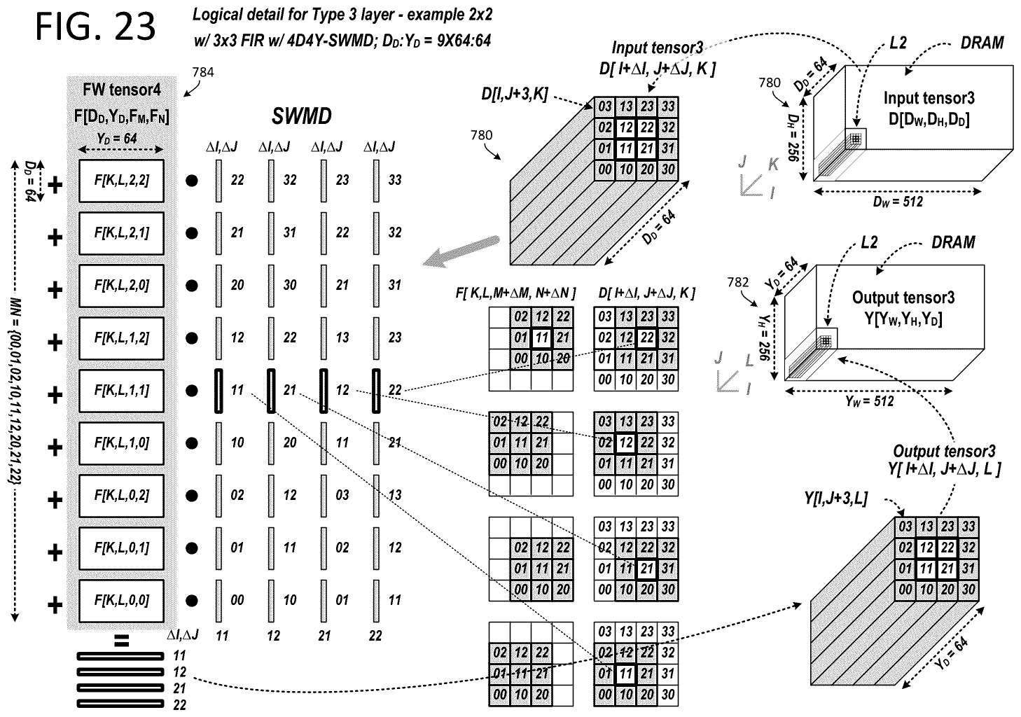

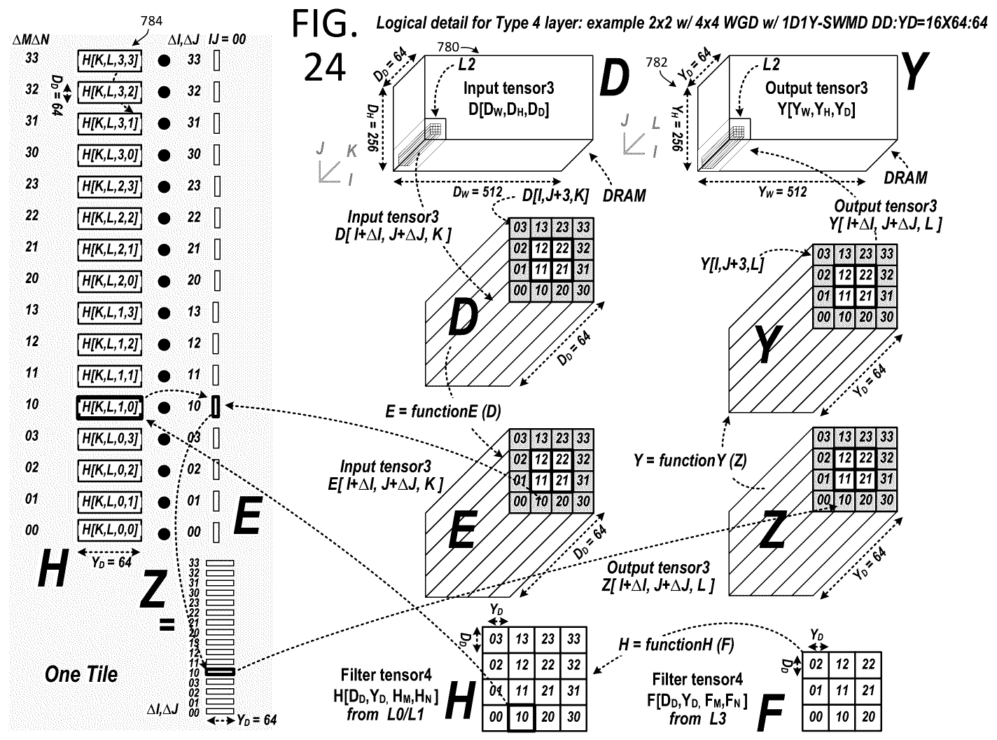

FIG. 23 illustrates exemplary logical detail for processing a convolutional neural net (CNN) layer with a 3×3 FIR filter using the broadcast-data SWMD mode, and more specifically 4D4Y-SWMD (i.e., four input sub-tensors (4D) processed concurrently to generate a corresponding set of four output sub-tensors (4Y) in a single-weight, multiple data configuration or mode). Input structure 780 is a tensor3 object D[DW,DH,DD] (here DW=512, DH=256, DD=64). The indices {I,J,K} are used to specify an element of D. Typically, extra columns (I={0, DW+1}) and extra rows (J={0, DH+1}) will pad the tensor3 object D[DW,DH,DD] with zero values of with duplicated input values. Output structure 782 is also a tensor3 object Y[YW,YH,YD] (here YW=512, YH=256, YD=64) in which indices {I,J,L} are used to specify an output structure (Y) data element. Filter weight structure is a tensor4 object F[DD,YD,FM,FN,] (here DD=64, YD=64, FM=3, FN=3). The indices {K,L,M,N} are used to specify an element of F.

As shown, a set of nine TPUs (each having 64 MAC processors, with four MAC units per processor) processes input vectors D[0:3,0:3,1:64]. The result of this operation—repeated 256×512/4 times to process the input tensor3 D[DW,DH,DD] into the output tensor3 Y[YW,YH,YD]—is four output vectors Y[1:2,1:2,1:64]. An initial step in the CNN processing is the movement of the F[1:64,1:64,0:2,0:2] filter weight elements from the L3 or DRAM memory to the L1/L0 memory of nine TPUs. After loading L1/L0 memory, the 4×4×64 tensor3 of vectors D[0:3,0:3,1:64] surrounding the four input vectors D[1:2,1:2,1:64] are accessed in a region of L2 memory and fed into the TPUs. Each vector of the 4×4×64 tensor3 of vectors D[0:3,0:3,1:64] is multiplied by one of the tensor2 (matrix) of F[K,L,M,N] filter weight according to the {M,N} indices. This is equivalent to 36 vector-matrix multiplies, with 36 vector products: F[K,L,M,N]*D[M′,N,K]=Y′[M,N,L]. Note that the {M′,N} index for the four sets of D vectors will be different; the M′ is shifted from the M index by a value of 10,1,2,31. The 36 vector products output from the nine TPUs (i.e., Y′[M,N,L]) are added into four output vectors Y[1:2,1:2,1:64] with the resultant output vectors (Y[1:2,1:2,1:64]) being written back to a region of L2 memory.

FIG. 24 shows the logical detail for processing a CNN layer with a 3×3 FIR filter using 1D1Y SWMD mode and Winograd (WGD) optimization. Winograd optimization with 1D1Y processing delivers a 2.25 performance increase relative to the 4D4Y-SWMD CNN processing shown in FIG. 23 (no WGD mode/optimization), and 4D4Y-SWMD with WGD (discussed below) delivers a 4× performance increase. Input and output structures (780, 782) are tensor3 objects having the same width, height and depth (DW, DH and DD) of counterpart structures shown in FIG. 23 (and same per-element indices {I,J,K} and {I,J,L}), and filter weight structure 784 is likewise a tensor4 object having the same dimensions (DD, YD, FM, FN) as the filter weight structure shown in FIG. 23 (using same per-element indices {K,L,M,N} to specify an element of F). In a number of embodiments, extra columns (I={0, DW+1}) and extra rows (J={0, DH+1}) are used to pad the tensor3 input structure D[DW,DH,DD] with zero values of with duplicated input values. In the 1D1Y-SWMD mode example, sixteen TPUs with 64 processing elements (PE) per TPU are applied processes input vectors D[0:3,0:3,1:64], with each PE performing one MAC operation per cycle to produce four output vector elements Y[1:2,1:2,1:64]. This operation is repeated 256×512/4 times to process the input tensor3 D[DW,DH,DD] into the output tensor3 Y[YW,YH,YD].

Still referring to FIG. 24, a first component operation of the Winograd optimization is conversion of the F[1:64,1:64,0:2,0:2] filter weight elements from the L3 or DRAM memory into the H[1:64,1:64,0:3,0:3] filter weight elements in the L1/L0 memory of the 16 TPUs. Concurrently with or following the filter weight conversion, the 4×4×64 tensor3 of vectors D[0:3,0:3,1:64] are converted into the E[0:3,0:3,1:64] vectors (a second component operation of the WGD optimization) with the latter (at least) held in a region of L2 memory. Each vector of the 4×4×64 tensor3 of vectors E[0:3,0:3,1:64] is multiplied by one of the tensor2 (matrix) of H[K,L,M,N] filter weight according to the {M,N} indices. This is equivalent to 16 vector-matrix multiplies, with 16 vector products: H[K,L,M,N]*E[M,N,K]=Z[M,N,L], an index mapping shown in FIG. 24 by the exemplary dotted-line inter-relationship between elements of the input tensors and output tensor. The 16 vector products Z[M,N,L] are converted into the four output vectors Y[1:2,1:2,1:64] (a third component of the WGD optimization), with those output vectors Y[1:2,1:2,1:64] written back to a region of L2 memory.

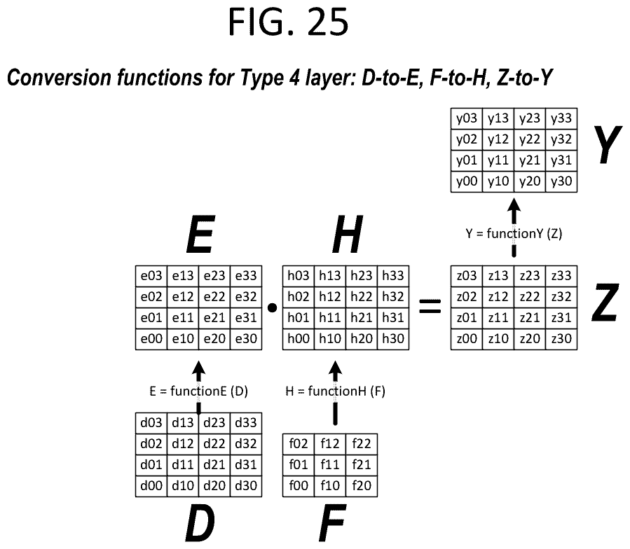

FIG. 25 illustrates an exemplary operational flow for the three component conversion operations applied to implement the Winograd (WGD) optimization method shown in FIG. 24. As shown, input data structure D and filter weight data structure F are converted to data and filter weight structures E and H, respectively, via functions E and H, with those converted structures convolved (vector multiplied) to yield intermediate output structure Z. Output structure Z is then converted, via function Y, to finalized output structure Y.

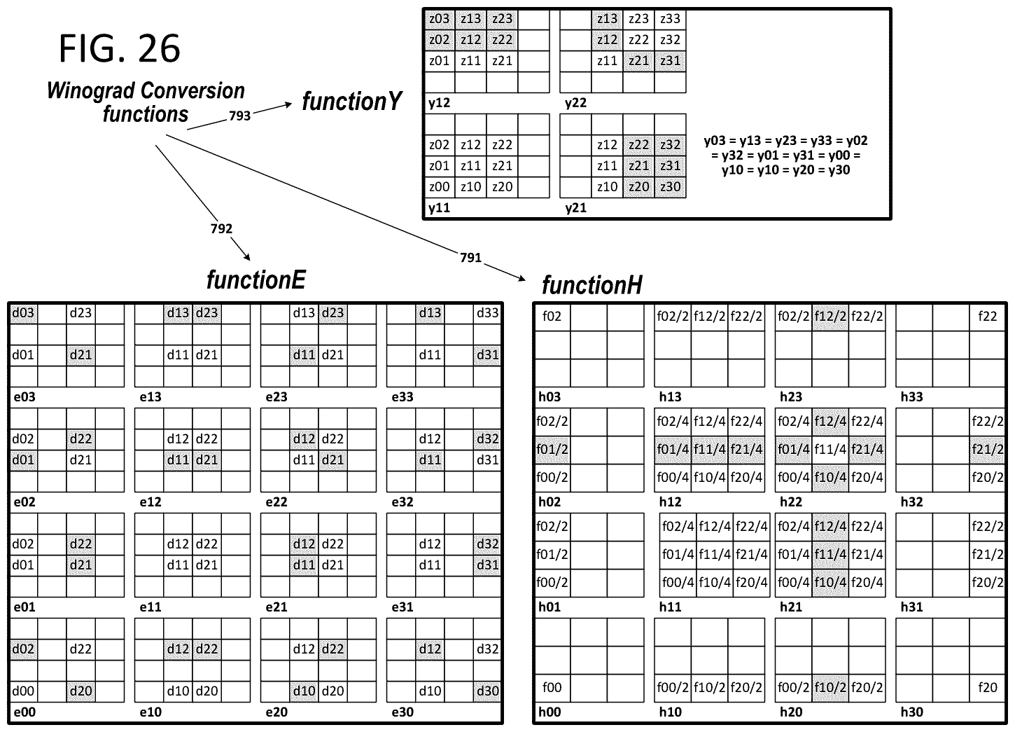

FIG. 26 shows the detail for each of the three conversion functions (E, H and Y)—component operations of the Winograd optimization as discussed in reference to FIG. 24 and outlined in FIG. 25. In the first component operation at 791, function-H is executed to convert the F[K,L,0:2,0:2] filter weight elements into the H[K,L,0:3,0:3] filter weight elements—a conversion executed independently for each {K,L} index combination. Each of the H[M,N] elements is created by adding (and subtracting) scaled elements of F[M,N] according to the notation inside of each box. The unshaded text indicates addition, and the shaded text indicates subtraction. The “/2” indicates scaling by “½”, and the “/2” indicates scaling by “¼”. Note that this scaling can be accomplished by an arithmetic right shift. The diagram at 792 shows the second step—execution of function-E to convert the D[K,ΔI,ΔJ] data elements into the E[K,ΔI,ΔJ] data elements (here {ΔI,ΔJ} have the range {0:3,0:3}). Note that this is done independently for each {K} index. Each of the E[K,ΔI,ΔJ] elements is created by adding (and subtracting) elements of D[K,ΔI,ΔJ] according to the notation inside of each box—again with unshaded text indicating added data elements the shaded text indicating subtracted data elements. Referring back to FIG. 25, the E[K,ΔI,ΔJ] data elements are multiplied by the H[K,L,0:3,0:3] elements to produce the Z[L,ΔI,ΔJ] result elements—multiplications executed independently for each {K,L} index combination. Also, note that, in at least one embodiment, this is not a matrix multiply, but a Hadamard multiply (element-by-element). Continuing with FIG. 26, the diagram at 793 diagram shows the fourth step—conversion of the Z[L,ΔI,ΔJ] result elements into the Y[L,ΔI,ΔJ] result elements (here {ΔI,ΔJ} have the range {0:3,0:3}), an operation implemented independently for each {L} index. Each of the Y[L,ΔI,ΔJ] elements is created by adding (and subtracting) elements of Z[Y,ΔI,ΔJ] according to the notation inside of each box (unshaded text indicating addition, and red text indicating subtraction). Note that only Y[L,1:2,1:2] need be written back to L2 memory.

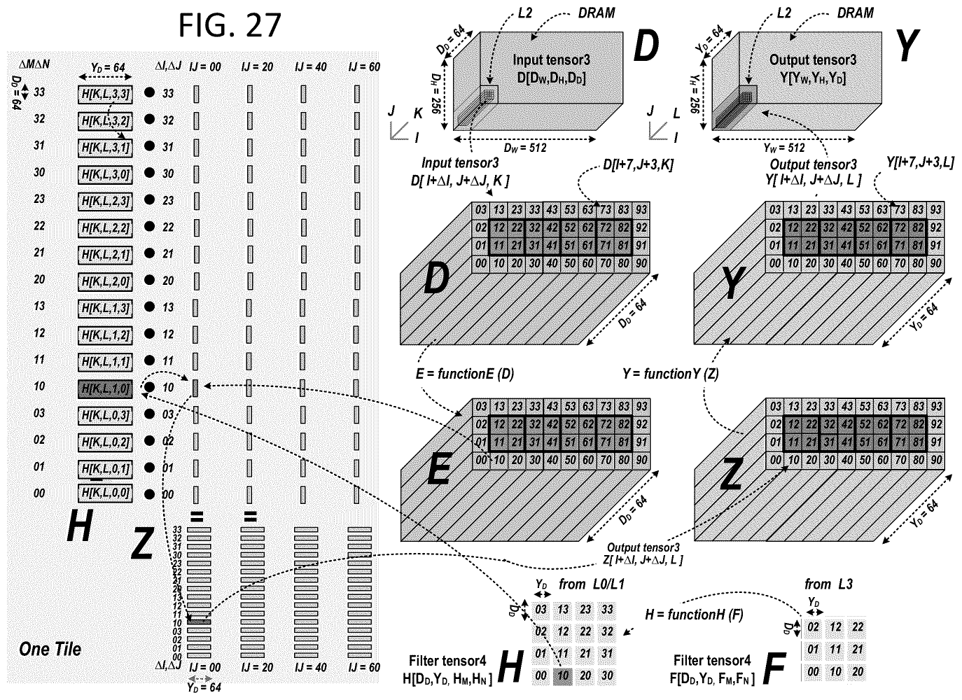

FIG. 27 illustrates the logical detail for processing a CNN layer with a 3×3 FIR filter using 4D4Y SWMD mode and Winograd (WGD) optimization. The depicted operations are comparable to the 1D1Y sequence shown in FIG. 24, except that four sets of data are processed simultaneously within each processing element of the 16×64 Pes (i.e., 16 TPUs each having 64 processing elements, with each processing element having four MAC units operable in parallel). The input structure is a tensor3 object D[DW,DH,DD] (here DW=512, DH=256, DD=64) in which indices {I,J,K} specify an element of D. In general, extra columns (I={0, DW+1}) and extra rows (J={0, DH+1}) will pad the tensor3 object D[DW,DH,DD] with zero values or with duplicated input values. Likewise, the output structure is a tensor3 object Y[YW,YH,YD] (here YW=512, YH=256, YD=64) in which indices {I,J,L} specify an element of Y. The filter weight structure is a tensor4 object F[DD,YD,FM,FN,] (here DD=64, YD=64, FM=3, FN=3) in which indices {K,L,M,N} specify an element of F.

The FIG. 27 embodiment operates 4D4Y-SWMD mode to process input vectors D[0:3,0:3,1:64] with 16 TPUs, with 64 processing elements per TPU, in which each PE can perform four MAC operations per MAC cycle to produce four output vectors Y[1:2,1:2,1:64]—a MAC cycle repeated 256×512/4 times to process the input tensor3 D[DW,DH,DD] into the output tensor3 Y[YW,YH,YD]. As discussed in FIGS. 25 and 26, processing commences with conversion of the F[1:64,1:64,0:2,0:2] filter weight elements from the L3 or DRAM memory into the H[1:64,1:64,0:3,0:3] filter weight elements in the L1/L0 memory of the 16 TPUs. The next step (which may be executed concurrently with the F-to-H conversion) is conversion of the four 4×4×64 tensor3 of vectors 4×D[0:3,0:3,1:64] into the 4×E[0:3,0:3,1:64] vectors with the converted input vectors (E) are held in a region of L2 memory. Each vector of the four 4×4×64 tensor3 of vectors 4×E[0:3,0:3,1:64] is multiplied by one of the tensor2 (matrix) of H[K,L,M,N] filter weight according to the {M,N} indices. This is equivalent to 64 vector-matrix multiplies, with 64 vector products: H[K,L,M,N]*E[M,N,K]=Z[M,N,L]—with index mapping shown by dashed arrows. The 64 vector products Z[M,N,L] are converted into the 16 output vectors Y[1:2,1:2,1:64] with those output vectors Y[1:2,1:2,1:64] being written to a region of L2 memory.

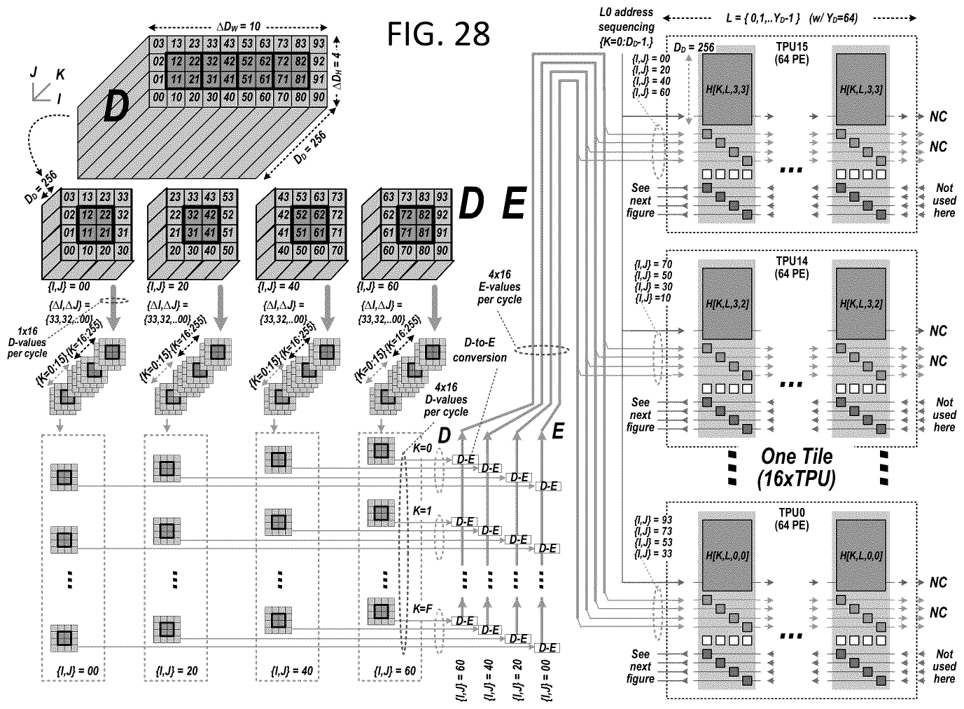

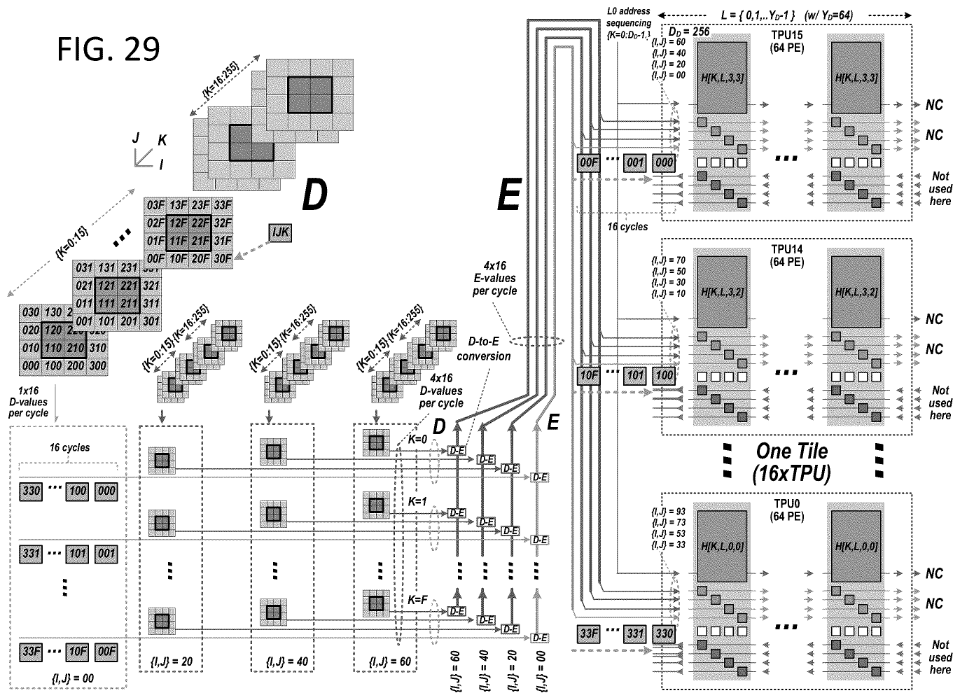

FIGS. 28 and 29 illustrate exemplary physical detail for processing a CNN layer with a 3×3 FIR filter using 4D4Y SWMD mode and Winograd (WGD) optimization (i.e., as in FIGS. 25-27), showing in particular the D-to-E conversion within the 4D4Y SWMD hardware set. Note that the step of F-H conversion may be implemented through a rotate-result/rotate-data TPU architecture (e.g., as described in reference to operations 150 or 155 of FIG. 2). The input structure is a tensor3 object D[DW,DH,DD] (here DW=512, DH=256, DD=256) in which indices {I,J,K} are used to specify an element of D. In the FIG. 28 example, a substructure D[ΔDW,ΔDH,DD] (here ΔDW=10, ΔDH=4, DD=256) is anchored at {I,J,K} and will be used during 256 execution cycles (DD=256), following which {I,J,K} will step to the next index value (this sequencing detail is shown in a subsequent section). As shown, the substructure D[ΔDW, ΔDH, DD] forms four working groups D[I′+ΔI, J′+ΔJ, K′+AK] used during 16 execution cycles, where {ΔI,ΔJ,ΔK} have the range {0:3,0:3,0:15}. Also, I′={I+0,I+2,I+4,I+6}, J′=J, and K′={0,16,32, . . . 256}, where {I,J,K} is the anchor point of the substructure. Note that the four working groups will have overlapping regions: D[2,3,0] is present in block {00} and block {20}, for example), and will thus be converted to two different E element values in the conversion operations to follow (an important point to remember). The 16 D elements in each D[I′+ΔI,J′+ΔJ,K′+ΔK] slice from each of the four working groups are passed to the D-to-E conversion blocks. Here D have the range {0:3,0:3,0:15}, and {I′,J′,K′} have the values {{I+0,I+2,I+4,I+6},J,0}. Note that there are 64 of these slices with 16 D elements, and they are sorted by {K} index and sent to the 16 sets of 4× D-E conversion blocks. Each of the four D-E conversion blocks in a set sorts the 16 element slices by {I′} value. The 16 D elements slices are handled at the rate of one element per cycle, in the order {ΔI,ΔJ}={33,32,31, . . . 01,00}. There are a total of 64 D-E conversion blocks, so that 64 D elements are converted per cycle. The four working groups D[I′+ΔI,J′+ΔJ,K′+ΔK] are converted to E[I′+ΔI,J′+ΔJ,K′+ΔK] in 16 cycles, where {ΔI,ΔJ,ΔK} have the range {0:3,0:3,0:15}, and where I′={I+0,I+2,I+4,I+6}, J′=J, and K′={0}. In each cycle, 64E elements are broadcast on the D_IN[3:0] input buses of each of the 16 TPUs of the Tile. They are multiplied by the appropriate H[K,L,ΔI,ΔJ] element from the L0 memory and are added to the appropriate accumulation register Z[I′+ΔI,J′+ΔJ,L′+ΔL].

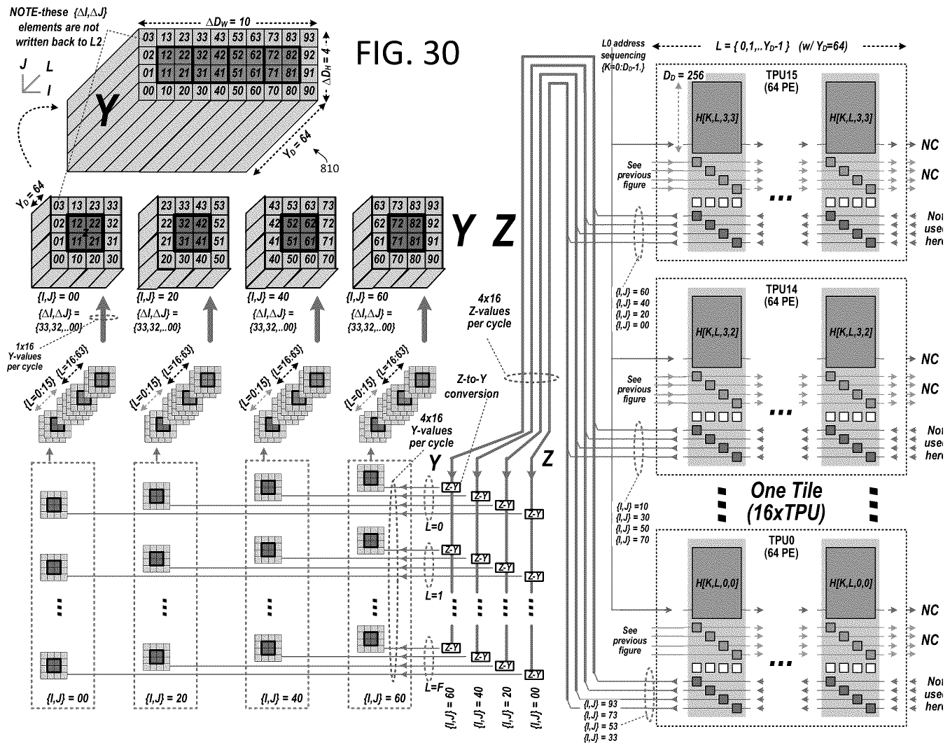

FIG. 30 illustrates additional exemplary physical detail for processing a CNN layer with a 3×3 FIR filter using 4D4Y SWMD mode and Winograd (WGD) optimization, showing in particular the Z-to-Y conversion carried out after 4D4Y SWMD accumulation of the E[I,J,K]*H[K,L,M,N] products. In the depicted example 4096 accumulation values Z[I′+ΔI,J′+ΔJ,L′+ΔL] are transferred into the shift-out register chain in the 64 PEs in each of the 16 TPUs in the Tile (i.e., with {ΔI,ΔJ,ΔL} having the range {0:3,0:3,0:15}, and where I′={I+0,I+2,I+4,I+6}, J′=J, and L′={0,16,32,48}) and are unloaded at the rate of 64 accumulation values per cycle. In each cycle, all combinations of {I′,ΔL} are transported on the 64 shift-out buses (where I′={I+0,I+2,I+4,I+6} and {ΔL}={0:15}), a shift-out sequence repeated for 16 cycles, with {ΔI,ΔJ} cycling through the range {0:3,0:3}, and the 16 cycle sequence repeated four times (with L′={0,16,32,48}) to unload the 4096 values. The 64 accumulation values Z[I′+ΔI,J′+ΔJ,L′+ΔL] that unload per cycle form four working groups that are passed to the four sets of Z-to-Y conversion blocks. The four working groups and four Z-to-Y sets are indexed by I′={I+0,I+2,I+4,I+6} and sub-indexed by the {ΔL}={0:15} value. Each of the 16 Z-to-Y conversion blocks in a set works on 16 Z accumulation values, sorted by {ΔI,ΔJ} cycling through the range {33,32,31, . . . 01,00}. By this operation, the 4096 interim accumulation values Z[I′+ΔI,J′+ΔJ,L′+ΔL] are converted to 4096 final accumulation values Y[I′+ΔI,J′+ΔJ,L′+ΔL], with those final accumulation values written back to the output substructure Y[ΔYW,ΔYH,YD] (here ΔDW=ΔYW and ΔDH=ΔYH). As in examples above, the output structure is a tensor3 object Y[YW,YH,YD] (here YW=512, YH=256, YD=64) in which indices {I,J,K} are used to specify an element of Y. FIG. 30 illustrates an exemplary substructure 810 (i.e., Y[ΔYW,ΔYH,YD], where ΔYW=10, ΔYH=4, YD=64) formed from four working groups Y[I′+ΔI,J′+ΔJ,L′+ΔL], where {ΔI,ΔJ,ΔL} have the range {0:3,0:3,0:15}. Also, I′={I+0,I+2,I+4,I+6}, J′=J, and L′={0,16,32,48}, where {I,J,K} is the anchor point of the substructure and the 64 Z-to-Y conversion blocks produce 64 Y accumulation results per cycle. Because only the Y[I′+ΔI,J′+ΔJ,L′+ΔL] values with {ΔI,ΔJ} equal to {22,21,12,11} will be non-zero and require storage, only 1024 Y accumulation results will need to be written back to the output substructure in the 64 cycles that are required to unload the 16 TPUs. Also, the 64 cycle unload time is only one fourth of the 256 cycle input load time (the ratio of PE/TPU=64 vs L0 depth=256), enabling implementations with reduced unload circuitry as described below.

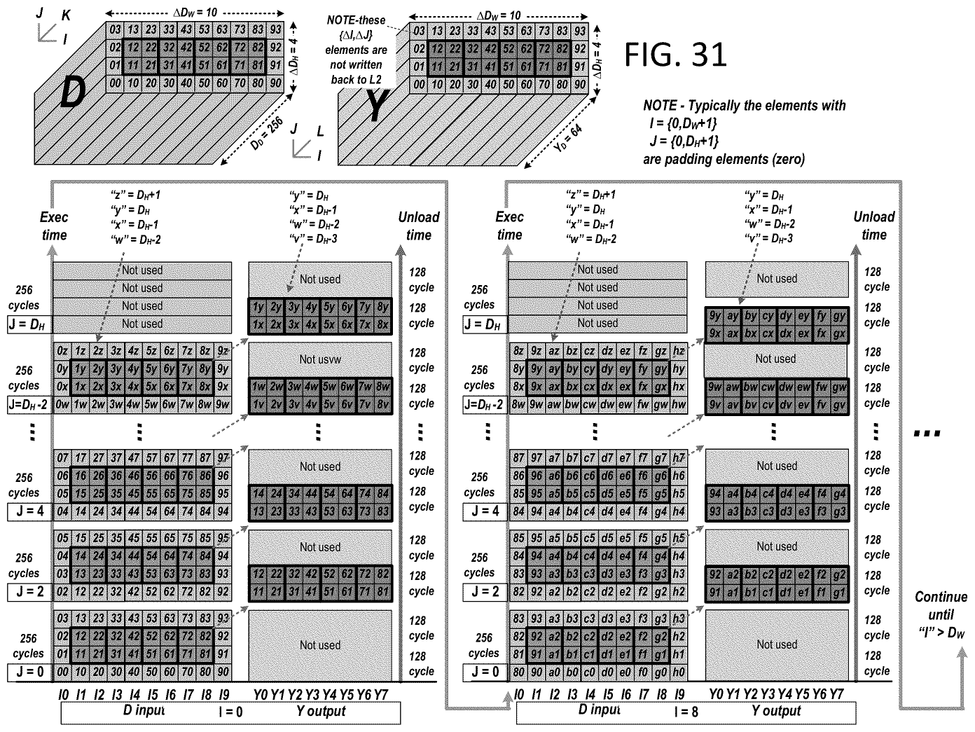

FIG. 31 illustrates exemplary first-level sequencing detail for processing the logical model layer from previous FIGS. 27-30. This layer includes a tensor3 input D[DW,DH,DD] with DW=512, DH=256, DD=256, a tensor3 output Y[YW,YH,YD] with YW=512, YH=256, YD=64, and a tensor4 filter weight F[DD,YD,FM,FN,] with DD=256, YD=64, FM=3, FN=3 (note that the sequencing diagram does not show the interim/Winograd tensors {E,H,Z} which are converted from/to {D,F,Y}). Starting in the lower-left corner of FIG. 31, the first 256 cycles show the handling of the initial input substructure D[ΔDW,ΔDH,DD] in which ΔDW=10, ΔDH=4, DD=256. As discussed above, the substructure forms four working groups D[I′+ΔI,J′+ΔJ,K′+ΔK], where {ΔI,ΔJ,ΔK} have the range {0:3,0:3,0:15}, and also, I′={I+0,I+2,I+4,I+6}, J′=J, and K′={0,16,32, . . . 256}, where {I,J,K} is the anchor point of the substructure. The sequencing control logic (not specifically shown in FIG. 31) applies these 40 input values to generate the 16 output accumulation values that are available in the next 256 cycle interval—output accumulation values that are written into the Y[1:8,1:2,1:64] locations in the output tensor in L2 memory. The exemplary 128-cycle unloading interval is less than the 256-cycle execution interval, leaving a time interval (between the execute time and the unload time) that may be exploited for Winograd optimization operations (as discussed below). In any case, the 256 cycle execution interval will be repeated at substructure {I,J,K} after the J index has incremented by “+2”, a progression continued across the [J] range until [J>DH], moving to the upper left of the FIG. 31 sequence diagram. Note that an additional unload interval is provided for the final set of accumulation totals. After that final-accumulation unload, the sequence of 256*(DH+1)*4/2 cycles is repeated for the next substructure D[ΔDW,ΔDH,DD], after the I index has incremented by “+8” as shown at the right-hand side of FIG. 31. Processing of the D[ΔDW,ΔDH,DD] substructures continues via additional sequences of 256*(DH+1)*4/2 cycles (with the I index again incremented by “+8” at intervals corresponding to that shown in FIG. 31) until the I index has reached the DW limit (I>DW), at which point the processing of this layer has completed.

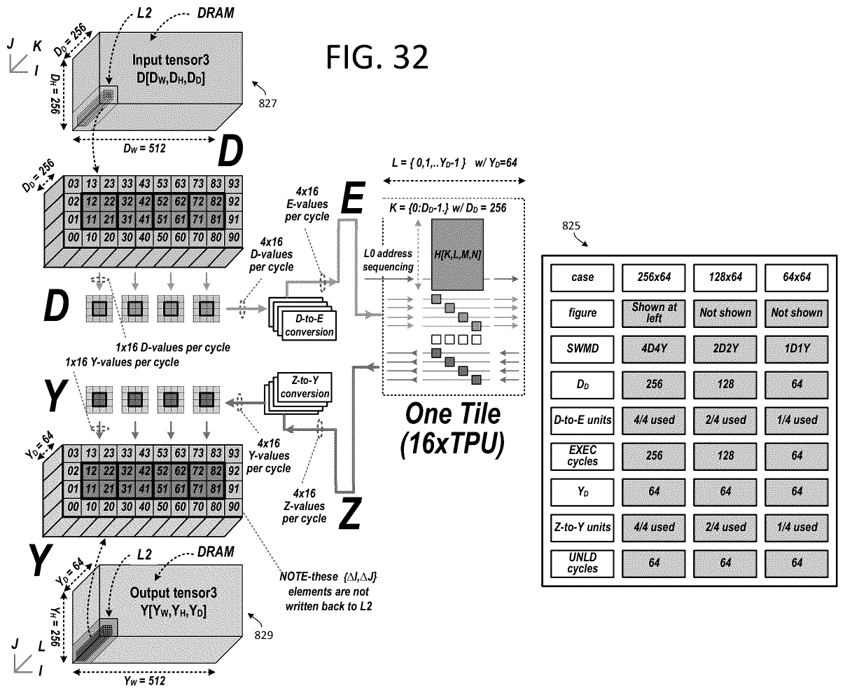

FIG. 32 illustrates exemplary logical detail for processing a CNN layer with a 3×3 FIR filter using 4D4Y SWMD mode and Winograd (WGD) optimization. The operational sequence is similar to those discussed in reference to FIGS. 24-31, but with various different DD:YD combinations shown in respective columns of table 825. The first case (leftmost shaded column in table 825) implements DD:YD=256:64 using 4D4Y-SWMD mode and corresponds to the exemplary processing diagram depicted at the left side of FIG. 32. As shown, input structure shown 827 is a tensor3 object D[DW,DH,DD] in which DW=512, DH=256, DD=256), output structure 829 is a tensor3 object Y[YW,YH,YD] in which YW=512, YH=256, YD=64), and filter weight structure (not specifically shown) is a tensor4 object F[DD,YD,FM,FN,] in which DD=256, YD=64, FM=3, FN=3. Each MAC processing tile includes sixteen 64-PE TPUs (i.e., 64 processing elements (PEs) per TPU) in which each PE can perform four MAC operations per cycle, and in which 256 cycles are applied to process each input substructure of 4×4×4×256 E elements, and 64 cycles are applied to unload 4×4×4×64 Z elements. The second case (middle shaded column in table 825) uses DD:YD=128:64 and 2D2Y-SWMD mode. The input structure is a tensor3 object D[DW,DH,DD] in which DW=512, DH=256, DD=128), the output structure is a tensor3 object Y[YW,YH,YD] in which YW=512, YH=256, YD=64, and the filter weight structure is a tensor4 object F[DD,YD,FM,FN,] for which DD=128, YD=64, FM=3, FN=3. The processing tile includes sixteen 64-PE TPUs, in which each PE can perform two MAC operations per cycle so that 128 cycles are consumed to process each input substructure of 2×4×4×256 E elements and 64 cycles are needed to unload 2×4×4×64 Z elements. The third case (rightmost column in the table) uses DD:YD=64:64 and 1D1Y-SWMD mode. The input structure is a tensor3 object D[DW,DH,DD] in which DW=512, DH=256, DD=64, the output structure is a tensor3 object Y[YW,YH,YD] in which YW=512, YH=256, YD=64, and the filter weight structure is a tensor4 object F[DD,YD,FM,FN,] in which DD=64, YD=64, FM=3, FN=3). The processing tile again includes 16 64-PE TPUs, but in which each PE can perform a single (one) MAC operation per cycle (instead of two or four as in the other two cases) so that 64 cycles are needed to process each input substructure of 1×4×4×256 E elements and 64 cycles are needed to unload 1×4×4×64 Z elements.

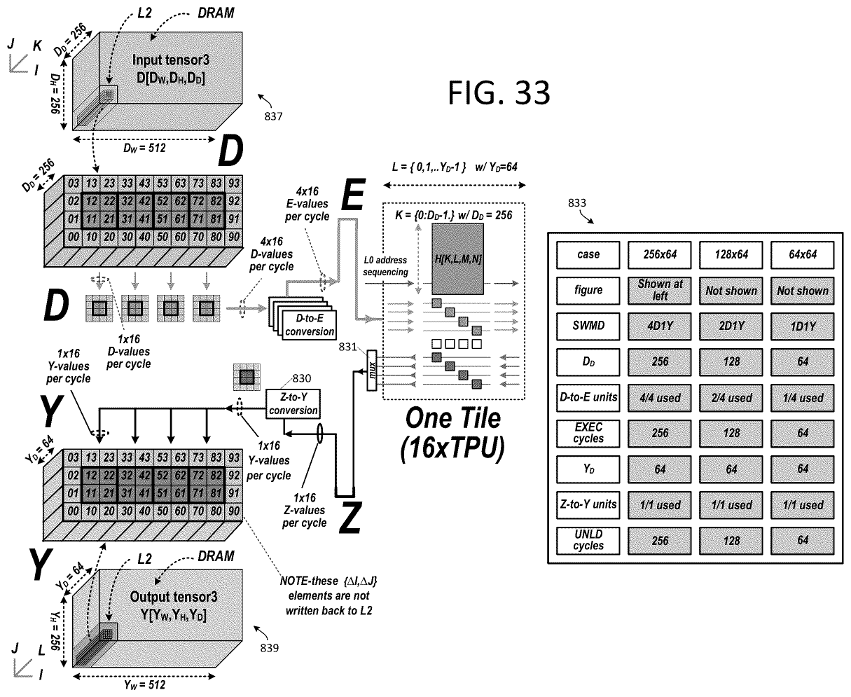

FIG. 33 illustrates exemplary logical detail for processing a CNN layer with a 3×3 FIR filter using 4D4Y SWMD mode and Winograd (WGD) optimization—layer processing similar to that shown in FIG. 32, except that the number of Z-to-Y conversion blocks has been reduced from four to one (830), with that single Z-to-Y conversion block receiving the outputs of the four shift-out (MAC_SO) buses via a 4-to-1 multiplexer 831. This reduces the cost of the conversion logic without impacting the performance (this is a result of the fact that the ratio of L0 depth vs PE/TPU is 256:64). The first case shown in table 833 (leftmost shaded column) uses DD:YD=256:64 and 4D1Y-SWMD mode and corresponds to the processing diagram at the left side of FIG. 33. As shown, input structure 837 is a tensor3 object D[DW,DH,DD] in which DW=512, DH=256, DD=256, output structure 839 is a tensor3 object Y[YW,YH,YD] in which YW=512, YH=256, YD=64, and the filter weight structure (not specifically shown) is a tensor4 object F[DD,YD,FM,FN,] for which DD=256, YD=64, FM=3, FN=3. The processing tile executes with sixteen 64-PE TPUs in which each PE can perform four parallel MAC operations per cycle so that 256 cycles are applied to process each input substructure of 4×4×4×256 E elements, and 256 cycles are applied to unload 4×4×4×64 Z elements. The second case (middle shaded column in table 833) uses DD:YD=128:64 and 2D1Y-SWMD mode. The input structure is a tensor3 object D[DW,DH,DD] in which DW=512, DH=256, DD=128, the output structure is a tensor3 object Y[YW,YH,YD] having YW=512, YH=256, YD=64, and the filter weight structure is a tensor4 object F[DD,YD,FM,FN,] in which DD=128, YD=64, FM=3, FN=3. The processing tile includes sixteen 64-PE TPU in which each PE executes two MAC parallel operations per cycle so that 128 cycles are applied to process each input substructure of 2×4×4×256 E elements, and 128 cycles likewise applied to unload 2×4×4×64 Z elements. The third case (rightmost shaded column in table 833) uses DD:YD=64:64 and 1D1Y-SWMD mode. The input structure is a tensor3 object D[DW,DH,DD] in which DW=512, DH=256, DD=64), the output structure is a tensor3 object Y[YW,YH,YD] in which YW=512, YH=256, YD=64, and the filter weight structure is a tensor4 object F[DD,YD,FM,FN,] for which DD=64, YD=64, FM=3, FN=3. In this case, each processing tile includes sixteen 64-PE TPUs having a single MAC channel (one MAC operation per MAC cycle) so that 64 cycles are needed to process each input substructure of 1×4×4×256 E elements, and 64 cycles are needed to unload 1×4×4×64 Z elements.

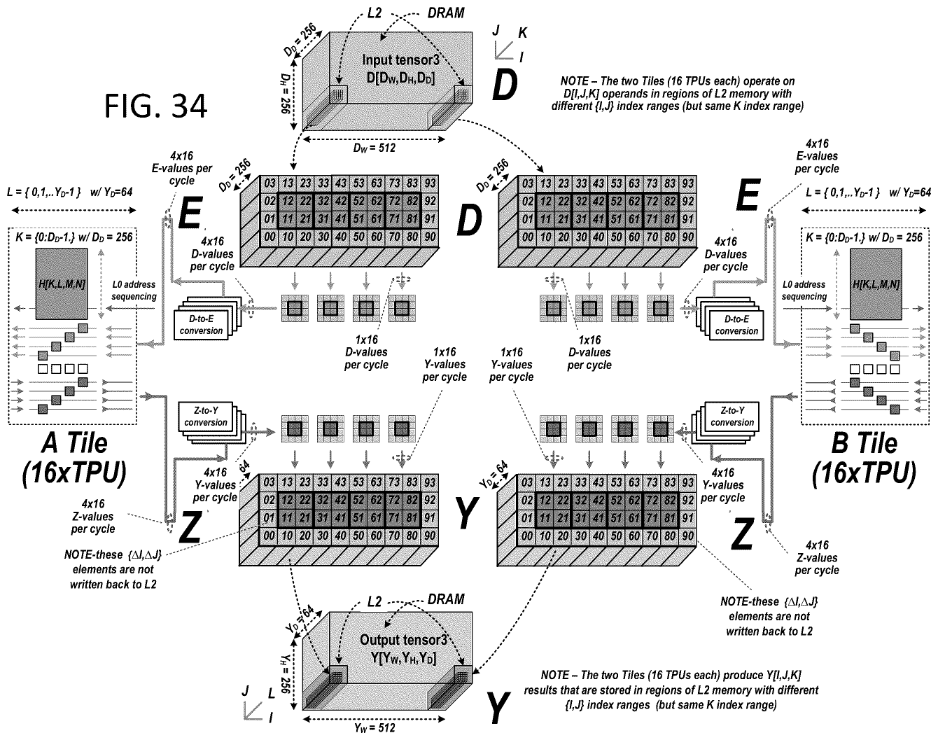

FIG. 34 illustrates exemplary extension of the single-tile processing shown in foregoing examples to two or more processing tiles (e.g., each having sixteen 64-processing-element TPUs) to parallel process larger model layers. As in examples above, the input structure is a tensor3 object D[DW,DH,DD] in which DW=512, DH=256, DD=256) and indices {I,J,K} are used to specify an element of D; the output structure is a tensor3 object Y[YW,YH,YD] in which YW=512, YH=256, YD=64) and indices {I,J,L} are used to specify an element of Y; and the filter weight structure is a tensor4 object F[DD,YD,FM,FN,] in which DD=256, YD=64, FM=3, FN=3 and indices {K,L,M,N} are used to specify an element of F. In the depicted example, a first processing tile (“Tile A”) includes sixteen 64-PE TPU and operates in 4D4Y-SWMD mode (i.e., each PE can perform four MAC operations per cycle) so that 256 cycles are applied to process each input substructure of 4×4×4×256 E elements, and 64 cycles are applied to unload 4×4×4×64 Z elements (this substructure operation is repeated 256×512/4 times to process the input tensor3 D[DW,DH,DD] into the output tensor3 Y[YW,YH,YD]).

Still referring to FIG. 34, a second processing tile (“Tile B”), also having sixteen 64-PE TPUs is coupled to access to the input and output data structures in L2 memory and executes a parallel set of processing operations to halve the total time otherwise required to process the complete CNN layer. In the depicted example, per-processing-tile access to the input and output data structures are separated with via [I,J] indices with each tile processing 4×4×4×256 substructures in different regions of the IJ plane. In a number of embodiments, the two regions are located in different L2 memory banks (each processing tile has direct access to eight 256 KB L2 memory banks, for example) but may nevertheless share a small overlap area. For example, if the IJ plane is divided at the I=DW/2 line, each (DW*DH/2) region will need (1*DH) elements copied from the other region. This adds a small amount of overhead (˜2/DW˜0.8%) when the input data is transported from DRAM to L2. Otherwise, this aggregation method is relatively straightforward because the two tiles (A and B) can process their respective regions with coarse coordination.

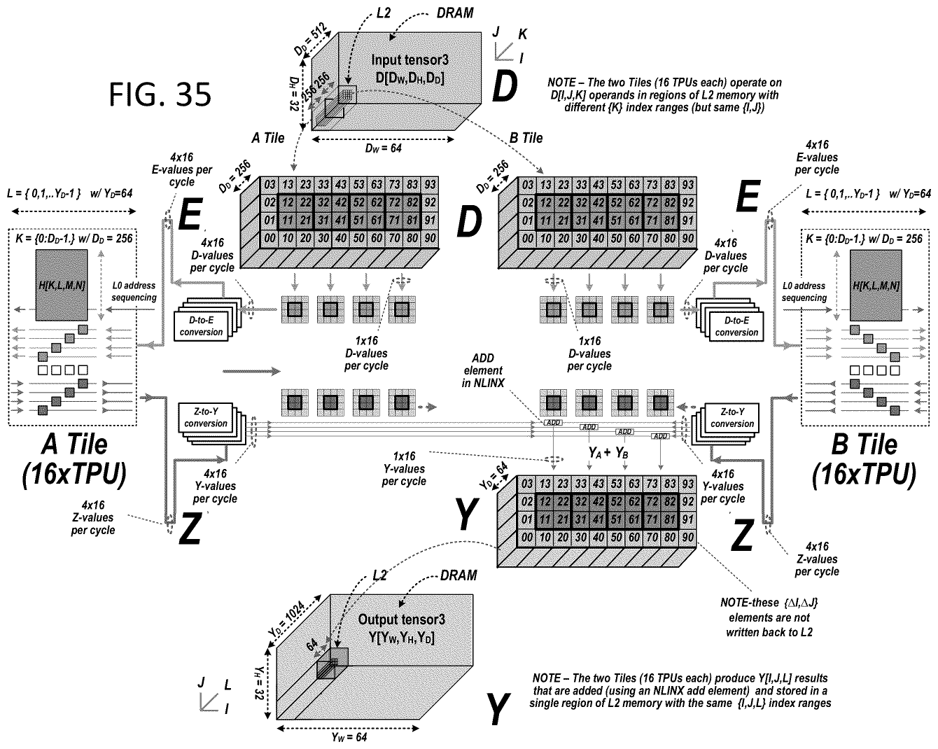

FIG. 35 illustrates another TPU aggregation example, again extending the single 16-TPU tile example to two or more 16-TPU tiles (e.g., 32 or more TPUs altogether) so that a larger model layer can be processed. As before, the input structure is a tensor3 object D[DW,DH,DD] in which DW=512, DH=256, DD=256, and indices {I,J,K} specify an element of D; the output structure is a tensor3 object Y[YW,YH,YD] in which YW=512, YH=256, YD=64 and indices {I,J,L} specify an element of Y; and the filter weight structure is a tensor4 object F[DD,YD,FM,FN,] in which DD=256, YD=64, FM=3, FN=3 and indices {K,L,M,N}specify an element of F. Each of the 16 TPUs per tile (i.e., within tiles A and B, at least) includes 64 processing elements (PEs) with each PE having four MAC channels to enable operation in the 4D4Y-SWMD mode (i.e., each PE can perform four MAC operations per cycle). Accordingly, 256 cycles are applied to process each input substructure of 4×4×4×256 E elements, and 64 cycles are applied to unload 4×4×4×64 Z elements resulting from the sub-structure processing—the substructure processing/unload operations being repeated 256×512/4 times to process the input tensor3 D[DW,DH,DD] into the output tensor3 Y[YW,YH,YD].

Still referring to FIG. 35, each of the 16-TPU tiles (only two tiles, A and B, are depicted, but additional tiles may be devoted to parallel process the input structure) are coupled to access the input and output structures in L2 memory, in this case with input-structure separation along the [K] index (rather than the [I,J] indices in FIG. 34). In the two-tile example shown, each processing tile processes 4×4×4×256 substructures in different regions of the K plane—two input regions that may be located in different L2 memory banks (e.g., each tile having direct access to a respective set of eight 256 KB L2 memory banks). In general, the K-plane-separation approach requires that individual processing tiles have some interaction, particularly in the Winograd optimized approach shown. In a number of embodiments, for example, the two sets of 4×4×4×64 Z elements from the two sets of 4×4×4×256 E elements are converted to two sets of 4×4×4×64 Y elements and added before they are written to the output structure. FIG. 35 illustrates this interaction in the 4×16 Y values per cycle transported from Tile A to Tile B, where they are added with the 4×16 Y values generated per cycle and written to the output structure. Because three-fourths of the Y values are zero, it is only necessary to transport 1×16 Y values per cycle. Nonetheless, this requires relatively fine-grain coordination between the two tiles. In an alternative embodiment, some L2 memory (or temporary memory) is provided to buffer the 1×16 Y values transferred per cycle to ease/relax timing constraints between the A and B processing tiles—a timing benefit at the cost of increased L2 bandwidth demand in one of the two processing tiles (e.g., increasing L2 BW from ˜69% to ˜81% in one of the two processing tiles).

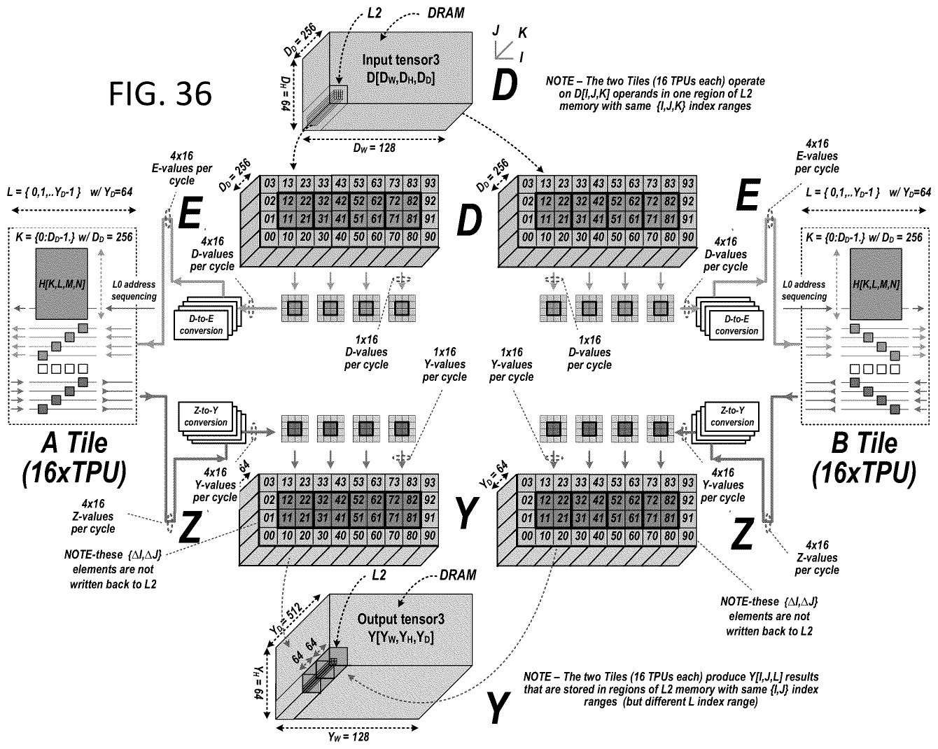

FIG. 36 illustrates another aggregation example that extends the single 16-TPU tile example to two or more 16-TPU tiles (e.g., 32 or more TPUs altogether) so that a larger model layer can be processed. As in the preceding two examples (FIGS. 34 and 35), the input structure is a tensor3 object D[DW,DH,DD] for which DW=512, DH=256, DD=256) and indices {I,J,K} specify an element of D; output structure is a tensor3 object Y[YW,YH,YD] in which YW=512, YH=256, YD=64 and indices {I,J,L} specify an element of Y; filter weight structure is a tensor4 object F[DD,YD,FM,FN,] for which DD=256, YD=64, FM=3, FN=3 and indices {K,L,M,N} specify an element of F; and all TPUs operate in 4D4Y-SWMD mode (e.g., sixteen 64-PE TPUs per tile in which each PE can perform four MAC operations per cycle). Under these parameters, 256 MAC cycles are applied to process each input substructure of 4×4×4×256 E elements, and 64 MAC cycles are applied to unload 4×4×4×64 Z elements—a substructure operation repeated 256×512/4 times to process the input tensor3 D[DW,DH,DD] into the output tensor3 Y[YW,YH,YD].

In the FIG. 36 embodiment, each of the 16-TPU tiles (only two tiles, A and B, are depicted, but additional tiles may be devoted to parallel process the input structure) are coupled to access the input and output structures in L2 memory, in this case with output-structure separation along the [L] index (rather than along the [I,J] indices to the input and output structures in FIG. 34 or along the [K] index of the input structure in FIG. 35). As shown, each tile processes 4×4×4×256 substructures in the same region of the K plane (in the same L2 memory bank but writes processing results to different regions of the output structure (e.g., in different L2 banks). As in the [K]-separation approach, output-structure separation along the [L] index method may require some interaction between the two processing tiles. In the depicted example, for instance, one set of 4×4×4×64 D elements from a substructure are transported from one processing tile to the other at the rate of 4×16 D values per MAC cycle. Alternatively, one set of converted 4×4×4×64 E elements from a substructure may be transported from one processing tile to the other at the rate of 4×16 E values per cycle (an implementation option that saves some conversion power). Power consumed reading data from L2 memory is reduced in either cased as is the total L2 bandwidth consumed by each processing tile.

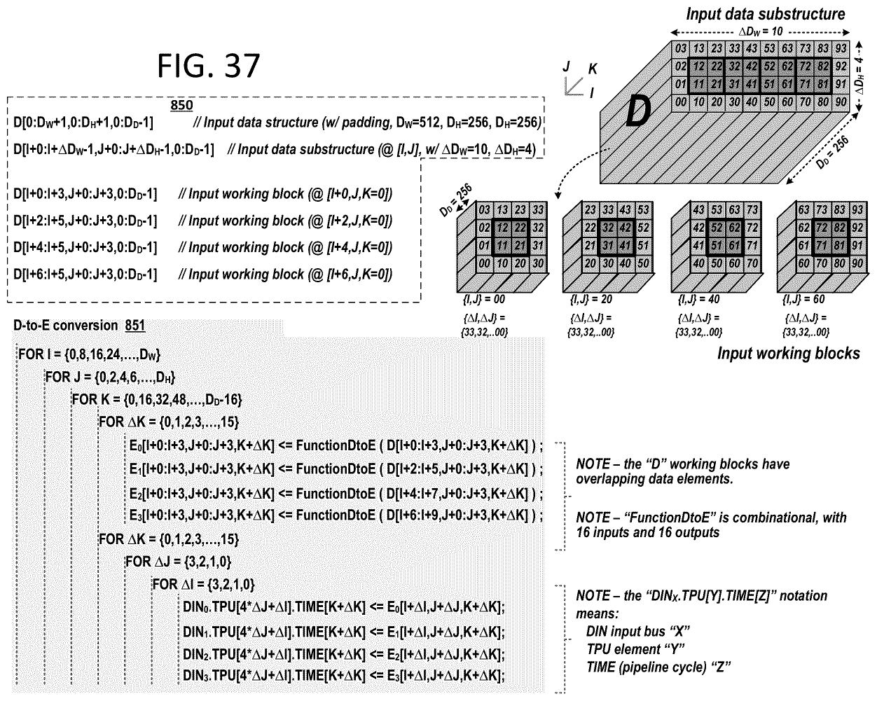

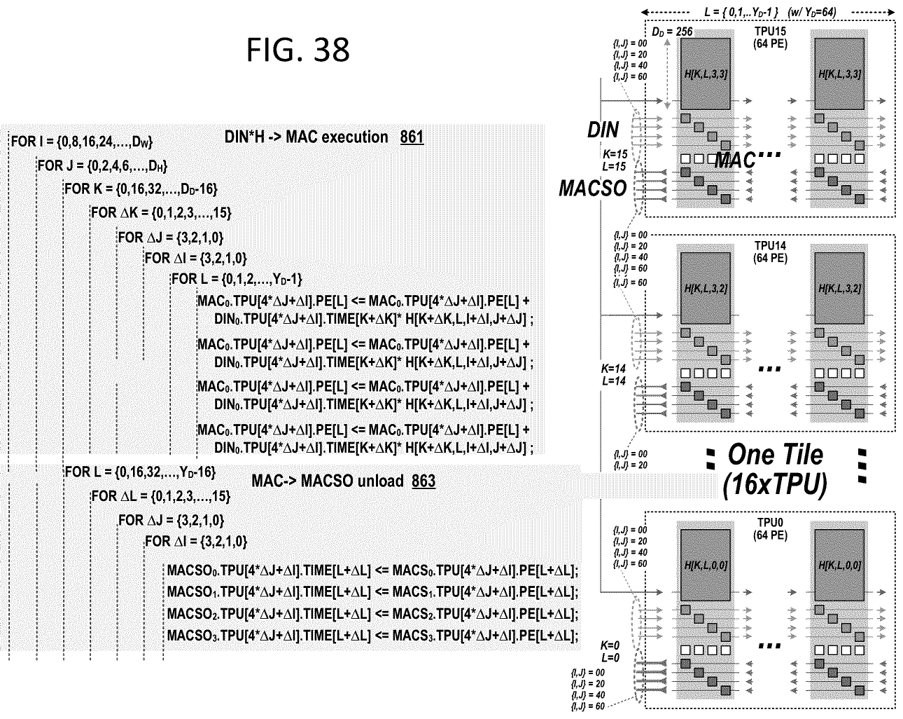

FIGS. 37, 38 and 39 illustrates exemplary pseudo-code detail for the Winograd-optimized CNN layer-processing examples discussed above, a detail divided into three sections to cover (i) the D-E conversion (FIG. 37); (ii) MAC execution and Z-result unload operations (FIG. 38); and (iii) Z-to-Y conversion steps. In each instance, the exemplary pseudo-code is temporally stretched out (i.e., de-emphasizing concurrent/overlapping pipestages within the processing pipeline rather than showing pipeline timing) to avoid obscuring data steering and indexing operations—in the actual physical hardware all the resources (pipeline stages) are utilized in every cycle.

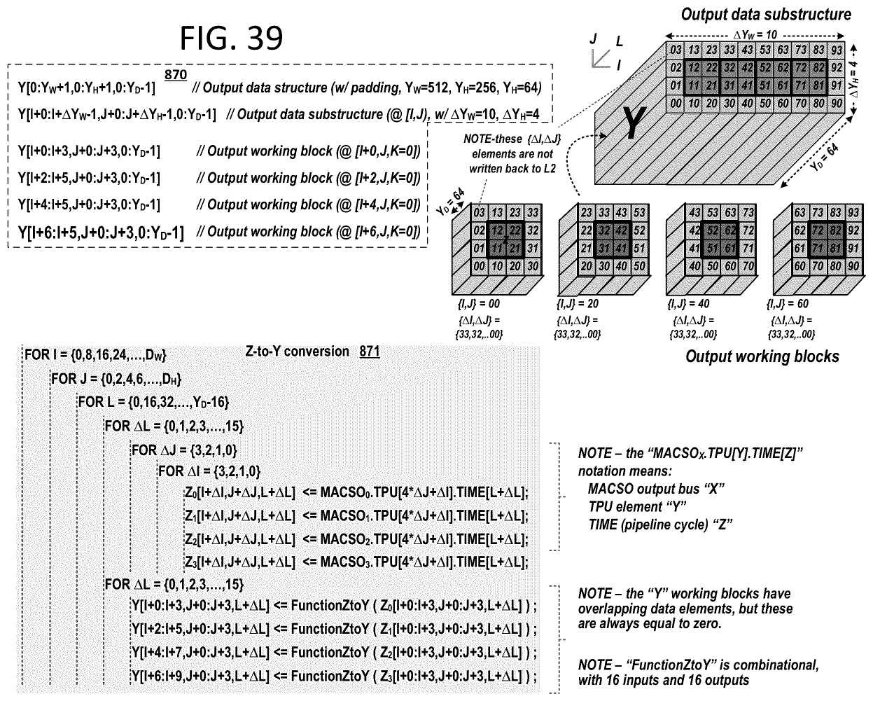

In FIG. 37, exemplary dimensions/spans of an input data structure (a tensor3 with approximate dimensions D[DW,DH,DD] including padding in the {I,J} plane), input data substructure (a tensor3 with dimensions D[ΔDW,ΔDH,DD]) and four input working blocks (four tensor3 structures, each with dimensions D[4,4,DD], including overlapping elements in the {I,J} plane) are shown at 850. The D-to-E conversion pseudo-code shown at 851 includes three outer loops (“FOR”) with indexes {I,J,K}. The {I,J} loops, which likewise appear in the processing examples of FIGS. 38 and 39, step through all the input data substructures within the input data structure, while the third loop index {K} is common to the processes shown in FIGS. 37 and 38. The {K} loop steps through the DD dimension in steps of 16 (the number of processing elements per tile) and includes two internal {ΔK} loops, executed concurrently in actuality despite their separate/sequential depiction. In the first of the two internal loops index {ΔK} steps through the values {0, 1, . . . 15} so that the sum {K+ΔK} steps through the DD dimension in steps of +1. The first working block D[I+0:I+3,J:J+3,K+ΔK] includes 16 input values. These are passed to the FunctionDtoE, which generates the first converted working block E0[I+0:I+3,J:J+3,K+ΔK], also with 16 values. Note that this is shown as a combinational function here—the actual physical TPU hardware implements this logic as a multi-stage pipeline. The remaining three working blocks {D[I+2:I+5,J:J+3,K+ΔK], D[I+4:I+7,J:J+3,K+ΔK], D[I+6:I+9,J:J+3,K+ΔK]} are converted to the three converted working blocks {E1[I+2:I+5,J:J+3,K+ΔK], E2[I+4:I+7,J:J+3,K+ΔK], E2[I+6:I+9,J:J+3,K+ΔK]}. In the second internal loop, index {ΔK} is also sequenced/incremented through the values {0, 1, . . . 15} so that the sum {K+ΔK} steps through the DD dimension in steps of +1. Two additional loops with the indexes {ΔI,ΔJ} are nested within the second internal {ΔK} loop. These {ΔI,ΔJ} loops step through all the values in the first converted working block E0[I+ΔI,J+ΔJ,K+ΔK] to enable those values (e.g., 16 values in this example) to be passed to the DIN0 input of each of the 16 TPUs (TPU[4*ΔJ+ΔI]) at the time slot TIME[K+ΔK]. Note that a time element is introduced explicitly here, because the DIN input bus is a time-multiplexed resource for all of the PEs in a particular TPU. The remaining three converted working blocks {E1[I+ΔI,J+ΔJ,K+ΔK], E2[I+ΔI,J+ΔJ,K+ΔK], E3[I+ΔI,J+ΔJ,K+ΔK]} are passed to the {DIN1, DIN2, DIN3} inputs of each of the 16 TPUs (TPU[4*ΔJ+ΔI]) at the time slot TIME[K+ΔK] in the same way, collectively yielding {DIN0, DIN1, DIN2, DIN3}·TPU[4*ΔJ+ΔI]·TIME[K+ΔK]} values that are applied as discussed below.

As mentioned, FIG. 38 illustrates exemplary the pseudo-code detail for MAC execution and Z-result unload operations, with the execution process (861) including the three outer three {I,J,K} loops discussed above. In the first of four inner loops nested within the {K}loop, index {ΔK} steps through the values {0, 1, . . . 15} so that the sum {K+ΔK} steps through the DD dimension in steps of +1. The next two loops have the indexes {ΔI,ΔJ}. These {ΔI,ΔJ} loops step through all the relative {I,J} values (16 values in total) from the converted working blocks. The last loop has the index {L}. This {L} loop steps through steps through the YD dimension in steps of +1. Note that this YD dimension has been chosen to match the number of PE elements in the TPU—YD dimensions larger than the per-TPU PE count may be supported by applying the TPU hardware in one or more additional passes through the layer (e.g., K-index separation as discussed). The values on the four data input (i.e., DIN or broadcast-data in) buses for each of the 16 TPUs are accessed as {DIN0, DIN1, DIN2, DIN3}·TPU[4*ΔJ+ΔI]·TIME[K+ΔK], with the applied TPU being a function of the {ΔI,ΔJ} index specifying the relative {I,J} values. The cycle time-slot TIME[K+ΔK] to be used is a function of the {K+ΔK} index, which specifies the DD dimension value. As shown within the execution pseudocode, the DIN values are multiplied by an H[K+ΔK,L,I+ΔI,J+ΔJ] value—i.e., a value has been converted from the original F[K+ΔK,L,I+ΔI,J+ΔJ] (as described above) and loaded into the L0 (and L1) memories at address L0[K+ΔK].TPU[4*ΔJ+ΔI].PE[L]. The products of DIN*H is accumulated in the accumulator registers {MAC0, MAC1, MAC2, MAC3}·TPU[4*ΔJ+ΔI].PE[L].

Still referring to FIG. 38, the result-unload process includes three outer loops with indexes {I,J,L}, with the {I,J} loops stepping through all the input data substructures within the input data structure as discussed above. The loop indexed by {L} steps through the YD dimension in steps of 16 (the number of PEs per tile in this example). In the depicted embodiment, the YD dimension is chosen to match the number of PE elements per TPU. If the actual YD dimension is larger than the per-tile PE count, one or more additional passes may be executed. Three inner loops having respective indices {ΔL, ΔJ, ΔI} are nested within the {L} loop. In the first inner loop, index {ΔL} steps through the values {0, 1, . . . 15} so that the sum {L+ΔL} steps through the YD dimension in steps of +1. The next two inner loops have the indexes {ΔI,ΔJ} to sequence through all the relative {I,J} values (16 values in total) from the converted working blocks. The accumulator registers {MAC0, MAC1, MAC2, MAC3}·TPU[4*ΔJ+ΔI]·PE[L+ΔL]} are transferred to the proper cycle-time-slot on the four output buses {MACSO0, MACSO1, MACSO2, MACSO3}·TPU[4*ΔJ+ΔI]·TIME[L+ΔL]}.

FIG. 39 illustrates exemplary pseudo-code detail corresponding to Z-to-Y conversion—part of the Winograd optimizations discussed above. Exemplary dimensions/spans of an output data structure (a tensor3 with approximate dimensions Y[YW,YH,YD]), output data substructure (a tensor3 with dimensions Y[ΔYW,ΔYH,YD]), and four output working blocks (four tensor3 structure, each with dimensions Y[4,4,YD]) are shown at 870. Note that the [YW,YH] will match [DW,DH] (because the stride=1), and [ΔYW,ΔYH] will match [ΔDW,ΔDH]. Also, the output data structure may include padding in the {I,J} plane, and the four output working blocks may have overlapping elements in the {I,J} plane—these overlapping elements will be zero in most cases, and thus need not be written to the L2 memory. The Z-to-Y conversion process includes three outer loops with indexes {I,J,L} in which the first two loops {I,J} sequence through all the input (and output) data substructures within the input (and output) data structures and the third loop {L} steps through the YD dimension in steps of 16 (the per-tile PE count in this example). Three inner loops are nested within the {L} loop, including a first inner loop that sequences index {ΔL} through the values {0, 1, . . . 15} (so that the sum {L+ΔL} steps through the YD dimension in steps of +1), and two additional inner loops that sequence indices{ΔJ,ΔI} through all 16 values in the {I,J} plane in each of the working blocks to load Z-result content from four output buses {MACSO0, MACSO1, MACSO2, MACSO3}·TPU[4*ΔJ+ΔI]·TIME[L+ΔL]}. The applied TPU (i.e., where multiple TPUs are applied to process the CNN layer) is a function of the {ΔI,ΔJ} index specifying the relative {I,J}values, and the applied cycle time-slot TIME[K+ΔK] is a function of the {L+ΔL} index, which specifies the YD dimension value. These values are loaded to the four unconverted working blocks {Z0, Z1, Z2, Z3}[I+ΔI,J+ΔJ,L+ΔL].

In the FIG. 39 example, a second {ΔL} loop is nested within the outer {L} loop and also sequences the {ΔL} index through values {0, 1, . . . 15} so that the sum {L+ΔL} steps through the YD dimension in steps of +1. The first unconverted output working block Z0[I+0:I+3,J:J+3,L+ΔL] includes 16 output values. These are passed to the FunctionZtoY, which generates the first converted output working block Y[I+0:I+3,J:J+3,L+ΔL], also with 16 values. Note while shown as a combinational function in FIG. 39, physical hardware generates the converted output working block within a multi-stage pipeline. The remaining three unconverted output working blocks {Z1[I+0:I+3,J:J+3,L+ΔL], Z2[I+0:I+3,J:J+3,L+ΔL], Z3[I+0:I+3,J:J+3,L+ΔL]} are converted to the three converted output working blocks {Y[I+2:I+5,J:J+3,K+ΔK], Y[I+4:I+7,J:J+3,K+ΔK], Y[I+6:I+9,J:J+3,K+ΔK]}. In the FIG. 39 example, the overlapping elements of the four converted output working blocks will be zero and thus need not be written to the L2 memory.

Referring to FIGS. 1-39 generally, the exemplary inferencing IC architectures, hierarchical components thereof, physical signaling interfaces, numbers of tensor processing units, TPU implementations, numbers of MAC processors per TPU, number of broadcast data channels, number of input subtensors FIR filtered per output subtensor, FIR stride dimensions (e.g., implemented within data steering circuitry to deliver desired input data streams to selected TPUs), MAC processor implementation, memory type, amount and disposition etc. may vary in numerous details and in particular with regard to any specific numbers, dimensions, formats, time-intervals presented (quantities of tiles, quantities of TPUs, quantities MAC processors, quantities of broadcast data channels, quantities of MAC channels, quantities and architectures of merged and/or dedicated shift-out paths, bit depths, memory sizes, data formats, data precisions, matrix/array dimensions, tensor dimensions, sub-tensor dimensions, clock periods or frequencies, MAC cycles per vector multiply interval, etc.). Moreover, the various inferencing IC embodiments (and component circuits thereof) presented herein may be implemented within a standalone integrated circuit component or IC package, or within one or more IC components (including packages having multiple IC dies) that combines the inferencing and/or vector-multiply functionality thereof with one or more other functions (e.g., integrated-circuit processor, application-specific integrated circuit (ASIC), etc.). One or more programmed microcontrollers and/or dedicated hardware circuits (e.g., finite state machines, registered or combinational circuits, etc.) may implement and/or control all or part of the various architectural and functional circuit blocks within the inferencing ICs presented herein. Additionally, any or all of those architectural/functional elements (or circuit blocks) may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, computer storage media in various forms (e.g., optical, magnetic or semiconductor storage media).

When received within a computer system via one or more computer-readable media, such data and/or instruction-based expressions of the above described circuits and circuitry can be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image can thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various functional-element quantities (tiles, TPUs per tile, MAC processors per TPU, etc.), bit depths, memory sizes, tensor/matrix/sub-tensor dimensions, clock frequencies, data formats (including input data, filter weights and output data), and so forth are provided for purposes of example only—any practicable alternatives may be implemented in all cases. Similarly, physical signaling interfaces (PHYs) having any practicable link parameters, protocols and configurations may be implemented in accordance with any practicable open or proprietary standard and any version of such standard. Links or other interconnections between integrated circuit devices and/or internal circuit elements or blocks may be shown as buses or as single signal lines. Each of the buses can alternatively be a single signal line, and each of the single signal lines can alternatively be a bus. Signals and signaling links, however shown or described, can be single-ended or differential. Logic signals shown or described as having active-high assertion or “true” states, may have opposite assertion states in alternative implementations. A signal driving circuit is said to “output” a signal to a signal receiving circuit when the signal driving circuit asserts (or de-asserts, if explicitly stated or indicated by context) the signal on a signal line coupled between the signal driving and signal receiving circuits. The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. An integrated circuit device comprising:
a broadcast data path;
a weighting-value memory;
Winograd conversion circuitry to:
render a converted input data set onto the broadcast data path by executing a first Winograd conversion function with respect to an input data set;
store within the weighting-value memory a converted weighting data set by executing a second Winograd conversion function with respect to a filter-weight data set; and
generate a final output data set by executing a third Winograd conversion function with respect to an interim output data set; and
a plurality of multiply-accumulate (MAC) units coupled in common to the broadcast data path and coupled via respective weighting-value paths to the weighting-value memory, each of the MAC units having, as component circuitry:
a data input coupled to receive, during each of a plurality of timing cycles, an input data value via the broadcast data path, the input data value being a constituent of the converted input data set;
a weighting-value input coupled to receive, during each of the plurality of timing cycles, a respective weighting value via the respective weighting-value path, the respective weighting value being a constituent of the converted weighting data set;
a multiplier circuit to generate a sequence of multiplication products by multiplying the input data value received during each of the plurality of timing cycles with the respective weighting value received during each of the plurality of timing cycles;
an accumulator circuit to accumulate a sum of constituent multiplication products within the sequence of multiplication products;
an output register coupled to receive the sum of constituent multiplication products at conclusion of a vector-multiply interval, the output register constituting, along with output registers in respective ones of the plurality of MAC units, a shift-register to enable the sum of constituent multiplication products accumulated within each of the MAC units over the vector-multiply interval to be serially shifted out of the plurality of MAC units as the interim output data set.

2. The integrated circuit device of claim 1 wherein the Winograd conversion circuitry to render the converted input data set onto the broadcast data path by executing the first Winograd conversion function with respect to the input data set comprises circuitry to generate, as each individual data value within the converted input data set, an arithmetic combination of multiple data values within the input data set.

3. The integrated circuit device of claim 2 wherein the circuitry to generate, as each individual data value within the converted input data set, the arithmetic combination of multiple data values within the input data set comprises circuitry to generate, as at least one individual data value within the converted input data set, a difference between a first sum of first and second data values within the input data set and a second sum of third and fourth data values within the input data set.

4. The integrated circuit device of claim 1 wherein the Winograd conversion circuitry to store within the weighting-value memory the converted weighting data set by executing the second Winograd conversion function with respect to the filter-weight data set comprises circuitry to generate, as one or more individual weighting values within the converted weighting data set, an arithmetic combination of multiple weighting values within the filter-weight data set.

5. The integrated circuit device of claim 4 wherein the circuitry to generate, as one or more individual weighting values within the converted weighting data set, the arithmetic combination of multiple weighting values within the filter-weight data set comprises circuitry to generate a sum of scaled instances of two or more of the weighting values within the filter-weight data set.

6. The integrated circuit device of claim 1 wherein the Winograd conversion circuitry to generate the final output data set by executing the third Winograd conversion function with respect to the interim output data set comprises circuitry to generate, as one or more individual output values within the final output data set, an arithmetic combination of multiple output values within the interim output data set.

7. The integrated circuit device of claim 1 wherein the data input to receive the input data value via the broadcast data path comprises a data operand register that is iteratively loaded with a respective input data value instance during each of the plurality of timing cycles.

8. The integrated circuit device of claim 7 further comprising a broadcast data register to iteratively output the respective input data value instances onto the broadcast data path over the plurality of timing cycles.

9. The integrated circuit device of claim 8 wherein the Winograd conversion circuitry to render the converted input data set onto the broadcast data path comprises circuitry to iteratively load constituent values within the converted input data set into the broadcast data register.

10. The integrated circuit device of claim 7 wherein the broadcast data path includes a downstream segment and an upstream segment, the integrated circuit device further comprising:
a line-segmenting pipestage register having an input coupled to the upstream segment of the broadcast data path and an output coupled in common, via the downstream segment of the broadcast data path, to inputs of the respective data operand registers within a first subset of the plurality of MAC units; and
a plurality of levelizing pipestage registers having respective inputs coupled in common to the upstream segment of the broadcast data path and outputs coupled respectively to inputs of respective data operand registers within a second subset of the plurality of MAC units.

11. A method of operation with an integrated-circuit (IC) device having a broadcast data path, weighting-value memory, and a plurality of multiply-accumulate (MAC) units, the method comprising:
rendering a converted input data set onto the broadcast data path by executing a first Winograd conversion function with respect to an input data set;
storing within the weighting-value memory a converted weighting data set by executing a second Winograd conversion function with respect to a filter-weight data set; and
within each of the plurality of MAC units:
receiving an input data value via the broadcast data path during each of the plurality of timing cycles, the input data value being a constituent of the converted input data set;
receiving a respective weighting value that is a constituent of the converted weighting data set;
multiplying the input data value received during each of the plurality of timing cycles with the respective weighting value received during each of the plurality of timing cycles to generate a sequence of multiplication products; and
accumulating a sum of constituent multiplication products within the sequence of multiplication products; and
transferring the sum of constituent multiplication products at conclusion of a vector-multiply interval spanned by the plurality of timing cycles to an output register that constitutes, together with respective output registers in others of the plurality of MAC units, a shift-register to enable the sum of constituent multiplication products accumulated within each of the MAC units over the vector-multiply interval to be serially shifted out of the plurality of MAC units as an interim output data set; and
generating a final output data set by executing a third Winograd conversion function with respect to the interim output data set.

12. The method of claim 11 wherein rendering the converted input data set onto the broadcast data path by executing the first Winograd conversion function with respect to the input data set comprises generating, as each individual data value within the converted input data set, an arithmetic combination of multiple data values within the input data set.

13. The method of claim 12 wherein generating, as each individual data value within the converted input data set, the arithmetic combination of multiple data values within the input data set comprises generating, as at least one individual data value within the converted input data set, a difference between a first sum of first and second data values within the input data set and a second sum of third and fourth data values within the input data set.

14. The method of claim 11 wherein storing within the weighting-value memory the converted weighting data set by executing the second Winograd conversion function with respect to the filter-weight data set comprises generating, as one or more individual weighting values within the converted weighting data set, an arithmetic combination of multiple weighting values within the filter-weight data set.

15. The method of claim 14 wherein generating, as one or more individual weighting values within the converted weighting data set, the arithmetic combination of multiple weighting values within the filter-weight data set comprises generating a sum of scaled instances of two or more of the weighting values within the filter-weight data set.

16. The method of claim 11 wherein generating the final output data set by executing the third Winograd conversion function with respect to the interim output data set comprises generating, as one or more individual output values within the final output data set, an arithmetic combination of multiple output values within the interim output data set.

17. The method of claim 11 wherein receiving the input data value within each of the plurality of MAC units via the broadcast data path during each of the plurality of timing cycles comprises iteratively loading instances of the input data value into a respective data operand register within each of the plurality of MAC units during each of the plurality of timing cycles.

18. The method of claim 17 further comprising iteratively outputting the input data value instances onto the broadcast data path from a broadcast data register over the plurality of timing cycles.

19. The method of claim 18 wherein rendering the converted input data set onto the broadcast data path comprises iteratively loading constituent values within the converted input data set into the broadcast data register.

20. An integrated-circuit (IC) device comprising:
a broadcast data path;
a weighting-value memory;
means for rendering a converted input data set onto the broadcast data path by executing a first Winograd conversion function with respect to an input data set;
means for storing within the weighting-value memory a converted weighting data set by executing a second Winograd conversion function with respect to a filter-weight data set;
means for receiving an input data value via the broadcast data path during each of the plurality of timing cycles, the input data value being a constituent of the converted input data set;
means for receiving a respective weighting value that is a constituent of the converted weighting data set;
means for multiplying the input data value received during each of the plurality of timing cycles with the respective weighting value received during each of the plurality of timing cycles to generate a sequence of multiplication products; and
means for accumulating a sum of constituent multiplication products within the sequence of multiplication products; and
means for transferring the sum of constituent multiplication products at conclusion of a vector-multiply interval spanned by the plurality of timing cycles to an output register that constitutes, together with other output registers, a shift-register to enable the accumulated sum of constituent multiplication products to be serially shifted out of the plurality of MAC units as part of an interim output data set; and
means for generating a final output data set by executing a third Winograd conversion function with respect to the interim output data set.
